(19) United States
(12) Patent Application Publication
(10) Pub. No.: US 2014/0088937 A1
(43) Pub. Date: Mar. 27, 2014

(54) Methods of Predicting The Probability of Modulation of Transcript Levels By RNAI Compounds

(71) Applicants: Duncan Brown, Berkeley, CA (US); Julja Burchard, Lansdale, PA (US); Eugen C. Buehler, Glenside, PA (US)

(72) Inventors: Duncan Brown, Berkeley, CA (US); Julja Burchard, Lansdale, PA (US); Eugen C. Buehler, Glenside, PA (US)

(73) Assignee: Merk Sharp & Dohme Corp., Rahway, NJ (US)

(21) Appl. No.: 14/091,459

(22) Filed: Nov. 27, 2013

Related U.S. Application Data
(63) Continuation of application No. 13/322,931, filed on Nov. 29, 2011.
(60) Provisional application No. 61/182,605, filed on May 29, 2009.

(51) Int. Cl. G06F 19/12

(52) U.S. Cl. CPC G06F 19/12
USPC 703/2

(57) ABSTRACT

The present invention provides a method for determining the probability that an RNAi compound modulates the expression level of a gene using a linear regression model. The present invention also provides a method for determining the probabilities that an RNAi compound modulates the expression levels of each gene in a set of genes of interest using the linear regression model. The present invention provides a method for determining the seed-sequence-dependent signature size of an RNAi compound using the linear regression model. The invention provides a method for identifying genes having seed-sequence-dependent silencing effect by an siRNA using the linear regression model. The invention further provides a method for selecting from a plurality of siRNAs one or more siRNAs with higher silencing efficacy, specificity and diversity in silencing a target gene in an organism. The invention also provides a method for determining the coefficients of the above linear regression model.

### 1. PRIORITY

This application claims the benefit of U.S. Provisional Application No. 61/182,605 filed May 29, 2009. The above listed application is hereby incorporated by reference herein in its entirety, including the drawings.

### 2. SEQUENCE LISTING

The sequence listing submitted via EFS, in compliance with 37 CFR §1.52(e)(5), is incorporated herein by reference. The sequence listing text file submitted via EFS contains the file “SequenceListing88WPCT,” created on May 12, 2010, which is 9,970 bytes in size.

### 3. FIELD OF THE INVENTION

This invention relates to methods for predicting the probability that an RNAi compound modulates the expression level of a transcript. The invention also relates to methods for predicting the number of transcripts that are modulated by an RNAi compound. The invention further relates to methods for determining seed-sequence-dependent signature size of an siRNA. The invention also relates to methods for selecting one or more siRNAs from among a plurality of siRNAs based on silencing specificity, efficacy, and diversity. The invention also relates to methods for determining the coefficients of the linear model used to determine the probability that an RNAi compound modulates the expression level of a transcript.

### 4. BACKGROUND OF THE INVENTION

RNA interference (RNAi) is a potent method to suppress gene expression in mammalian cells, and has generated much excitement in the scientific community (Couzin, 2002, Science 298, 2296-2297; McManus et al., 2002, Nat. Rev. Genet. 3,737-747; Hannon, 2002, Nature 418, 244-251; Paddison et al., 2002, Cancer Cell 2, 17-23). In the last decade, noncoding RNA molecules of about 20-30 nucleotides have emerged as critical regulators in the expression and function of eukaryotic genomes. Two primary categories of these small RNAs—short interfering RNAs (siRNAs) and microRNAs (miRNAs) act in a broad range of eukaryotic species to regulate endogenous genes and to defend the genome from invasive nucleic acids. The effects of these small RNAs on gene expression are generally inhibitory, with occasionally the exception of up regulation. Because the gene silencing machinery of the small RNAs are in many cases controllable, RNA interference has taken on great importance in practical and applied realms.

The core components of the RNA interference machinery are common among siRNA and miRNA. The signature components are three sets of macromolecules—Dicers, Argonaute, and duplex-derived small siRNA or miRNA. Each of the three components plays an important role in the RNA interference machinery (Carthew et al., 2009, Cell 136, 642-655). First, double stranded precursors of siRNA and miRNA are processed by a Dicer protein into short (˜20-30) nucleotide fragments. The Dicer protein cleaves dsRNA precursors into characteristic length through the action of two RNase III domains. Then, one strand of the processed duplex is loaded into an Argonaute protein. The Argonaute protein enables target recognition between the single stranded small RNA and a target sequence of transcript of a gene through Watson-Crick base pairing. The strand of RNA that is loaded into the Argonaute protein is called the guide strand. The other strand of the dsRNA is called passenger strand. Martinez has observed that in addition to the guide stand of siRNA, single-stranded passenger siRNAs can also guide target RNA cleavage in RNAi (Martinez et al., 2002, Cell 110, 563-574). The RNAi guide strand associates with effector assemblies known as RNA-induced silencing complexes (RISCs). The degree of small RNA-mRNA complementarity has been considered a key determinant of the regulatory mechanism. Perfect complementarity allows Argonaute-catalyzed cleavage of the mRNA strand. Mismatches at or near the center of the complementarity suppress endonucleolytic cleavage and promote repression of mRNA translation (Carthew et al., 2009, Cell 136, 642-655).

Both miRNAs and siRNAs that are naturally occurring have a shared central biogenesis and can perform interchangeable biochemical functions. These two classes of silencing RNAs cannot be distinguished by their mechanisms of action. Nevertheless, important distinctions can be made, particularly in regard to their origin and evolutionary conservation (Bartel and Bartel, 2003, Plant Physiol. 132(2), 709-17). miRNAs are derived from genomic loci and thus are viewed as endogenous and purposefully expressed products of an organism's own genome. siRNAs often derives from transposons, viruses, or heterochromatic DNA. When genome faces threats from novel invaders, it can exploit the foreign sequences themselves by co-opting them into the siRNA mechanism. Second, miRNA sequences are nearly always conserved in related organisms, whereas siRNA sequences are rarely conserved. These types of differences are the basis of practical guidelines for distinguishing miRNAs and siRNAs. It should be also noted that siRNAs also can be chemically synthesized in addition to deriving from cleavage of double-stranded RNA by Dicer proteins. Synthetic siRNA duplexes maintain the ability to associate with RISC proteins and direct silencing of mRNA transcripts, thus providing a powerful tool for gene silencing research.

Short hairpin RNAs (shRNAs) are also used to inactivate the expression of target genes (Miyagishi et al., 2004, J. Gene. Med. 6, 715-723). Compared to siRNA, shRNA offers advantages in silencing longevity, delivery options and cost. Expressed shRNA is transcribed in cells from a DNA template as a single-stranded RNA molecule (˜50-100 bases). Complementary regions spaced by a small “loop” cause the transcript to fold back on itself forming a “short hairpin”. Recognition and processing by the RNAi machinery converts the shRNA into the corresponding siRNA.

Specific gene silencing has the potential to harness human genome data to elucidate gene function, identify drug targets, and develop more specific therapeutics. In analogy to transcription factors but with opposing modulation effect, miRNAs provide a particular layer of network for gene regulation of a broad spectrum of biological pathways through fine-tuning protein expression levels. miRNA deficiencies or excesses have been correlated with a variety of clinically important diseases including myocardial infarcation, virus infection, Alzheimer's disease, metabolic diseases, cancers, and many others (Care et al., 2007, Nat. Med. 13(5), 613-618; Wiemer, 2007, Eur. J. Cancer 43(10), 1529-1544; Sullivan et al., 2005, Nature 435(7042), 682-686; Krutzfeldt et al., 2006, Cell. Metab. 4(1), 9-12; Nelson et al., 2007, J. Neuropathol. Exp. Neurol. 66(6), 461-468). Methods of altering the levels of miRNA expression have been developed. For example, specific knockdown of the target miRNAs by anti-miRNA oligonucleotides, or overexpression of miRNA duplex by transfection of vectors encoding this structure has been conducted both in vitro and in vivo (Boulta et al., 2003, Nucl. Acids Res. 31(17), 4973-4980; Brummelkamp et al., 2002, Science 296(5567), 550-553; Costinean et al., 2006, Proc. Natl. Acad. Sci. 103(18), 7024-7029).

It has also been shown that siRNA and shRNA can be used to silence genes in vivo. The ability to utilize siRNA and shRNA for gene silencing in vivo has the potential to enable selection and development of siRNAs for therapeutic use. A recent report highlights the potential therapeutic application of siRNAs. Fas-mediated apoptosis is implicated in a broad spectrum of liver diseases, where lives could be saved by inhibiting apoptotic death of hepatocytes. Song injected mice intravenously with siRNA targeted to the Fas receptor (Song et al., 2003, Nat. Medicine 9, 347-351). The Fas gene was silenced in mouse hepatocytes at the mRNA and protein levels, prevented apoptosis, and protected the mice from hepatitis-induced liver damage. Thus, silencing Fas expression holds therapeutic promise to prevent liver injury by protecting hepatocytes from cytotoxicity. The results suggest that siRNAs can function in vivo, and may hold potential as therapeutic drugs.

Because certain miRNAs act by repressing gene expression, they could affect tumorigenesis through several mechanisms. Certain miRNAs that are amplified or overexpressed in cancer could act as oncogenes. It was shown that the miR-17˜92 cluster was linked to cancer based on the observation that it maps to a chromosomal region that is frequently amplified in a subset of human B cell lymphomas (Ota et al., 2004, Cancer Res. 64, 3087-3095). On the other hand, several miRNAs have been implicated as tumor suppressors based on their physical deletion or reduced expression in human cancer. The miR-15a˜16-1 cluster of miRNAs has recently been recognized as an excellent candidate for the tumor suppressor gene on 13q14. This chromosomal region is deleted in the majority of CLLs and in a subset of mantle cell lymphomas and prostate cancer. The inhibition of miR-15a and miR-16 activity leads to hyperplasia of the prostate in mice and promotes survival, proliferation, and invasion of primary prostate in vitro (Bonci et al., 2008, Nat. Med. 14, 1271-1277).

Considerable efforts have been invested to identify the key thermodynamic and sequence parameters that promote strong RNAi gene silencing. Lai discovered the importance of the complementarity of residues 2-8 of the 5′ portion of miRNA to the 3′ UTR sequence of the target transcript in miRNA target recognition (Lai, 2002, Nat. Genet. 30, 363-364). It was observed that residues 2-8 of the miRNA are the most conserved among miRNAs of related organisms (Lewis et al., 2003, Cell 115, 787-798). When predicting targets of mammalian miRNAs, requiring perfect pairing to the heptamer spanning residues 2-8 of the miRNA is much more productive than requiring pairing to any other heptamer of the miRNA. It was further noted that pairing to this 5′ core region also appears to disproportionally govern the specificity of siRNA-mediated mRNA cleavage (Jackson et al., 2003, Nat. Biotechnol. 21, 635-637).

Brennecke evaluated the minimal requirements for a functional miRNA-target duplex in vivo (Brennecke et al., 2005, PLoS Biol. 3(3), e85). Brennecke referred to the core of 5′ sequence complementarity essential for target recognition as the “seed.” A systematic analysis of 8mer, 7mer, timer, 5mer and 4mer of continuous nucleotide sequence complementary to the first 8 nucleotides of the miRNA was performed. Brennecke found that as little as seven base-pairs of complementarity to the miRNA 5′ end sequence is sufficient to confer regulation in vivo. This means that the functional miRNA-target duplex can be more variable in structure, requiring perfect complementary for a short sequence stretch while allowing interrupts by gaps and mismatches. Brennecke also found that a large fraction of the genome is regulated by miRNAs. Brennecke estimated that the total number of genes in a genome targeted by miRNAs approaches the number of protein-coding genes.

With respect to siRNAs, numerous reports in the literature purport the exquisite specificity of siRNAs, suggesting a requirement for near-perfect identity with the siRNA sequence (Elbashir et al., 2001, EMBO J. 20, 6877-6888; Tuschl et al., 1999, Genes Dev. 13, 3191-3197; Hutvagner et al., 2002, Science 297, 2056-2060). Cross-hybridization with transcripts containing partial identity to the siRNA sequence may elicit phenotypes reflecting silencing of additional transcripts in addition to the target gene.

There is a strong parallel between siRNA mediated gene regulation and miRNA-mediated gene regulation. Birmingham et al. reported that sequence complementarity between the seed sequence of the siRNA and the 3′UTR region of a mRNA is a primary determinant of regulation of transcripts and their corresponding proteins by the siRNA (Birmingham et al., 2005, Nature Methods 3(3), 199-204). It was found that most of the unintended transcripts regulated have 3′UTRs that contain sequences complementary to the seed sequence of the siRNA guide strand. Similarly, the intended transcripts of a miRNA regulation contains sequences complementary to the seed sequence of the miRNA compound Lai, 2002, Nat. Genet. 30, 363-364).

Seed sequence mediated gene knock-down is an siRNA-mediated event that generally results in modest, 1.5- to 4-fold changes in the expression of dozens to hundreds of genes (Jackson et al., 2005, Nat. Biotechnol. 21, 635-637). Seed sequence mediated transcription modulation effects can be mediated by either strand of the siRNA. As seed sequence mediated gene silencing can induce measurable phenotypes, it represents an impediment to the interpretation of data from large-scale RNA interference screens.

Multiple computer prediction algorithms have been developed to use the established miRNA:mRNA interaction rules, especially the match between the seed region of the small RNA and the 3′UTR sequence of mRNA (Lewis et al., 2005, Cell, 120, 15-20; Grimson et al., 2007, Molecular Cell, 27, 91-105; Lewis et al., 2003, Cell, 115, 787-798; Krek et al., 2005, Nature Genetics 37, 495-500; Grün et al., 2005, PLoS Comp. Biol. 1:e13; Lall et al., 2006, Current Biology 16, 1-16; Chen and Rajewsky, 2006, Nat Genet 38, 1452-1456; Betel et al., 2008, Nucleic Acids Res. 36(Database Issue), D149-53). The algorithms used to predict miRNA targets typically develop scoring schemes based on sequence complementary, binding free energy calculation of RNA duplex formation, evolutionary conservation among interspecies sequences, and target RNA structure. Several prediction programs are readily available on the web, such as TargetScan (http://www.targetscan.org/) (Lewis et al., 2005, Cell, 120, 15-20), PicTar ((http://www.pictar.org/) (Krek et al., 2005, Nature Genetics 37, 495-500), and Miranda (http://www.miranda.org/) (Betel et al., 2008, Nucleic Acids Res. 36(Database Issue), D149-53).

Although the existing miRNA:mRNA interaction prediction methods are useful in practice for the design of experiments as they increase the efficiency of validation experiments by focusing on genes ranked higher in the prediction list compared to random, they still fall significantly short of capturing the full details of miRNA:mRNA interaction. As such, the predicted target list can account for only a small fraction of the genes that are actually silenced by a given miRNA, and it leaves the rest of predicted genes in the list as false positives.

The prediction of siRNA:mRNA interaction using existing algorithms is even less successful than the prediction of miRNA:mRNA on-target interaction. siRNA-mediated silencing is affected by the partial complementarity of siRNA to the 3′UTR region of the target mRNA, which is a mechanism reminiscent of that of miRNA.

The poor prediction accuracy of siRNA:mRNA silencing effect may be partly explained by the assumption on which all the existing prediction methods are based. All the existing methods rely on a conservation filter to reduce noise. The assumption is that a functionally important miRNA:mRNA target binding site must be evolutionarily conserved across species, as many evolutionarily selected genes often are. This is also called phylogenetic conservation. Thus, sequence alignment tools such as FASTA or BLAST are employed to identify conservation of target sequence and position across species, and to filter out non-conserved positions as false positives. However, unlike miRNAs' targeting effect, genes with siRNA silencing effect are not evolutionarily selected and thus seed match site conservation is not expected to predict down-regulation. Therefore, an approach which is appropriate for predicting miRNA mediated down-regulation may not be appropriate for predicting siRNA mediated down-regulation. The art is in need of a prediction algorithm that does not rely on an evolutionary conservation assumption.

Existing methods for the prediction of RNA interference are based on target dichotomy. A given transcript is predicted to be either a target of the RNAi compound or not a target. There is a need in the art for a method that provides a degree of probability that a given transcript is targeted by an RNAi compound. TargetScan attempts to establish the probability that the null hypothesis that the given transcript is not a target is true, and thus the output of such probability is continuous. However, TargetScan still calls for the proof or disproof that the null hypothesis that the given transcript is not a target is true. In essence, existing methods all assess the nature of the influence of RNAi compound on transcription in term of dichotomic classification. There is a need in the art for a method that can assess whether a given transcript is modulated by an RNAi compound in terms of probability.

Discussion or citation of a reference herein shall not be construed as an admission that such reference is prior art to the present invention.

### 5. SUMMARY OF THE INVENTION

The invention provides systems and methods for determining a degree of likelihood (probability) that an RNAi compound modulates the expression levels of one or more genes of interest. The prediction method is based on a linear regression model which takes a plurality of different seed match types and the length of 3′UTR sequence of the transcript as predictor variables. Advantageously, the methods can predict the RNAi induced transcript regulation without requiring sequence conservation data. In addition, the linear regression model of the invention explains much more of the variance in the RNAi induced transcript regulation than some existing methods.

In one embodiment, the invention provides a method for determining the probabilities that an RNAi compound modulates the expression levels of each gene in a set of genes of interest, the method comprising: step (a): calculating a score representing a probability that the RNAi compound modulates a transcript of a gene in the set of genes of interest according to a linear model of: Score=A*#pm+B*#m₁₋₇+C*#m₂₋₈+D*#m₂₋₇+E*length(3′UTR)+optionally F+optionally G*X; wherein #pm is the number of pm seed match types between a 3′UTR sequence of the transcript and a seed sequence, or a variant thereof, of the RNAi compound; the seed sequence consists of the first 8 nucleotides, numbered 1-8, respectively, at a 5′ end of the RNAi compound; #m₁₋₇ is the number of m₁₋₇ seed match types between the 3′UTR sequence and the seed sequence or the variant thereof; #m₂₋₈ is the number of m₂₋₈ seed match types between the 3′UTR sequence and the seed sequence or the variant thereof; #m₂₋₇ is the number of m₂₋₇ seed match types between the 3′UTR sequence and the seed sequence or the variant thereof; and the length(3′UTR) is the length in number of nucleotides of the 3′UTR sequence; wherein the variant is the seed sequence except that a nucleotide U replaces the nucleotide at position 1 of the seed sequence; and wherein the pm seed match type=perfect match of all nucleotides 1-8 in the seed sequence or the variant thereof; the m₁₋₇ seed match type=perfect match of nucleotides 1-7 and mismatch of nucleotide 8 in the seed sequence or the variant thereof; the m₂₋₈ seed match type=perfect match of nucleotides 2-8 and mismatch of nucleotide 1 in the seed sequence or the variant thereof; and the m₂₋₇ seed match type=perfect match of nucleotides 2-7 and mismatches of nucleotides 1 and 8 in the seed sequence or the variant thereof; wherein a perfect match means a complementary nucleotide is present, and a mismatch means absence of a complementary nucleotide; wherein coefficients A, B, C, D, E, F and G are constants; and wherein X is the value of one or more additional features characterizing the influence of the RNAi compound on the gene; and step (b): repeating step (a) for each gene in the set of genes, thereby determining a set of scores indicating the degree of likelihood that the RNAi compound modulates the respective transcript, thereby determining the probabilities that the RNAi compound modulates the expression levels of each gene in the set of genes.

In a preferred embodiment of any of the methods described herein in which numbers of seed match types are determined, the variant of the seed sequence is used to determine the number of each of the seed match types. As will be clear, preferably the seed sequence is used to determine the numbers of all seed match types, or the variant is used to determine the number of all seed match types.

In another embodiment, the invention provides a method for determining the probability that an RNAi compound modulates the expression level of a gene, the method comprising: step (a): calculating a score representing a probability that the RNAi compound modulates the expression level of the gene according to a linear model of: Score=A*#pm+B*#m₁₋₇+C*#m₂₋₈+D*#m₂₋₇+E*length(3′UTR)+optionally F+optionally G*X; wherein #pm is the number of pm seed match types between a 3′UTR sequence of the transcript and a seed sequence, or a variant thereof, of the RNAi compound; the seed sequence consists of the first 8 nucleotides, numbered 1-8, respectively, at a 5′ end of the RNAi compound; #m₁₋₇ is the number of m₁₋₇ seed match types between the 3′UTR sequence and the seed sequence or the variant thereof; #m₂₋₈ is the number of m₂₋₈ seed match types between the 3′UTR sequence and the seed sequence or the variant thereof; #m₂₋₇ is the number of m₂₋₇ seed match types between the 3′UTR sequence and the seed sequence or the variant thereof; and the length(3′UTR) is the length in number of nucleotides of the 3′UTR sequence; wherein the variant is the seed sequence except that a nucleotide U replaces the nucleotide at position 1 of the seed sequence; and wherein the pm seed match type=perfect match of all nucleotides 1-8 in the seed sequence or the variant thereof; the m₁₋₇ seed match type=perfect match of nucleotides 1-7 and mismatch of nucleotide 8 in the seed sequence or the variant thereof; the m₂₋₈ seed match type=perfect match of nucleotides 2-8 and mismatch of nucleotide 1 in the seed sequence or the variant thereof; and the m₂₋₇ seed match type=perfect match of nucleotides 2-7 and mismatches of nucleotides 1 and 8 in the seed sequence or the variant thereof; wherein a perfect match means a complementary nucleotide is present, and a mismatch means absence of a complementary nucleotide; wherein coefficients A, B, C, D, E, F and G are constants; and wherein X is the value of one or more additional features characterizing the influence of the RNAi compound on the gene.

In another embodiment, the invention provides a method for determining the probabilities that each RNAi compound in a set of RNAi compounds of interest affects a phenotype for which a gene of interest is known to be a biomarker, comprising determining for each RNAi in the plurality, the probability that the RNAi compound modulates the expression level of the gene of interest according to the method described above, wherein said RNAi compound is an siRNA, and wherein said gene is said biomarker. In one embodiment, said biomarker is a biomarker for a phenotype or pathway of interest.

Optionally, one or more or all steps of the above methods can be performed by a suitably programmed computer.

Optionally, the above methods further comprise a step of outputting or displaying the probability scores calculated.

In one embodiment, the score or the set of scores calculated by the above methods are selected from the group consisting of: (a) a log-odds that the null hypothesis that the transcript is not modulated or is not down-regulated by the RNAi compound is true, (b) a p-value that is the probability that the null hypothesis that the transcript is not modulated or is not down-regulated by the RNAi compound is true, and (c) a measure of the relative expression of the transcript by a cell containing the RNAi compound and expression of the transcript by an analogous (preferably, same) cell not containing the RNAi compound.

In a preferred embodiment, the score is the log-odds that the null hypothesis that the transcript is not down-regulated by the RNAi compound is true.

In another preferred embodiment, the measure is the log ratio of expression of the transcript by a cell containing the RNAi compound to expression of the transcript by an analogous cell not containing the RNAi compound.

In another embodiment, the invention provides a method for determining the seed-sequence-dependent signature size of an RNAi compound, the method comprising: step (a): calculating a score representing a probability that the RNAi compound modulates a transcript of a gene in a set of genes of interest according to a linear model of: Score=A*#pm+B*#m₁₋₇+C*#m₂₋₈+D*#m₂₋₇+E*length(3′UTR)+optionally F+optionally G*X; wherein #pm is the number of pm seed match types between a 3′UTR sequence of the transcript and a seed sequence, or a variant thereof, of the RNAi compound; the seed sequence consists of the first 8 nucleotides, numbered 1-8, respectively, at a 5′ end of the RNAi compound; #m₁₋₇ is the number of m₁₋₇ seed match types between the 3′UTR sequence and the seed sequence or the variant thereof; #m₂₋₈ is the number of m₂₋₈ seed match types between the 3′UTR sequence and the seed sequence or the variant thereof; #m₂₋₇ is the number of m₂₋₇ seed match types between the 3′UTR sequence and the seed sequence or the variant thereof; and the length(3′UTR) is the length in number of nucleotides of the 3′UTR sequence; wherein the variant is the seed sequence except that a nucleotide U replaces the nucleotide at position 1 of the seed sequence; and wherein the pm seed match type=perfect match of all nucleotides 1-8 in the seed sequence or said variant thereof; the m₁₋₇ seed match type=perfect match of nucleotides 1-7 and mismatch of nucleotide 8 in the seed sequence or said variant thereof; the m₂₋₈ seed match type=perfect match of nucleotides 2-8 and mismatch of nucleotide 1 in the seed sequence or said variant thereof; and the m₂₋₇ seed match type=perfect match of nucleotides 2-7 and mismatches of nucleotides 1 and 8 in the seed sequence or said variant thereof; wherein a perfect match means a complementary nucleotide is present, and a mismatch means absence of a complementary nucleotide; wherein coefficients A, B, C, D, E, F and G are constants; and wherein X is the value of one or more additional features characterizing the influence of the RNAi compound on the gene; and step (b): repeating step (a) for each gene in the set of genes, thereby determining a set of scores indicating the probability that the RNAi compound modulates the respective transcript; and step (c): calculating the seed-sequence-dependent signature size of the RNAi compound, wherein the seed-sequence-dependent signature size is, or an indication of, the number of genes that have a transcript which the score predicts is modulated by the RNAi compound.

In one embodiment, the score used to determine seed-sequence-dependent signature size is selected from a group consisting of: (a) a log-odds that the null hypothesis that the transcript is not modulated or is not down-regulated by the RNAi compound is true, (b) a p-value that is the probability that the null hypothesis that the transcript is not modulated or is not down-regulated by the RNAi compound is true, and (c) a measure of the relative expression of the transcript by a cell containing the RNAi compound and expression of the transcript by an analogous cell not containing the RNAi compound; and wherein the seed-sequence-dependent signature size is calculated as follows: (i) when the score is the log-odds that the null hypothesis that the transcript is not modulated or is not down-regulated by the RNAi compound is true, calculating the seed-sequence-dependent signature size comprises: (A) calculating the standard deviation of the set of scores, or (B) calculating the mean of the absolute values of the set of scores, or (C) counting the number of log-odds in the set of scores that have a value above a first preselected threshold; and (ii) when the score is the p-value, calculating the seed-sequence-dependent signature size comprises counting the number of p-values in the set of scores that have a value below a second preselected threshold; and (iii) when the score is the measure, calculating the seed-sequence-dependent signature size comprises counting the number of measures in the set of scores that have a value above a third preselected threshold and/or below a fourth preselected threshold.

Optionally, one or more or all steps of the above methods can be performed by a suitably programmed computer.

Optionally, the above method further comprises a step of outputting or displaying the set of scores calculated.

In a preferred embodiment, the score is the log-odds that the null hypothesis that the transcript is not down-regulated by the RNAi compound is true.

In another embodiment, the measure is the relative expression of the transcript by a cell not containing the RNAi compound and expression of the transcript by an analogous cell containing the RNAi compound, and the seed-sequence-dependent signature size is the number of measures in the set of scores that have a value above a fifth preselected threshold and/or below a sixth preselected threshold.

In a preferred embodiment, the measure of the relative expression is the mean log ratio, wherein the mean log ratio is a mean of the log ratios of signal intensities from a pair of microarray experiments where fluorescent dye labeling of nucleic acids contacted with a microarray is reversed in one microarray experiment relative to the other.

In another preferred embodiment, the set of genes of interest contains at least 2, at least 4, at least 20, at least 40, at least 100, at least 200, at least 1000, at least 2000, at least 4000, or at least 8000 genes.

In one embodiment, the method further comprises a step of deriving the coefficients A, B, C, D, E, optionally F and optionally G using a linear regression method.

In one embodiment, the coefficients A, B, C, D, E and F are: A=a negative number, B=a negative number, C=a negative number, D=a negative number, E=a positive number, F=a positive or negative number, or zero.

Preferably, the coefficients A, B, C, D, E and F are: A=−1.671±0.04008, B=−1.292±0.02467, C=−0.5471±0.02371, D=−0.3876±0.01393, E=0.0001551±0.000007025, F=0.002255±0.009319.

Preferably, the coefficients A, B, C, D, E and F are: A=−1.671, B=−1.292, C=−0.5471, D=−0.3876, E=0.0001551, F=0.002255.

In one embodiment, when a score is calculated based on a linear model of: Score=A*#pm+B*#m₁₋₇+C*#m₂₋₈+D*#m₂₋₇+E*length(3′UTR)+F+G*X, one or more additional features X are selected from the group consisting of #m₃₋₈, #m₁₋₆, the number of A nucleotides and U nucleotides in the entire 3′UTR sequence, and the expression level of the transcript; wherein #m₃₋₈ is the number of m₃₋₈ seed match types between the 3′UTR sequence and the seed sequence or the variant thereof, wherein the m₃₋₈ seed match type=perfect match of nucleotides 3-8 and mismatches of nucleotides 1 and 2 in the seed sequence or the variant thereof; and #m₁₋₆ is the number of m₁₋₆ seed match types between the 3′UTR sequence and the seed sequence or the variant thereof, wherein the m₁₋₆ seed match type=a perfect match of nucleotides 1-6 and mismatches of nucleotides 7 and 8 in the seed sequence or the variant thereof.

In another embodiment, the additional features X do not comprise one or more of the followings: sequence evolutionary conservation scores between the 3′UTR sequence and the 3′UTR sequence of one or more homologous genes of species different from that of the transcript; the number of nucleotides between the 5′ end of the seed match site in the 3′UTR sequence and the 5′ end of the 3′UTR sequence, wherein the seed match site is the best matched sequence in said 3′UTR sequence to all nucleotides 1-8 in the seed match; the number of nucleotides between the 3′ end of the seed match site in the 3′UTR sequence and the 3′ end of the 3′UTR sequence; and the number of matches between the 3′UTR sequence and portions of the RNAi sequence that are outside the seed sequence. Preferably, the additional features X do not comprise sequence evolutionary conservation scores between the 3′UTR sequence and one or more homologous genes of species different from that of the transcript.

In one embodiment where the score is a p-value, the p-value is calculated by a method comprising converting a log-odds that the null hypothesis that the transcript is not modulated by the RNAi compound is true to a p-value according to the equation:

p-value=e^{logodds}(1+e^{logodds}).

Preferably, the p-value is a one-sided p-value representing the probability that the null hypothesis that a transcript is not down-regulated is true, calculated according to the equation of:

$$o = \{ \begin{matrix}t / 2 & if mlr < 0 \\ 1 - t / 2 & if mlr \geq 0\end{matrix}$$

wherein t is the two-sided p-value representing the probability that the null hypothesis that a transcript is not down-regulated or up-regulated is true, and wherein mlr is the mean log ratio which is a mean of the log ratios of signal intensities from a pair of microarray experiments where fluorescent dye labeling of nucleic acids contacted with a microarray is reversed in one microarray experiment relative to the other.

In another preferred embodiment, the score is the log-odds that the null hypothesis that the transcript is not modulated by the RNAi compound is true.

In one embodiment, the RNAi compound can be an siRNA, a miRNA, or a shRNA.

In one embodiment, the seed sequence is the reverse complement of the sense strand of a target sequence in the transcript. In another embodiment, the seed sequence is the reverse complement of the antisense strand of a target sequence in the transcript.

In one embodiment, the set of genes of interest consists of all the genes present in a database purported to contain all the genes known to be expressed in a genome of interest. In another embodiment, the genes in the set of genes of interest are all of the same species.

In one embodiment, when the score is a log-odds that the null hypothesis that the transcript is not modulated by the RNAi compound is true, the method further comprises a step of identifying all the genes with a score of log-odds below a preselected threshold. Preferably, such preselected threshold is −1.279, −1.996, or −2.299.

In one embodiment, the score is a p-value, the method further comprises the step of identifying all the genes with a p-value below a preselected threshold. Preferably, such preselected threshold is 0.05, 0.01, or 0.001.

In one embodiment, the invention provides a method for selecting one or more siRNAs from among a plurality of siRNAs based on silencing specificity, comprising a step of determining the seed-sequence-dependent signature size of the siRNA, and further comprising the steps of: (i) ranking the siRNAs by seed-sequence-dependent signature sizes; and (ii) selecting one or more siRNAs whose seed-sequence-dependent signature size is below a preselected threshold, or selecting siRNAs with the 1^{st} to N^{th} smallest seed-sequence-dependent signature size, wherein N is a positive integer.

In one embodiment, wherein the seed-sequence-dependent signature size is a standard deviation of log-odds, and wherein step (ii) comprises selecting one or more siRNAs whose seed-sequence-dependent signature size is below a preselected threshold, said preselected threshold is 0.289, or 0.250.

In another embodiment, wherein the seed-sequence-dependent signature size is a mean of the absolute value of log-odds, and wherein step (ii) comprises selecting one or more siRNAs whose seed-sequence-dependent signature size is below a preselected threshold, said preselected threshold is 10^{th}, or 25^{th} percentile of all siRNAs.

In another embodiment, wherein the seed-sequence-dependent signature size is expression log₂ ratio, and wherein step (ii) comprises selecting one or more siRNAs whose seed-sequence-dependent signature size is below a preselected threshold, said preselected threshold is 1.2 fold, 1.5 fold, or 2 fold reduction of expression level.

In one embodiment, the invention provides a method for selecting one or more siRNAs from among a plurality of siRNAs based on silencing specificity, comprising carrying out the method of any one of claim 1 and claims dependent directly or indirectly thereon, wherein the RNAi compound is an siRNA, for each of the siRNAs in the plurality, to determine the probability scores that each siRNA in the plurality modulates the expression level of each gene in the set of genes, and wherein the method further comprises: (i) for each of the siRNAs, predicting the number genes having seed-sequence-dependent match to the siRNA by determining the number of genes in the set of genes, excluding the target gene of the siRNA compound, that have a transcript which the score predicts is modulated by the RNAi compound; (ii) ranking the plurality of siRNAs according to the number of genes having seed-sequence-dependent match predicted in step (i); and (iii) selecting one or more siRNAs for which the number genes with seed-sequence-dependent match is below a preselected threshold, or preferably, selecting siRNAs with the 1^{st} to N^{th} lowest number of genes having seed-sequence-dependent match, wherein N is a positive integer.

In one embodiment, wherein when step (iii) comprises selecting one or more siRNAs for which the number genes having seed-sequence-dependent match is below a preselected threshold, the number of genes with seed-sequence-dependent match to is below 5, 10, 20, or 40.

Optionally, one or more or all steps of the above methods can be performed by a suitably programmed computer.

Optionally, the method further comprises a step of outputting or displaying the identities of the selected siRNAs.

In one embodiment, the invention provides a method for determining the coefficients of a linear regression model that calculates a score representing a probability that an RNAi compound modulates the expression level of a gene, the method comprising: step (a): obtaining, for each gene in a set of genes selected from a differential gene expression profile, a score from the differential gene expression profile, wherein the score represents a probability that the RNAi compound modulates the gene, wherein the differential expression profile comprises measurements of the relative expression of the transcript by a cell containing the RNAi compound and expression of the transcript by an analogous cell not containing the RNAi compound; step (b): determining, for each gene in the set of genes, a plurality of features, wherein the features comprise: length(3′UTR), which is the length in number of nucleotides of a 3′UTR sequence of a transcript of the gene; #pm, which is the number of pm seed match types between the 3′UTR sequence and a seed sequence, or a variant thereof, of the RNAi compound, wherein the seed sequence consists of the first 8 nucleotides, numbered 1-8 respectively, at a 5′ end of the RNAi compound; #m₁₋₇, which is the number of m₁₋₇ seed match types between the 3′UTR sequence and the seed sequence or the variant thereof; #m₂₋₈, which is the number of m₂₋₈ seed match types between the 3′UTR sequence and the seed sequence or the variant thereof; and #m₂₋₇, which is the number of m₂₋₇ seed match types between the 3′UTR sequence and the seed sequence or the variant thereof; wherein the variant is the seed sequence except that a nucleotide U replaces the nucleotide at position 1 of the seed sequence; and wherein the pm seed match type=perfect match of all nucleotides 1-8 in the seed sequence or the variant thereof, the m₁₋₇ seed match type=perfect match of nucleotides 1-7 and mismatch of nucleotide 8 in the seed sequence or the variant thereof, the m₂₋₈ seed match type=perfect match of nucleotides 2-8 and mismatch of nucleotide 1 in the seed sequence or the variant thereof, and the m₂₋₇ seed match type=perfect match of nucleotides 2-7 and mismatches of nucleotides 1 and 8 in the seed sequence or the variant thereof, wherein a perfect match means a complementary nucleotide is present, and a mismatch means absence of a complementary nucleotide; and wherein the transcripts of the set of genes collectively comprise one or more of each of the pm, m₁₋₇, m₂₋₈, and m₂₋₇ seed match types; step (c): importing the score and the plurality of features of each gene into a linear model of: Score=A*#pm+B*#m₁₋₇+C*#m₂₋₈+D*#m₂₋₇+E*length(3′UTR)+F; and step (d): performing a linear regression using the linear model in step (c), to calculate a least-squares fit of the data imported in step (c), thereby generating coefficients A, B, C, D, E, and F.

In one embodiment, said score in step (a) is a mean of the scores obtained from at least 3, at least 4, at least 10, or at least 20 replicate microarray experiments measuring relative expression of respective transcripts by a cell containing said RNAi compound and expression of said transcripts by said analogous cell not containing said RNAi compound. In another embodiment, said mean score are further refined by repeating said step (a) one or more times, each time using a different RNAi compound.

Optionally, one or more or all steps of the above methods can be performed by a suitably programmed computer program.

Optionally, the above method further comprise a step of outputting or displaying coefficients A, B, C, D, E, and F.

In one embodiment, the score is selected from a group consisting of: (a) a log-odds that the null hypothesis that the transcript is not modulated or is not down-regulated by the RNAi compound is true, (b) a p-value that is the probability that the null hypothesis that the transcript is not modulated or is not down-regulated by the RNAi compound is true, and (c) a measure of the relative expression of the transcript by a cell containing the RNAi compound and expression of the transcript by an analogous (preferably, same) cell not containing the RNAi compound. Preferably, the score is a log-odds that the null hypothesis that the transcript is not down-regulated by the RNAi compound is true.

Preferably, each of above log-odds is calculated by a method comprising converting a p-value that is the probability that the null hypothesis that the transcript is not down-regulated by the RNAi compound is true to a log-odds according to the equation:

$$logodds = log ( \frac{pvalue}{1 - pvalue} )$$

wherein the p-value is derived from the differential gene expression profile.

In another embodiment, the differential gene expression profiles are downloaded from a microarray scanner, or from a database accessed via a WAN, e.g., the world-wide web.

In one embodiment, the set of selected genes are genes whose transcript levels in the differential expression profile are above a pre-selected threshold. Preferably, the set of selected genes contains: at least 100, at least 1000, at least 2000, at least 4000, or at least 8000 genes.

In one embodiment, the invention provides a method for selecting from a plurality of different siRNAs one or more siRNAs for silencing a target gene in an organism, each of the plurality of different siRNAs targeting a different target sequence in a transcript of the target gene, said method comprising: (a) determining all possible siRNAs of a preselected size or set of sizes that are complementary to the sequence of said transcript; (b) selecting one or more siRNAs from said plurality of said different siRNAs such that the selected siRNAs have either a guanine or a cytosine at nucleotide 1 at the 5′ end of the passenger strand of said siRNAs, or such that the selected siRNAs have one or no guanine or cytosine residues at positions 18 and 19 of said selected siRNA; (c) determining a Position Specific Score Matrix (PSSM) score for each of said siRNAs selected in step (b), wherein said PSSM score of each siRNA of said one or more siRNAs is determined according to the positional nucleotide compositions of a corresponding target sequence motif in the transcript of the gene which said siRNA is designed to target, wherein each said target sequence motif comprises at least 19 nucleotides; (d) selecting one or more siRNAs from among those siRNAs selected in step (b), with a PSSM within a preselected range; (e) selecting a first subset of siRNAs from the siRNAs selected in step (d) using a sequence alignment algorithm, wherein the maximal sequence alignment score of each siRNA in said first subset is below a preselected threshold, wherein said sequence alignment scores are calculated by querying the target sequence of an siRNA against a sequence database which is purported to obtain sequences of transcripts of the majority of the genes of said organism but which excludes said target gene; (f) determining the seed-sequence-dependent signature sizes of the siRNAs selected in step (e); (g) ranking said siRNAs in step (f) based on said seed-sequence-dependent signature sizes from lowest to highest; (h) selecting siRNAs with the 1^{st} to N^{th} smallest seed-sequence-dependent signature sizes, wherein N is a positive integer; (i) de-overlapping, on a suitably programmed computer, the siRNAs selected in step (h) by selecting a second subset of siRNAs from the siRNAs selected in step (h), wherein the target sequences of said second subset of siRNAs are located at least 2 nucleotides away from each other in said transcript sequence, and the absolute value of the PSSM score of each siRNA of this set of siRNAs ranks lowest among the siRNAs whose target sites are at least 2 nucleotides away from each other in said transcript sequence; (j) ranking the siRNAs selected in step (i) based on the absolute value of their PSSM scores; and (k) selecting siRNAs with the 1^{st} to M^{th} smallest absolute PSSM scores, wherein M is a positive integer.

In one embodiment, the method further comprising a quality control step before step (b), the quality control step comprising: (A) removing siRNAs with a target sequence not common to all documented splice forms of transcripts of the target gene; (B) removing siRNAs with a target sequence overlapping with simple or interspersed repeat elements in said transcript; (C) removing siRNAs with a target sequence overlapping with regions in said transcript that have low sequence complexity; (D) removing siRNAs with a target sequence positioned within 75 nucleotides downstream of the translation start codon of said transcript; (E) removing siRNAs with one or more binding sites in the 5′UTR region of said transcript; (F) removing siRNAs with a target sequence containing 4 or more consecutive guanosine, cytosine, adenine or uracil residues; (G) removing siRNAs with a target sequence containing one or more recognition sites for restriction endonucleases; (H) removing siRNAs with all nucleotides 1-8 of seed sequence perfectly matched with any known miRNAs in said organism; and (I) removing siRNAs with a target sequence which overlaps with any known SNPs in said organism.

In a preferred embodiment, the selecting step (b) of the method further comprises one or more or all of the following steps: (A) selecting one or more siRNAs from the plurality of different siRNAs such that in the selected siRNAs, 0-40% of nucleotides 2-7, numbered from a 5′ end of the passenger strand of the selected siRNA are either guanine or cytosine; and (B) selecting one or more siRNAs from the plurality of different siRNAs such that the target sequence of the selected siRNA is at most 100 nucleotides, at most 300 nucleotides, or at most 500 nucleotides away from the 5′ end of the 3′UTR sequence of the gene. In another embodiment, the selected siRNAs in step (A) have 0-60%, instead of 0-40%, guanine or cytosine content in nucleotides 2-7 from the 5′ end of the passenger strand of the selected siRNA.

Optionally, one or more or all steps of the above methods can be performed by a suitably programmed computer.

Optionally, the method further comprises a step of outputting or displaying the identities of the selected siRNAs.

In one embodiment, the selecting step (b) of the above method selects siRNAs with PSSM scores between an upper threshold and a lower threshold. In one preferred embodiment, the lower threshold is −200 and the higher threshold is 0. In another preferred embodiment, the lower threshold is −300 and the higher threshold is 200. Preferably, at least 10 siRNAs are selected in step (b) of the method.

In one embodiment, the sequence alignment algorithm in step (e) is VMATCH or BLAST.

In one embodiment, wherein the sequence alignment algorithm is VMATCH, the preselected threshold for the VMATCH search in step (e) is 18 nucleotides.

In one embodiment, wherein the sequence alignment algorithm is BLAST, the preselected threshold for the BLAST search in step (e) is 17 nucleotides.

In one embodiment, wherein the sequence alignment algorithm is FASTA, the preselected threshold for the FASTA search in step (e) is 18 nucleotides.

In one embodiment, the seed-sequence-dependent signature size in step (f) is determined by a method for determining seed-sequence-dependent signature size as described above.

In one embodiment, the seed-sequence-dependent signature size is step (f) is determined empirically from expression data.

In a preferred embodiment, the final number of siRNAs selected in step (k) of the method is 3.

In one embodiment, the invention provides a method for selecting from a plurality of different siRNAs one or more siRNAs for silencing a target gene in an organism, each of the plurality of different siRNAs targeting a different target sequence in a transcript of the target gene, the method comprising: (a) determining all possible siRNAs of a preselected size or set of sizes that are complementary to the sequence of said transcript; (b) performing a quality control step comprising one or more or all of the following: (i) removing siRNAs with a target sequence containing 4 or more consecutive guanosine, cytosine, adenine or uracil residues; (ii) removing siRNAs with one or more binding sites in the 5′UTR region of said transcript; (iii) removing siRNAs with a target sequence that starts more than 500 nucleotides 3′ of the 5′ end of the 3′UTR sequence of the transcript; (iv) removing siRNAs with a target sequence not common to all documented splice forms of transcripts of said target gene; (v) removing siRNAs with a target sequence overlapping with simple or interspersed repeat elements in said transcript; (vi) removing siRNAs with a target sequence overlapping with regions in said transcript that have low sequence complexity; (vi) removing siRNAs with all nucleotides 1-8 of seed sequence perfectly matched with any known miRNAs in said organism; and (vii) removing siRNAs with a target sequence which overlaps with any known SNPs in said organism; (c) determining the seed-sequence-dependent signature sizes of the siRNAs selected in step (b); (d) ranking said siRNAs in step (c) based on said seed-sequence-dependent signature sizes from lowest to highest; and (e) selecting siRNAs with the 1^{st} to N^{th} smallest seed-sequence-dependent signature sizes, wherein N is a positive integer.

In a preferred embodiment, the plurality of siRNAs have a passenger strand that is chemically modified to reduce silencing mediated by the passenger strand and to improve RISC loading of the intended guide strand.

In one embodiment, the method further comprises before step (c) a step of removing siRNAs with target sequences that do not have homologous sequences in a plurality of species of interest.

In one embodiment, the method further comprising before step (c) a step of removing siRNAs with target sequences that have homologous sequences in other species.

In one embodiment, the method further comprising before step (c) a step for removing siRNAs with a nucleotide G at position 14 or with a nucleotide C at position 10 of the seed sequence of the siRNAs.

In one embodiment, the method further comprising before step (c) a step for removing siRNAs with sequence alignment score above a preselected threshold, wherein said sequence alignment score is calculated by querying the target sequence of an siRNA against a sequence database which is purported to obtain sequences of transcripts of the majority of the genes of said organism but which excludes said target gene. In one embodiment, the sequence alignment algorithm comprises VMATCH, BLAST and FASTA. In one embodiment, wherein said sequence alignment algorithm is VMATCH, the preselected threshold for the VMATCH search is 18 nucleotides. In one embodiment, wherein said sequence alignment algorithm is BLAST, the preselected threshold for the BLAST search is 17 nucleotides. In one embodiment, wherein said sequence alignment algorithm is FASTA, the preselected threshold for the FASTA search in step (b)(viii) is 18 nucleotides.

In one embodiment, the method comprising after step (e) a step of selecting from the siRNAs a subset of Y siRNAs which have a preselected distribution of nucleotides at each position of nucleotides 1-19 of an siRNA, wherein Y is a positive integer.

In one embodiment, the preselected distribution of nucleotides is an equal (25%) or near equal (25±2%) distribution of a distribution of nucleotides A, U, G, and C at each position of nucleotides 1-19 of an siRNA.

In another embodiment, the preselected distribution of nucleotides is an equal or near equal distribution of GC content at each position of nucleotides 1-19 of an siRNA.

In one embodiment, the number N of siRNAs in step (e) is 100.

In one embodiment, the subset of Y siRNAs ranges between 42 to 84 siRNAs.

In one embodiment, the seed-sequence-dependent signature sizes in step (c) are determined by carrying out a method for determining seed-sequence-dependent signature size as described above.

In another embodiment, the seed-sequence-dependent signature sizes is step (c) are determined empirically from expression data.

In one embodiment, the method further comprising ranking the subset of Y siRNAs based on their relative expression level of the target gene by a cell containing the siRNA and by an analogous cell not containing the siRNA, and selecting Z siRNAs with the 1^{st} to Z^{th} highest relative expression level, wherein Z is a positive integer.

In one embodiment, the number Z of siRNAs ranges between 4 to 12.

Optionally, one or more or all steps of the above methods can be performed by a suitably programmed computer.

Optionally, the method further comprises a step of outputting or displaying the identities of the selected siRNAs.

In one embodiment, the invention provides a method for identifying transcripts that are involved in the modulation of a phenotype of interest, said method comprising: (a) determining the probabilities that an siRNA down-regulates the expression levels of each gene in a set of genes of interest by using the methods described in this invention, wherein the RNAi compound is an siRNA; (b) selecting from said set of genes in step (a) those genes that are predicted to be down-regulated based on said probabilities; (c) repeating steps (a) and (b) for each siRNA in a plurality of siRNAs, thereby determining for each siRNA those genes whose transcripts in the plurality are predicted to be down-regulated by said siRNA and the predicted amounts of down-regulation of said transcripts; (d) providing a quantitative measure of the effect of each siRNA in said plurality of siRNAs upon a phenotype of interest exhibited by a cell or organism, when said siRNA is introduced into said cell or organism; (e) comparing the quantitative measures of step (d) with the predicted amounts of down-regulation determined in step (c); and (f) identifying one or more transcripts for which there is a statistically significant correlation between down-regulation of the transcript across the siRNAs and the quantitative measures across the siRNAs.

In one embodiment, the RNAi compound described in the above methods is an siRNA.

In still another aspect, the invention provides a computer system comprising a processor, and a memory coupled to the processor and encoding one or more programs, wherein the one or more programs cause the processor to carry out any one of the methods of the invention, wherein optionally the one or more programs further instruct the computer system to output the result of the method of the invention to a user, a user interface, a computer readable storage medium, a local or remote computer system, or display the result of the methods of the invention.

In still another aspect, the invention provides a computer program product for use in conjunction with a computer having a processor and a memory connected to the processor, the computer program product comprising a computer readable storage medium having a computer program mechanism encoded thereon, wherein the computer program mechanism may be loaded into the memory of the computer and cause the computer to carry out any one of the methods of the invention.

### 6. BRIEF DESCRIPTION OF FIGURES

The objects, features, and advantages of the present invention are further described in the detailed description that follows, with reference to the figures and drawings by way of non-limiting exemplary embodiments of the present invention and wherein:

FIG. 1a shows the correlation between the number of seed matches of a particular type of miR16 identified on the transcripts of a plurality of genes and the mean log₁₀ ratio of the expression levels of the same transcripts. Y axis represents the number of seed matches of a particular type found per transcript. X axis represents mean log₁₀ ratio of expression level of the transcripts, wherein negative expression level indicates down-regulation, and positive expression levels indicates up-regulation.

FIG. 1b shows the correlation between the length of the 3′UTR sequence of the transcript of a plurality of genes and the mean log₁₀ ratio of the expression levels of the same transcripts.

FIG. 2 provides a flow-chart illustrating steps in an exemplary embodiment for applying the linear regression model of Equation 1 to calculate the log-odds, p-value and expression log ratio of RNAi mediated transcript modulation, and the seed-sequence-dependent signature size of the RNAi compound.

FIG. 3 provides one embodiment of a flow-chart illustrating steps for determining the coefficients of the linear regression model of Equation 1 and Equation 2.

FIG. 4 provides one embodiment of a flow chart illustrating the steps for determining the seed-sequence-dependent signature size of an siRNA.

FIG. 5 provides one embodiment of a flow chart for selecting from a plurality of different siRNAs one or more siRNAs that have a strong down-regulation effect and a low seed-sequence-dependent gene silencing effect relative to the other siRNAs in the population.

FIG. 6 provides a ROC plot illustrating the improvement that the linear regression model described in the present invention has over a prior art method using weighted FASTA alignment count score.

FIG. 7 depicts an exemplary embodiment of a computer system useful for implementing the methods of the present invention.

FIG. 8 provides one embodiment of a flow chart for selecting from a plurality of different siRNAs one or more siRNAs that have a strong down-regulation effect and a low seed-sequence-dependent gene silencing effect relative to the other siRNAs in the population, where preferably the siRNA is either an siRNA whose passenger stand is modified by a passenger-strand-blocking chemical modification.

### 7. DETAILED DESCRIPTION OF THE INVENTION

The present invention provides a method for determining the probabilities that an RNAi compound modulates (or, in a specific embodiment, down-regulates) the expression level of each gene in a set of genes of interest using a linear model. The present invention provides a linear model which is used to calculate the above probabilities, with each probability provided as a score representing the degree of likelihood that an RNAi compound modulates (or, in a specific embodiment, down-regulates) the expression levels of the respective genes. The score is a quantitative value of probability, with magnitude indicating degree of probability. The invention further provides a method to derive the coefficients of the above linear model based on empirical data. The invention also provides a method for identifying genes having seed-sequence-dependent match which are predicted to be down-regulated by an siRNA. The invention further provides methods for selecting siRNAs of higher silencing efficacy, specificity, and diversity.

The RNAi compounds used in the methods and products of the invention include but are not limited to miRNAs, siRNAs, and shRNAs. Reference to an RNAi compound as used herein shall be construed as referring to an miRNA, siRNA, and/or shRNA. As described above, these RNAi compounds render the expression level of their target genes controllable by base pairing interaction of their seed sequence with the seed match site on a transcript of the target gene or by base pairing interaction of any section of their nucleic acid sequence with a matched site on a target gene, up to and including a full length match. It should be noted that there can be more than one seed match site on the target gene.

The term “siRNA” as used herein refers to a nucleic acid molecule or complex thereof that is capable of loading one of its nucleic acid strands into the RNA-induced Silencing Complex (RISC) such that the strand detectably binds a known protein component of RISC, or alternatively refers to a nucleic acid molecule or complex thereof that has the same structural features as a nucleic acid molecule or complex thereof that has been shown to be capable of loading one or more of its nucleic acid strands into RISC. Structural features are meant to include length of duplex region(s) if any, length of single-stranded region(s) if any, and/or chemical structures of components of the siRNA, such as, as for example, but not limitation, sugar residues and nucleotide bases. Binding of such strand to RISC may be detected for example by a) recovery of a complex of the strand in association with the known protein component, such as via immunoprecipitation or b) functional activity of RISC detected in the presence of the strand but not in their absence, such as reduction in the expression level of one or more RNA targets known or predicted to show sequence complementarity to a nucleic acid portion of the strand. An siRNA can be single-stranded or double-stranded, and generally contains 7-30 nucleotides per strand. In a preferred embodiment, an siRNA is a duplex RNA molecule of 21, 22, or 23 nucleotides in each strand, composed of 19, 20, or 21 nucleotides, respectively, of duplex ribonucleotides with two unpaired nucleotides (overhang) on the 3′ end of each strand.

A RACE experiment can be used to determine whether cleavage by RISC occurs. By way of example but not limitation, a RACE experiment can be carried out as follows:
Using 96-well plates, A549 cells were treated with either 25 nM active or 25 nM control siRNA. To obtain sufficient RNA (5 μg), one 96-well plate was used for each treatment (96 replicates). Following 24 hr transfection, total RNA was isolated using standard Trizol (Invitrogen) isolation, using 2 mls Trizol per 96-well plate. The isolated RNA was used for RACE protocol.
The GeneRacer Oligo was ligated to total RNA by adding 5 mg total RNA, in 7 ml of H2O, to lyophilized GeneRacer Oligo and incubating at 65° C. for 5 minutes. The mixture was placed on ice for 2 minutes, centrifuged briefly, then to it was added 1 ml 10× ligase buffer, 1 ml 10 mM ATP, 1 ml RNAse Out (40 U/ml), and 1 ml T4 RNA ligase (5 U/ml). The mixture was mixed gently, and then incubated at 37° C. for 1 hour. Following 1 hour incubation, 90 ml DEPC H₂O and 100 ml phenol:cholorform was added. The mixture was vortexed on high for 30 seconds then centrifuged 5 minutes on high. The aqueous layer was transferred to a new eppendorf tube. To this layer was added 2 ml glycogen, 10 ml 3M sodium acetate and then mixed. 220 ml of ethanol was then added. The mixture was inverted several times to mix then placed on dry ice for 10 minutes. It was centrifuge on high at 4° C. for 20 minutes. The supernatant was aspirated then wash with 70% ethanol. It was centrifuged for 5 minutes on high and the supernatant was removed. The pellet was allowed to dry for 2-3 minutes. The pellet was suspended in 10 ml of DEPC H2O.
To 10 ml of the ligated RNA was added 1 ml 10 mM RT-Primer (Target primer 1), 1 ml 10 mM dNTP mix, and 1 ml DEPC H₂O then the mixture was incubated at 65° C. for 5 minutes, followed by placing on ice for 2 minutes, and centrifuging briefly To this was added 4 ml 5× first strand buffer, 1 ml 0.1M DTT, 1 ml RNAse Out (40 U/ml), and 1 ml Superscript III RT (200 U/ml). The mixture was mixed gently then incubated at 50° C. for 45 minutes followed by 65° C. for 7 minutes. The RT reaction was inactivated by incubating at 70° C. for 15 minute and then placing on ice. The mixture was centrifuged briefly. To it was then added 1 ml RNAse H (2 U) followed by mixing gently and then incubating at 37° C. for 20 minutes. This mixture was then either stored at −20° C. or used immediately for PCR.
Using 1 ml of the RT reaction above as template, a standard PCR amplification was performed for 34 cycles using 5′ GeneRacer primer and 3′ Gene Specific primer (Target primer 1). The specificity was increased by use of a 60° C. annealing temperature. Using 1 ml of the PCR reaction above as template, a Nested PCR was performed reaction for 34 cycles using the GeneRacer Nested 5′ primer and Nested 3′ Gene Specific primers (Target primer 2). The specificity was increased by use of a 60° C. annealing temperature. The samples were analyzed on native 6% PAGE. The bands of expected size were cut out and eluted from gel using SNAP columns provided with the GeneRacer kit. The eluted gel bands were cloned using a TOPO TA Cloning kit provided with the GeneRacer kit. LB-Amp agar plates containing colonies were PCR screened and sequenced.

The term “seed sequence” as used herein refers to the first 8 nucleotides, numbered 1-8 respectively, at the 5′ end of an RNAi compound. If the RNAi compound is an siRNA or an shRNA or an miRNA, the seed sequence refers to the first 8 nucleotides at the 5′ end of the guide strand of the double stranded siRNA, shRNA or an miRNA. Where it is not yet determined which strand is the guide strand of an siRNA or an shRNA or an miRNA, the score provided by the method of the invention, which represents a probability that the RNAi compound modulates a particular gene transcript, can be calculated for the first strand, and then for the other, with the score indicating the highest probability of transcription modulation (or, in a specific embodiment, down-regulation) taken as the actual score, and the strand providing the actual score taken as the guide strand.

The term “target site” as used herein refers to a portion of the sequence present on a transcript that forms classical Watson-Crick base pairing interactions with the entire sequence (excluding any 3′ overhang) of a strand of the RNAi compound and/or is a region of the target transcript that can be demonstrated to be subject to RISC mediated cleavage detected in the presence of the RNAi compound but not in its absence, such as reduction in the expression level of the target transcript. The term “target sequence” is used herein interchangeably with “target site”.

The term “seed match site” as used herein refers to a sequence of 8 nucleotides in the 3′UTR of a transcript that is compared to the seed sequence of the RNAi compound in the methods described herein. A seed match site is identical to a site in the 3′UTR region when there is a full 8-nucleotide perfect match between the seed sequence and the 3′UTR sequence (meaning that for each of the 8 nucleotides in the seed sequence, there is a complementary nucleotide, affording classic Watson Crick base-pairing, present on the 3′UTR sequence). When determining the number of nucleotides between the 5′ end of the seed match site in a 3′UTR sequence and the 5′ end of the 3′UTR sequence, the seed match site is a sequence in the 3′UTR with the most matches to the seed sequence (or the variant thereof as defined herein). A string-matching algorithm can be used to determine such matches (where if there is a tie for “most” matches, the sequence closest to the 5′ end of the 3′UTR is used).

The term “3′UTR” as used herein is the abbreviation of 3′ Untranslated Region. The “3′UTR sequence” referred to in the methods of the invention is the complete sequence from the end of the stop codon of a gene transcript to the last nucleotide before the poly-A tail of the gene transcript.

The term “seed-sequence-dependent signature size” with respect to an RNAi compound as used herein refers to the number of genes, or an indication of the number of genes, that have a transcript which is modulated or predicted to be modulated, or in one embodiment, which is down-regulated or predicted to be down-regulated, by an RNAi compound through a mechanism dependent on the presence of seed matched site(s) to the RNAi compound.

A mechanism dependent on the presence of seed matched site(s) can be detected by methods known by those of skill in the art, for example, but not limitation, expression profiling as described in Jackson et al., RNA. 12:1179-87 (2006); Jackson et al., Nat Biotechnol. 21:635-7 (2003) and Lim et al., Nature. 433 (7027):769-73 (2005).

Where seed-sequence-dependent signature size is the number of genes, or an indication of the number of genes, that are predicted to be modulated or down-regulated, the seed-sequence-dependent signature size is based on a score described herein, wherein the score represents the probability that the RNAi compound modulates the expression level of the transcript. Alternatively, the seed-sequence-dependent signature size of an RNAi compound can be determined empirically (experimentally).

In this application, an RNAi compound often is said to “modulate” the expression level of a gene. “Modulate” as used herein in such context means that the RNAi compound either up-regulates or down-regulates the expression of the gene. When gene regulation by an RNAi compound is discussed, the words “modulate” and “regulate” are often used interchangeably.

When reference is made herein to a particular sequence alignment algorithm such as VMATCH, BLAST, or FASTA, it will be clear that any suitable alignment algorithm that achieves essentially the same purpose can be used.

Section 6.1 of this application describes how a linear regression model for predicting the probability of transcripts being differentially modulated (or, in a specific embodiment, down-regulated) by an RNAi compound is created, including the generation of the coefficients used by the linear regression model. Section 6.1 also describes the application of such model. Section 6.2 describes the methods for determining the seed-sequence-dependent signature size of an RNAi compound, and the processing steps used to identify the number of genes that are significantly down-regulated by an siRNA. Section 6.3 describes methods used to select an siRNAs with the best gene silencing ability from a set of candidate siRNAs. Section 6.4 describes methods for using biomarkers for monitoring the seed-sequence-dependent gene silencing activity of an siRNA. Section 6.5 describes methods for interpreting the results of siRNA screens. Section 6.6 describes the implementation of the above methods in a computer system. Section 7 exemplifies embodiments of some of the methods described above.

7.1 Methods for Predicting the Probability that Transcripts are Differentially Modulated by an RNAi Compound

As described earlier in this application, multiple computer prediction models have been developed based on the established RNAi-mRNA interaction rules, especially the match between the seed sequence of RNAi compounds and their seed match sites on the mRNA sequence (Lewis et al., 2005, Cell, 120, 15-20; Grimson et al., 2007, Molecular Cell, 27, 91-105; Lewis et al., 2003, Cell, 115, 787-798; Krek et al., 2005, Nature Genetics 37, 495-500; Grin et al., 2005, PLoS Comp. Biol. 1:e13; Lall et al., 2006, Current Biology 16, 1-16; Chen and Rajewsky, 2006, Nat Genet 38, 1452-1456; Betel et al., 2008, Nucleic Acids Res. 36(Database Issue), D149-53). The models used to predict RNAi targets typically develop scoring schemes based on one or more of following features: RNAi sequence complementarity to mRNA, free energy calculation of RNA duplex formation, phylogenetic conservation, and target RNA structure.

In a preferred embodiment, the prediction model of the present invention, which determines the probability that an RNAi compound modulates (or, down-regulates) the expression level of a gene of interest, does not use the above features except for RNAi sequence complementarity. In particular, the prediction model of the present invention uses information, inter alia, on RNAi sequence complementarity between the seed sequence of the RNAi compound and the 3′UTR sequence of the mRNA of a target gene. The prediction methods of the invention are built upon a linear regression model. Using the linear regression model, the probability that transcripts are differentially modulated (or, down-regulated) by an RNAi compound is calculated and subsequently used as a basis for predicting the modulation (or, down-regulation) effects that the RNAi compound has on gene transcripts. The coefficients of such a linear regression model are derived by training the model with experimental data.

7.1.1 Model Creation

The invention provides a linear regression model to predict the probabilities that an RNAi compound modulates (or, in a specific embodiment, down-regulates) the expression level of a gene or each gene in a set of genes of interest. A general discussion of linear regression models can be found in, e.g., “Statistics and Data Analysis: From Elementary to Intermediate” by Amit C. Tamhane and Dorothy D. Dunlop, Prentice Hall, 1999. Linear regression is a statistical methodology to estimate the relationship of a response variable to a set of predictor variables.

The inventors have discovered that the probability that an RNAi compound modulates the expression level of its target gene correlates with the number of certain types of seed matches between the seed sequence of the RNAi compound and the 3′UTR sequence of a transcript of the target gene.

The types of seed matches (seed match types), between the seed sequence of the RNAi compound and the 3′UTR region of a transcript of the target gene, include both full match and partial matches. For example, the inventors have discovered that the numbers of 8mer, 7mer and certain 6mer seed match types influence the level of expression of a gene. The 8mer match is a perfect match of the seed sequence of an RNAi compound to the 3′UTR sequence of a transcript of the target gene (hereinafter referred to as “pm” seed match type). The 7mer and 6mer matches are partial matches. The 7mer matches consist of: 1) perfect match of nucleotides 1-7 and mismatch of nucleotide 8 between the seed sequence and the 3′UTR region of a transcript (hereinafter referred to as “m₁₋₇” seed match type); and 2) perfect match of nucleotides 2-8 and mismatch of nucleotide 1 in the seed sequence (hereinafter referred to as “m₂₋₈” seed match type). A perfect match means a complementary nucleotide is present in the transcript to form a classical Watson-Crick base pair with the corresponding nucleotide in the RNAi seed sequence. A mismatch means absence of a complementary nucleotide. One type of a 6mer match that can be used is a perfect match of nucleotides 2-7 and mismatch of nucleotides 1 and 8 in the seed sequence (hereinafter referred to as “m₂₋₇” seed match type). It will be clear to one skilled in the art that the 8mer match is a full match to the seed sequence of RNAi compound, and the 7mer and 6mer matches are partial matches. Non-limiting examples of the above seed match types, to illuminate the meaning of these matches, are as follows: assuming that bases 1-8 (seed sequence) of the guide strand of an RNAi compound are 5′-AUGCCGAA-3′ (SEQ ID NO: 1), a pm seed match type sequence on the target transcript. which matches to bases 1-8 of the guide strand of the RNAi compound, is 5′-UUCGGCAU-3′ (SEQ ID NO: 2). Similarly, the m₁₋₇ seed match type on the target transcript can have one of three potential sequences: 5′-UUCGGCAC-3′ (SEQ ID NO: 3), 5′-UUCGGCAG-3′ (SEQ ID NO: 4), 5′-UUCGGCAA-3′ (SEQ ID NO: 5) (these 3 sequences can also be represented by 5′-UUCGGCA(C/G/A)-3′ (SEQ ID NO: 6)). Likewise, the m₂₋₈ seed match types on the target transcript are as follows: 5′-(G/C/A)UCGGCAU-3′ (SEQ ID NO: 7). The m₂₋₇ seed match types on the target transcript are: 5′-(G/C/A)UCGGCA(C/G/A)-3′ (SEQ ID NO: 8).

The inventors have observed that a strong correlation exists between the length of the 3′UTR sequence of a transcript and modulation by an RNAi compound of the same transcript.

In a preferred alternative embodiment, a variant of the seed sequence is used to determine the numbers of seed match types. This variant is identical to the seed sequence except that a nucleotide U replaces the nucleotide at position 1 of the seed sequence. Thus, in this embodiment, the siRNA is treated as thought it contains a U in position 1 in the seed sequence (guide strand) (regardless of what nucleotide is actually present at that position), and then all features are calculated as previously described. To illuminate the meaning of the above, non-limiting examples of the seed match types of such a variant are as follows: assuming that bases 1-8 of the seed sequence of the guide strand of an RNAi compound are 5′-AUGCCGAA-3′ (SEQ ID NO: 1), the variant of the seed sequence replaces the nucleotide A at position 1 of the seed sequence and creates a new sequence of 5′-UUGCCGAA-3′ (SEQ ID NO: 9). All features described previously are now calculated based on this new sequence. For example, the pm seed match type on the target transcript, which matches to bases 1-8 of the guide strand of the RNAi compound, is 5′-UUCGGCAA-3′ (SEQ ID NO: 10). The m₁₋₇ seed match types on the target transcript are now as follows: 5′-UUCGGCA(C/G/U)-3′ (SEQ ID NO: 11). The m₂₋₈ seed match types on the target transcript are: 5′-(G/C/A)UCGGCAA-3′ (SEQ ID NO: 12). The m₂₋₇ seed match types on the target transcript are: 5′-(G/C/A)UCGGCA(C/G/U)-3′ (SEQ ID NO: 13).

The invention provides a linear regression model for predicting gene modulation, or predicting down regulation, by an RNAi compound. The model comprises the following predictor variables: the number of 8mer matches between seed sequence of RNAi compound and 3′UTR sequence, or a variant thereof, of a transcript, the number of 7mer matches of the same, the number of 6mer matches of the same, and the length in number of nucleotides of the 3′UTR sequence of the transcript. In this application, the above predictor variables are also called features. In a preferred embodiment, a linear regression model comprises the following features: #pm=the number of pm matches, #m₁₋₇=the number of m₁₋₇ matches, #m₂₋₈=the number of m₂₋₈ matches, #m₂₋₇=the number of m₂₋₇ matches, wherein the pm seed match type=perfect match of all nucleotides 1-8 in the seed sequence or the variant thereof, the m₁₋₇ seed match type=perfect match of nucleotides 1-7 and mismatch of nucleotide 8 in the seed sequence or the variant thereof, the m₂₋₈ seed match type=perfect match of nucleotides 2-8 and mismatch of nucleotide 1 in the seed sequence or the variant thereof, and the m₂₋₇ seed match type=perfect match of nucleotides 2-7 and mismatches of nucleotides 1 and 8 in the seed sequence or the variant thereof, wherein said variant is the seed sequence except that a nucleotide U replaces the nucleotide at position 1 of the seed sequence; and wherein a perfect match means a complementary nucleotide is present, and a mismatch means absence of a complementary nucleotide, and length(3′UTR)=the length of the 3′UTR sequence of the transcript. Thus, in a specific embodiment, for a given RNAi compound, in order to study its modulation effects on a gene of interest, the following linear model can be used to calculate the score of the probability that the gene is modulated (or, down-regulated) by the RNAi compound:

Score=A*#pm+B*#m₁₋₇+C*#m₂₋₈+D*#m₂₋₇+E*length(3′UTR)+optionally F (Equation 1)

wherein coefficients A, B, C, D, E, and F are constants. F is also the intercept of the linear regression model.

In a preferred embodiment, the effect of an RNAi compound on each gene in a set of genes of interest can be assessed by repeatedly using above Equation 1 to calculate the score of each gene in the set of genes of interest.

In another embodiment, additional features are optionally included in the linear regression model of Equation 1. These additional features exert additional influences on an RNAi compound's modulation of gene expression levels, but either are not as strong influences as the above features of #pm, #m₁₋₇, #m₂₋₈, #m₂₋₇, and length(3′UTR) or may not be of interest to a general application (e.g. tissue-specific transcript expression levels). By adding these additional features, the linear regression model of Equation 2 as set forth below is created:

Score=A*#pm+B*#m₁₋₇+C*#m₂₋₈+D*#m₂₋₇+E*length(3′UTR)+optionally F+optionally G*X (Equation 2)

wherein coefficients A, B, C, D, E, F and G are constants, and X is the value of one or more additional features G characterizing the influence of the RNAi compound on the transcript. When there is only one additional feature, such feature is represented in the form of G*X, wherein G represents the coefficient of feature X. When there are a plurality of additional features, the additional features may be represented by “G₁*X₁+G₂*X₂+ . . . GₙXₙ”, wherein n is the number of such additional features.

The above additional features may include, but are not limited to: the expression level of the target transcript, the number of m₃₋₈ seed match types, the number of m₁₋₆ seed match types, and/or the number of A/U nucleotides in the entire 3′UTR sequence. For example, the inventors have observed that additional types of timer seed match types, such as m₃₋₈ and m₁₋₆, correlate with gene expression levels.

The m₃₋₈ match is a perfect match of bases 3-8 and mismatches of bases 1 and 2 of the RNAi seed sequence to the 3′UTR sequence, or a variant thereof, of a transcript. The m₁₋₆ match is a perfect match of bases 1-6 and mismatches of bases 7 and 8 of the RNAi seed sequence to the 3′UTR sequence or the variant thereof; wherein said variant is the seed sequence except that a nucleotide U replaces the nucleotide at position 1 of the seed sequence. Therefore, in one embodiment, the number of m₃₋₈ seed match types and the number of m₁₋₆ seed match types between the seed sequence or the variant thereof and the 3′UTR sequence of the transcript of the gene, represented by #m₃₋₈ and #m₁₋₆ respectively, are included as additional features in Equation 2.

Additionally, the number of A/U nucleotides in the entire 3′UTR sequence, and the expression level of the gene of interest can be the additional features included in Equation 2. The number of A/U nucleotides in the entire 3′UTR sequence can be determined by counting the number of A nucleotides and U nucleotides in the portion of the gene that is after the stop codon and before the poly-A tail of a transcript. If the expression level of the transcript of a gene of interest is known, it can also be included as an additional feature in the linear regression model described in this application.

In some embodiments, features that have little or no impact on an RNAi compound's regulation of gene expression are not incorporated into the linear regression model. The inventors have discovered that certain features that have been widely used as predicting factors in RNAi target selection in some existing prediction models showed little impact on prediction when tested in the linear model of the present invention. For example, a phylogenetic conservation score has been used by prediction models such as TargetScan, PicTar and Miranda. The phylogenetic conservation score indicates the conservancy of seed match site between a 3′UTR sequence and one or more homologous genes of species different from that of the 3′UTR sequence. The assumption was that the more well conserved a seed match site is between species, the more likely it is a true miRNA seed match site. The accuracy rate of the prediction would presumably increase if the non-conserved RNAi positions are filtered out as false positives.

Contrary to the above prior art presumption, the inventors found that inclusion of a seed match site's phylogenetic conservation score only marginally improved the prediction of transcript regulation by miRNA. The phylogenetic conservation score is calculated in the prior art methods to measure the degree of conservation of target sequence and position across species. Improvement made by including the phylogenetic conservation score can be ignored if compared with the contribution of the features presently included in Equation 1. Phylogenetic conservation score was not a useful factor in predicting siRNA modulation effect either, possibly because siRNAs are introduced into cell cultures exogenously and thus are not under evolutionary pressure like miRNAs. As a result, in a preferred embodiment, the linear regression model of the invention does not include the feature of a phylogenetic conservation score of the target site across species.

In a specific embodiment, the linear regression model of the present invention explicitly excludes one or more of certain features which were found not to have predictive value in the present linear model (see Example 1). Such features include the distance of a seed match site to the beginning of the 3′UTR sequence, the distance of a seed match site to the end of the 3′UTR sequence, and matches of non-seed sequence of an RNAi compound to the 3′UTR sequence. These prior art features appear to be subsumed by the 3′UTR length feature of the present invention.

The linear regression coefficients A-G of above Equations 1 and 2 are determined by least squares fitting of experimental data. The process will be described in detail in Section 6.1.3. The values of the coefficients of Equation 1 are determined by fitting a training set of data to the linear regression model of Equation 1 (see Example 2). In one embodiment, coefficients A-F are: A=−1.671±0.04008, B=−1.292±0.02467, C=−0.5471±0.02371, D=−0.3876±0.01393, E=0.0001551±0.000007025, and F=0.002255±0.009319. The above coefficients are derived from the least squares fitting and are presented with one standard deviation. In a preferred embodiment, coefficients A-F are: A=−1.671, B=−1.292, C=−0.5471, D=−0.3876, E=0.0001551, and F=0.002255. In another embodiment, coefficients A-F are: A=a negative number, B=a negative number, C=a negative number, D=a negative number, E=a positive number, F=a positive or negative number or zero. This third set of coefficients is an extrapolation of the first two sets of coefficients. It provides a less fine, but better-than-random prediction of an RNAi compound's effect on gene expression levels.

In another embodiment, coefficients A-D could be a positive number or zero, and coefficient E could be a negative number or zero. The exact number depends on the quality and the composition of the data set that is used to train the above linear regression model. These coefficients of the other embodiment provide less accurate, but still better-than-random prediction of an RNAi compound's effect on gene expression levels.

The output of the linear regression model of the present invention is in the form of a score. In one embodiment, the output is a set of scores, with each score representing a degree of likelihood that an RNAi compound modulates, or, in a specific embodiment, down-regulates, the gene expression level of a gene in a set of genes of interest, the details of which will be described below. In another embodiment, the score represents a degree of likelihood that an RNAi compound modulates, or down-regulates, the expression level of a gene of interest, the details of which will be described in Section 6.1.2.2. In a specific embodiment, the set of scores is used to determine the seed-sequence-dependent signature size of an RNAi compound. Such a seed-sequence-dependent signature size is, or is an indication of, the number of genes that have a transcript which the respective score predicts is modulated by the RNAi compound. Further details on determination of seed-sequence-dependent signature size will be described in Section 6.2.

The score output from the linear regression model of the present invention can be in three forms: (a) a log-odds, which log-odds can be a log-odds that the null hypothesis is true that the transcript (1) is not modulated, (2) is not down-regulated, (3) is modulated, or (4) is down-regulated, by the RNAi compound; (b) a p-value that is the probability that the null hypothesis that the transcript is not modulated or is not down-regulated by the RNAi compound is true, and (c) a measure of the relative expression of the transcript by a cell containing the RNAi compound and expression of the transcript by an analogous cell not containing the RNAi compound.

In one embodiment, the score output from the linear regression model is in the form of a log-odds. In a specific example of such an embodiment, such score measures the probability that the null hypothesis that a transcript is not modulated by the RNAi compound is true. One often chooses to determine the log-odds that a transcript is modulated when both up-regulation and down-regulation of gene expression are of interest. One such example is miRNA, where the expression levels of transcripts are observed to be either up-regulated or down-regulated by miRNAs. However, when only down-regulation is of interest, such as in the context of siRNAs where down-regulation is the prevalent phenomenon, a log-odds of the null hypothesis that a transcript is not down-regulated is true can be determined. The linear regression model which determines a log-odds that the null hypothesis that a transcript is not modulated is true and the linear regression model which determines a log-odds that the null hypothesis that a transcript is not down-regulated is true are based on two different sets of coefficients. The set of coefficients for the former is derived from differential gene expression profiles in which both up-regulated genes and down-regulated genes are included. The set of coefficients for the latter is derived from the same differential gene expression profiles but with the two-sided p-values transformed into one-sided p-values as described hereinafter. In the instances where the score is a log-odds that an alternative null hypothesis that the transcript is modulated or down-regulated is true [(a)(3) or (a)(4) listed above], one of skill in the art would readily recognize that such a score can be obtained by using a linear model described herein in which the signs of the coefficients (obtained as herein below in Section 6.1.3) are reversed (e.g. positive to negative, or negative to positive) relative to instances where the score is a log-odds that a null hypothesis is true that the transcript is not modulated or is not down-regulated, respectively.

In the present application, a log-odds that the null hypothesis that the transcript is not modulated (or down-regulated) [(a)(1) or (a)(2) listed above] by the RNAi compound is true, which is lower than a preselected threshold, indicates a high probability that the transcript is modulated (or down-regulated) by the RNAi compound. Conversely, a log-odds that the null hypothesis that the transcript is not modulated (or down-regulated) by the RNAi compound is true, which is higher than a preselected threshold, indicates a low probability that the transcript is modulated (or down-regulated) by the RNAi compound. In this application, unless otherwise specified, log-odds refers to the log-odds that the null hypothesis that the transcript is not modulated (or, down-regulated) by the RNAi compound is true. In a specific embodiment, the preselected threshold for log-odds is: −1.279, −1.996, or −2.299. It is clear that one skilled in the art can readily choose a desired threshold, and that a lower preselected threshold of log-odds means that siRNAs with high probability will have a higher likelihood of modulating (or, down-regulating) the respective transcript.

In a preferred embodiment, the score is in the form of a p-value. A “two-sided” p-value represents the probability that the null hypothesis that the transcript is not modulated by the RNAi compound is true. In a statistical analysis test, a p-value is the probability of obtaining a result at least as extreme as the one that was actually observed, assuming that the null hypothesis is true. In the present context of a two-sided p-value, the null hypothesis is that the expression level of the gene of interest will not be modulated by the given RNAi compound. A p-value that is lower than a preselected threshold casts doubt on the null hypothesis, and thus there is a high probability that the transcript is modulated by the RNAi compound. Conversely, if a p-value is above the preselected threshold, it means that the null hypothesis that expression level of the gene of interest will not be modulated by the given RNAi compound is likely true. In specific embodiments, the preselected thresholds for p-value are: 0.05, 0.01, or 0.001. It is clear that a lower preselected threshold of p-value provides a greater confidence level in the accuracy of the predicted probability of the RNAi modulation.

In a preferred embodiment, the score is in the form of a one-sided p-value. A one-sided p-value represents the probability that the null hypothesis that the transcript is not down-regulated by the RNAi compound is true. In a normal p-value analysis of gene regulation, two-sided p-values are used because a gene may be either up-regulated or down-regulated. However, the two-sided p-value is not suitable where only down-regulation is of interest. The direct effects of RNAi on gene expression and control are generally inhibitory. Therefore, if the p-values are transformed by methods well-known in the art to one-sided predictions of down-regulation, the p-values predicted by the model are one-sided p-values.

If the linear regression model is trained on expression data of genes which are both up-regulated and down-regulated, the p-value calculated from the empirical data may be a two-sided p-value or a one-sided p-value, depending on the method of transformation. In order to calculate the one-sided probability of down-regulation by an siRNA, a further step of converting the two-sided p-value to a one-sided p-value can be performed. The one-sided p-value for an siRNA may be calculated using the following formula:

$$o = \{ \begin{matrix}t / 2 & if mlr < 0 \\ 1 - t / 2 & if mlr \geq 0\end{matrix} \qquad ( Equation 3 )$$

where o is the one-sided p-value and t is the two-sided p-value; mlr is the abbreviation for “mean log ratio”, which is a mean of the log ratio of signal intensities from one or more probes on one or more arrays representing the transcript of interest. In two-color array experiments, mean log ratio is used to avoid dye-specific bias effects by using a dye swap design. Briefly, in the first microarray experiment, mRNAs from cells under condition A are labeled with fluorescent marker A; and mRNAs from cells under condition B are labeled with fluorescent marker B, and both mRNAs are contacted with the microarray in a hybridization experiment. The log ratios of the signal intensities between fluorescent marker A and fluorescent marker B are then determined. In a second microarray experiment, mRNAs from the cells under condition A are labeled with fluorescent marker B; and mRNAs from the cells under condition B are labeled with fluorescent marker A. The log ratios of the signal intensities between fluorescent marker B and fluorescent marker A are determined again. The above two log ratios are then averaged to determine the mean log ratio. In single-color array experiments, such as on Affymetrix arrays, mRNAs from cells under each condition are labeled identically but are applied to separate microarrays. The mean intensities of one or more probes for each transcript are calculated for each array, and the log ratio of the averages from one or more arrays is taken to determine the mean log ratio.

A one-sided p-value also can be converted to a two-sided p-value. If the linear model was trained on expression data of genes which only or predominantly involve down-regulation, such as siRNA-mediated gene regulation, the p-values predicted by the model are one-sided p-values. The one-sided p-value can be converted to a two-sided p-value using the following formula:

$$t = \{ \begin{matrix}2 o & if o < 0.5 \\ 2 - 2 o & if o \geq 0.5\end{matrix} \qquad ( Equation 4 )$$

where t is the two-sided p-value, and o is the one-sided p-value.

Log-odds and p-value are mutually transformable. A log-odds can be transformed into a p-value using the following equation:

pvalue=e^{logodds}/(1+e^{logodds}) (Equation 5)

A p-value can be transformed into a log-odds using the following equation:

$$logodds = log ( \frac{pvalue}{1 - pvalue} ) \qquad ( Equation 6 )$$

In another embodiment, the score is in the form of a measure of the relative expression of a transcript by a cell containing an RNAi compound and expression of the transcript by an analogous cell not containing the RNAi compound. This form of score is herein referred to as an “expression ratio.” In a specific embodiment, the score is in the form of an “expression log ratio.” An expression log ratio is the logarithm of the above expression ratio to the base of 10. In another specific embodiment, the score is in the form of “expression log₂ ratio.” The expression log₂ ratio is the logarithm of expression ratio to the base of 2. The expression log₂ ratio is also called the fold change. Fold change is commonly used in the analysis of gene expression data from microarray experiments. A positive fold change that is higher than a preselected threshold denotes a strong up-regulation effect of the RNAi compound. In specific embodiments, such thresholds are 1.5 fold, 2 fold, or 3 fold increase of expression level of a transcript. Conversely, a negative fold change denotes a decrease of expression level of a transcript thus denotes a down-regulation effect of the RNAi compound. A fold change at or near zero denotes a weak regulation effect by the RNAi compound.

In a preferred embodiment, the expression ratio is calculated by dividing the expression level of a transcript in a cell containing an RNAi compound by the expression level of the transcript in an analogous (preferably, same) cell not containing the RNAi compound. An expression ratio larger than one denotes a up-regulation effect of the RNAi compound. In another embodiment, the expression ratio is calculated by flipping the above numerator and the denominator. It is clear that in this case, an expression ratio larger than one denotes a down-regulation effect of the RNAi compound.

In a preferred embodiment, the score representing the likelihood that an RNAi compound modulates the expression level of a gene is in the form of a mean log ratio (mlr). It is known in the art that reversing fluorescent dye labeling in a microarray experiment helps to reduce errors caused by dye bias. As discussed above, the mean log ratio calculates a mean of the log ratios of signal intensities from a pair of microarray experiments where fluorescent dye labeling of nucleic acids contacted with a microarray is reversed in one microarray experiment relative to the other.

As will be clear, the mlr is related to the probability of modulation, or down-regulation, in that the larger the predicted modulation, or down-regulation, the more certain one can be that the relevant transcript is truly being modulated, or down-regulated.

7.1.2 Model Application

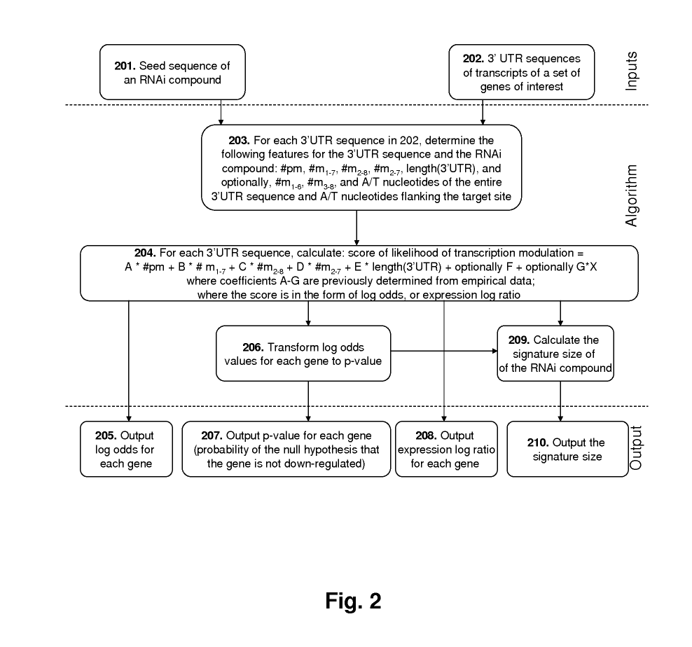

A linear regression model that predicts the probability of RNAi-mediated modulation of gene expression has been described in Section 6.1.1, above. In this section, exemplary processing steps for using the linear regression model to make such a prediction are described in conjunction with FIG. 2.

7.1.2.1 Methods for Determining the Probabilities that an RNAi Compound Modulates the Expression Levels of Each Gene in a Set of Genes of Interest

RNAi gene expression modulation can be a multiple-gene phenomenon. For example, It has been estimated that there are on average 7.1 target genes per miRNA within the human genome (John et al., 2004, PLoS Biol., 2, e363). Similarly, an siRNA may also regulate multiple genes, including some genes which the siRNA is not designed to target, but upon which it nevertheless exerts an influence. Therefore, it is desirable to predict the modulation effect that an RNAi compound has on each gene in a set of genes of interest, and thus to determine the specificity of the siRNA against the set of genes of interest.

The present invention provides a method for determining the probabilities that an RNAi compound modulates the expression levels of a set of user selected genes. The set of genes is customarily selected by the user and can include any number of genes. In specific embodiments, the set of genes includes at least N genes, preferably of a single species, where N is 2, 5, 10, 20, 40, 100, 200, 1000, 5000, 8000, 10,000, 25,000, or 50,000. In one embodiment, such a set of genes of interest includes all the genes known to be expressed in a genome of interest. In another embodiment, such a set of genes of interest is a set of genes from the same species, e.g., human, or non-human animal, mammal, plant, insect, nematode, yeast, etc. In another embodiment, such a set of genes of interest is the genes expressed to form a transcriptome. A transcriptome is a set of mRNAs which are actively expressed in one or a population of cells.

A flow chart of an exemplary embodiment of the method used to determine the probabilities that an RNAi compound modulates the expression levels of each gene in a set of genes of interest is shown in FIG. 2. The steps performed in the flow chart are described in detail below.

### Step 201

In step 201, the sequence of an RNAi compound of interest is provided. This RNAi compound may be an siRNA, miRNA or shRNA. In this step, the seed sequence of the RNAi compound, i.e., the first nucleotides at the 5′ end of the RNAi compound, is determined.

### Step 202

In step 202, the 3′UTR sequence of each gene in a set of genes of interest are obtained. As described above, the set of genes of interest can be customarily defined by a user, e.g., all the genes known to be expressed in a genome of interest, or a set of genes from the same species. Once the set of genes of interest is defined, the 3′UTR sequences of the transcript of the set of genes are obtained. This may be accomplished by manual compilation by the user, or by electronic downloading from public or private databases. In one embodiment, the 3′UTR sequences of all genes with available 3′UTR sequences in a genome of interest are downloaded, e.g., from the University of California Santa Cruz's genome center website (http://genome.ucsc.edu/). The file downloaded should contain all known 3′UTR sequences of the genome of selection, for example, the human genome, and may be further processed to extract the 3′UTR sequences of a set of genes of interest.

### Step 203

In step 203, the number of the seed match types of pm, m₁₋₇, m₂₋₈, and m₂₋₇ for each 3′UTR sequence of a transcript for each gene in the set of genes of interest selected in step 202 is determined. It will be clear to one skilled in the art that it is possible that more than one match site in a gene transcript may be found for a given seed match type. The number of each seed match type is then saved in variables #pm, #m₁₋₇, #m₂₋₈, and #m₂₋₇. Also in step 203, the length of the 3′UTR sequence for the transcript of each gene in the set of genes of interest is determined. In a preferred embodiment, the process of counting the number of seed match types and the length of the 3′UTR sequences is automated by a software program.

When Equation 2 is used, one or more additional features will be used. In one embodiment, the numbers of seed match types of m₃₋₈ and m₁₋₆ for the 3′UTR sequence of the transcript of each gene in the set of genes of interest selected in step 202 are used. In addition or alternatively, the number of A/U nucleotides in the entire 3′UTR sequence can be used. Alternatively or additionally, the expression level of the transcript can be used. Any one or more or all of the foregoing additional features can be used. In a preferred embodiment, the process of identifying the above features is automated by a computer program.

### Step 204

In step 204, the score representing a probability that the RNAi compound modulates one of the genes in the set of genes of interest is calculated. In one embodiment, linear model Equation 1 is used to calculate the score. Variables #pm, #m₁₋₇, #m₂₋₈, #m₂₋₇, and length(3′UTR), obtained from step 204, are imported into Equation 1. A set of predetermined coefficients A-F are also incorporated in Equation 1. In a preferred embodiment, the coefficients A-F are:

A=−1.671

B=−1.292

C=−0.5471

D=−0.3876

E=0.0001551

F=0.002255

When Equation 2 is used, one or more additional features X, and their associated coefficients G₁, represented by “G₁*X₁+G₂*X₂+ . . . Gᵢ*Xᵢ . . . GₙXₙ”, are incorporated in Equation 2. In one embodiment, the additional features described in step 203, along with their corresponding coefficients G₁, G₂, G₃, and G₄, are incorporated in Equation 2. These additional coefficients of G₁, G₂, G₃, and G₄ can be determined by the method disclosed in Section 6.1.3 below.

A score representing a probability that the RNAi compound regulates the given transcript is calculated. The score calculated is either in the form of a log-odds, or in the form of an expression log ratio, depending on which set of coefficients is used in the linear regression model. The details of determination of coefficients of the linear regression model are described in Section 6.1.3. In one preferred embodiment, the output score is a log-odds. In another preferred embodiment, the output score is in the form of a mean log ratio.

Steps 203 and 204 are repeated for each gene in the set of genes of interest. This produces a set of scores representing the probability that the RNAi compound modulates the expression levels of each gene in the set of genes of interest. The score calculated for each gene can be one or more of the scores output by steps 205, 207, and 208.

### Steps 205-208

Steps 205, 206-207, and 208 all output the scores representing the degrees of probability of the modulation, but in different forms. Step 205 outputs the prediction result directly from step 204 in the form of log-odds. Step 206 converts log-odds to p-value, using Equation 5. Step 207 outputs the converted p-values. The p-value represents the probability that the null hypothesis that the gene is not modulated by the RNAi compound is true. Step 208 outputs expression log ratio. Steps 205, 206-207, and 208 are all alternative steps.

It will be clear that probability of modulation can, in a preferred embodiment, be probability of down-regulation, by the siRNA.

### Steps 209 and 210

Steps 209 and 210 are part of the methods for identifying the seed-sequence-dependent signature size of an RNAi compound, which will be described in Section 6.2 below. The output step 210 is an optional step.

7.1.2.2 Methods for Determining the Probability that an RNAi Compound Modulates the Expression Level of a Specific Gene of Interest

The present invention also provides a method for predicting the probability that an RNAi compound modulates the expression level of a specific gene of interest. The steps of such method of prediction are identical to the method of predicting probabilities for a set of genes described above, with the exception that only the probability score for a single gene is determined. The probability score of the single gene is calculated using Equation 1. Alternatively, Equation 2 is used when additional predictive features are included. The methods in this section follow the same steps 201-208 as described in Section 6.1.2.1, with the following modifications:

In step 202, the 3′UTR sequence of a specific gene of interest is provided, instead of that of a set of genes of interest.

Steps 203 and 204 are not repeated because only one gene is of interest.

Steps 209-210 are eliminated, because seed-sequence-dependent signature size is a multi-gene phenomenon.

In a one embodiment, the method for predicting the probability that an RNAi compound modulates, or down regulates, the expression level of a specific gene of interest is repeated with a plurality of different siRNAs and a transcript of the specific gene of interest. In a specific embodiment, the gene of interest is known to be a biomarker (whose expression correlates or anti-correlates with a phenotype of interest). In a specific embodiment, the invention provides a method for determining whether a phenotype of interest is caused by an siRNA by determining the probability of down-regulation by the siRNA of a transcript of a biomarker for the phenotype. In such an embodiment, preferably more than N different siRNAs, each designed to target a different gene, is in the plurality of different siRNAs, with N being 10,000, 20,000, 30,000, 40,000, 50,000 or 60,000. The result of such a method is the probabilities of down-regulation of the specific gene for each of the siRNAs in the plurality, which indicates the probabilities that the phenotype of interest is caused by the respective siRNA.

7.1.3 Methods for Determining Coefficients of the Linear Regression Model

This section describes the processing steps for determining the coefficients of the linear regression models identified in Section 6.1.1. In one embodiment, the coefficients are derived from training data obtained from the differential gene expression profiles of a plurality of genes. Differential gene expression profiles comprise a plurality of measures and their associated intensities, each measure being of the relative expression of a transcript by a cell containing the RNAi compound and expression of the transcript by an analogous (preferably, same) cell not containing the RNAi compound, for transcripts of a plurality of different genes. Thus, for example, the measure can be a ratio of such expression by the analogous cell not containing the RNAi compound to expression by the cell containing the RNAi compound, often presented as a log ratio. In one embodiment, the training data may contain the data from differential gene expression profiles for thousands of genes. In a preferred embodiment, the training data is gene expression data obtained from microarray experiments. In a preferred embodiment, the coefficients are derived by fitting training data on the linear regression models identified in Section 6.1.1 using a least squares fitting method. In a preferred embodiment, the coefficients for Equation 1 are determined. In another embodiment, the coefficients for Equation 2 are determined.

Linear regression attempts to model the relationship between a response variable and a plurality of predictor variables by fitting a linear equation to observed data. The predictor variables are variables which are selected by an experimenter to determine their relationship to an observed phenomenon. The predictor variables are the input of a proposed linear equation. The response variable is the output of the proposed linear equation. The response variable is calculated with respect to the predictor variable. In the context of the present invention, the predictor variables comprise numbers of different seed match types and the length of the 3′UTR sequence of the transcript. The response variable is the score representing the degree of likelihood that the RNAi compound modulates the transcript.

The most common method for fitting a regression line is the method of least squares fitting. This method calculates the best-fitting line for the observed data (predictor variables) by minimizing the sum of the squares of the vertical deviations from each data point to the line.

The numbers A-F determined to generate a best fit are referred to as the model coefficients or parameters. A linear regression model equipped with coefficients can then be used to calculate the response variables with a given set of predictor variables. In the present invention, coefficients A-F are determined for Equation 1, or coefficients A-G are determined for Equation 2.

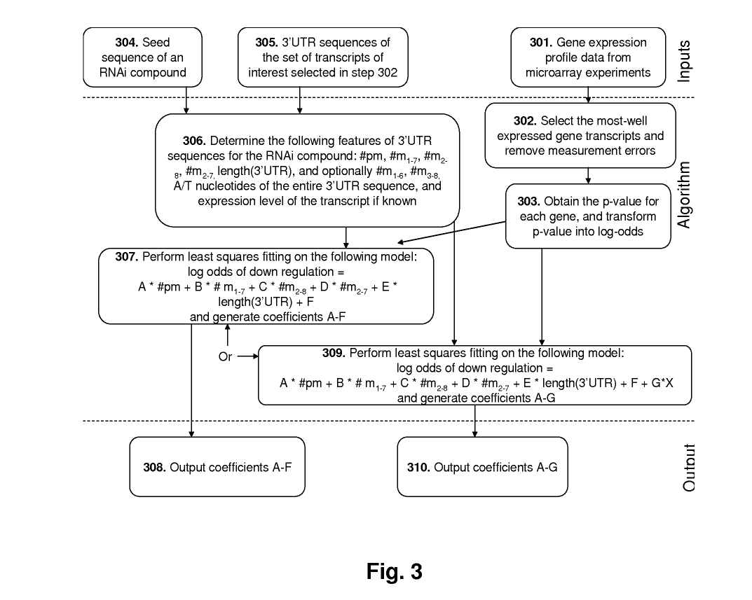

A flow chart of an exemplary embodiment of a method used to determine the coefficients of the linear regression model of the present invention is shown in FIG. 3. The steps performed in the flow chart are described in detail below.

Steps 301-303

In steps 301-303, the probability scores representing the degree of likelihood that a given RNAi compound modulates each gene in a set of genes of interest are obtained from one or more microarray experiments. The steps comprise obtaining differential gene expression profile data from microarray experiments, preferably selecting the most-well expressed genes and removing measurement errors, and obtaining an expression log ratio or a p-value of the genes, where in the case of a p-value, the p-value is further converted into a log-odds.

In step 301, the differential gene expression profiles for an RNAi compound are obtained. In specific embodiments, the above differential gene expression profiles are obtained from a gene expression study. Examples of such a gene expression study comprise a DNA microarray experiment, a RT-PCR assay, and a TaqMan assay.

In a preferred embodiment, the differential gene expression profiles of an RNAi compound are obtained from DNA microarray experiments. DNA microarrays are widely used to obtain gene expression profiles.

The training set of gene expression profile data can be obtained from several sources. In one embodiment, users can generate their own gene expression profiling data of an RNAi compound by conducting a microarray experiment. In an example of such an experiment, a cell culture is transfected with an RNAi compound. Gene expression profiles of such transfected cell cultures are then compared with cell cultures without transfection.

In another embodiment, instead of conducting an expression profiling experiment, a user can use previously stored gene expression profile data in databases. A rich repertoire of gene expression profile data exists in both public and private databases. A large amount of microarray experiment results have been contributed by the scientific community to various databases and some of these databases are freely available to the public. One example of such databases is Gene Expression Omnibus (GEO) (http://www.ncbi.nlm.nih.gov/geo/). GEO is a public database which contains thousands of differential gene expression profiles, including single and dual channel microarray-based experiments measuring mRNA, miRNA, genomic DNA, and protein abundance.

In step 302, transcripts of the most-well expressed genes in the differential gene expression profiles are selected and the measurement errors in the experimental data are removed. In one embodiment, the relative abundance of mRNA transcripts, as measured by hybridization intensity, is used to select a set of most well (i.e., the most highly) expressed transcripts. In a preferred embodiment, the above set of most well expressed genes include at least 8000 genes, at least 4000 genes, at least 2000 genes, at least 1000 genes, at least 200 genes, or at least 100 genes. Well expressed transcripts produce more reliable indication of the gene expression level changes than poorly expressed genes because the expression level changes of well expressed genes are less likely due to noise.

Microarray measurements are subject to many sources of errors which can affect the precision of the measurement results. Before the hybridization intensities from a microarray experiment are used to represent the changes in mRNA expression level, the intensity data are preferably preprocessed in order to remove measurement errors.

In a preferred embodiment, the intensity data is preprocessed using the Rosetta Error Model. The Rosetta Error Model is disclosed by Weng et al. in Bioinformatics, 2006, 22(9):1111-1121, incorporated herein by reference in its entirety. The Rosetta Error Model captures the variance-intensity relationship for various types of microarray technologies such as single-color arrays and two-color arrays. The model conservatively estimates intensity error, and use the estimated error to stabilize the signal variance.

The Rosetta Error Model is particularly powerful in increasing expression detection sensitivity and specificity when the number of data replicates is limited. Traditionally, fold changes are used to make differential calls in detecting differential expression. Often the call is made when a two-fold increase or decrease of gene expression is observed. The fold change method assumes no additive errors in microarray experiments. Additive error is the error that is added to the true value and does not depend on the true value itself. When additive error exists, the variation in fold change increases when measurement intensity value decreases. As a result, the fold change method can result in many false positives at the low intensity end. At the same time, its sensitivity is low in detecting small fold changes at the high intensity end where the measurement variation in log-ratio is low. Overall the fold change method suffers from both low sensitivity and low specificity.

The Rosetta Error Model improves the sensitivity and specificity of expression detection over the fixed fold change detection method by computing p-values in differential expression analysis. The null hypothesis is that a gene is not differentially expressed. At a given p-value, the Rosetta Error Model sets different fold change level thresholds for different measurement intensities. When intensities are low, only those having high fold change are called differentially expressed. For the same p-value threshold, when intensities are high, measurement intensities with low fold change are called differentially expressed. Therefore, sequences of low fold change can be confidently detected, because the false positives which are commonly seen in the fold change method have been greatly reduced.

In a preferred embodiment, p-values or log-odds are the preferred form of data relative to expression ratio data as the response variables for determining coefficients of the invention.

In some embodiments, other data preprocessing methods, such as background-subtraction, normalization, detrending, and fluorescent-reversal combination may be used in addition to the Rosetta Error Model.

In one embodiment, noise of the variance in transcript regulation is further reduced by averaging over multiple microarray experiments. Variance observed in the signal intensity measurement is mainly dependent on regulation by the transfected RNAi compound. However, part of the variance is also due to other factors such as variation between experimental replicates, variation between technical replicates, and microarray platform bias. Variance due to experimental and technical noise can be reduced by averaging over multiple microarray experiments. In one embodiment, the signal intensity measurements from 3 microarray experiment repeats against the same batch of a transfected cell culture are averaged. In another embodiment, the signal intensity measurements of 3 different batches of a transfected cell culture are averaged.

In one embodiment, noise of the variance in transcript regulation may be reduced by using two or more different types of DNA microarrays. Different types of DNA microarray chips normally do not show synchronized variance in transcript regulation. In order to reduce such platform bias, two or more types of DNA microarrays may be used. The synchronized variance observed in all types of DNA microarrays are selected as true positives. In one embodiment, an Agilent human 44K array and Affymetrix Merck Custom array are used, and signal intensity measurements of genes for which transcript regulation are synchronized on both platforms are selected.

In step 303, the expression log ratio or p-value of each gene in a set of genes is obtained, where the set of genes are the genes that are most well expressed in the set. The p-values are further transformed into log-odds using Equation 6. The expression log ratio or log-odds will be used in Equation 1 in step 307 and Equation 2 in step 309 to derive coefficients of the linear regression models.

It should be noted that if the linear regression model is trained on expression data of transcripts of genes that are both up-regulated and down-regulated, the p-value determined will be a two-sided p-value, indicating the probability that the null hypothesis that an RNAi compound does not modulate a particular gene transcript is true. This two-sided p-value can be converted to a one-sided p-value of down-regulation if desired. However, if only a prediction of down-regulation is of interest, the linear regression model will be trained either on two-sided p-values that have been converted to one-sided p-values or on only down-regulated genes, and the p-value determined will be a one-sided p-value, indicating the probability that the null hypothesis that an RNAi compound does not down-regulate a particular gene transcript is true.

Steps 304-306

In steps 304-306, features in the linear regression model of Equation 1 or Equation 2 for a target siRNA are determined. These features will then be linear squares fitted in Equation 1 in step 307 or Equation 2 in step 309.

In step 304, the seed sequence of the RNAi compound is determined. This RNAi compound is the RNAi compound whose differential gene expression profile is obtained in step 301 (i.e., the profile comprises measurements of differential expression of transcripts in cells transfected with the RNAi compound relative to analogous (preferably, same) cells not transfected with the RNAi compound).

In step 305, the 3′UTR sequences of the transcripts of the set of genes selected in step 302 are obtained. This step can be performed by downloading the 3′UTR sequences from a sequence database such as the UCSC Genome Table Browser database, and optionally by further selecting the 3′UTR sequences of the transcripts of a set of genes of interest.

In step 306, the features described in Section 6.1.1 are determined for a transcript of each gene in the set of genes of interest selected in step 302. Such features include seed match types #pm, #m₁₋₇, #m₂₋₈, #m₂₋₇ between 3′UTR sequence and seed sequence or variant thereof, and the length of the 3′UTR sequence of the transcript of the gene. Optionally, additional features described in Section 6.1.1 are also determined. Such features include seed match types #m₃₋₈ and #m₁₋₆ between 3′UTR sequence and seed sequence or variant thereof, the number of A nucleotides and U nucleotides in the entire 3′UTR sequence, and the expression level of the transcript.

The set of genes of interest selected in step 302 should collectively comprise one or more of each of the seed match type features in the linear regression model (Equation 1 and Equation 2), so that coefficients for each of the features can be derived. Thus, the selected set of genes should have transcripts that collectively comprise one or more of each of the #pm, #m₁₋₇, #m₂₋₈, #m₂₋₇ seed match types. Optionally, the selected transcripts all collectively comprise one or more of each of the #m₃₋₈ and #m₁₋₆ seed match types, when Equation 2 is used, and when these features appear in Equation 2.

Step 307-308

In step 307, the coefficients A-F in Equation 1 are derived by fitting the expression data obtained in step 303 and the feature data obtained in step 306 in the linear regression model Equation 1. As described earlier in this section, linear regression is a form of regression analysis in which the relationship between a plurality of predictor variables and a response variable is modeled by a linear function. In a preferred embodiment, the coefficients A-F in Equation 1 are derived by plotting a regression curve that has a least squares fit for the predictor variables of #pm, #m₁₋₇, #m₂₋₈, #m₂₋₇ and length(3′UTR) and the response variable of log-odds for each gene. In another embodiment, an expression log ratio can be used as an alternative to log-odds as the response variable. The linear regression slope is a measurement of the best fit straight line to all the experimental data. The numbers determined to give the best fits are coefficients A-F. F is the intercept of the linear model of Equation 1. In one embodiment, the statistics software R is used to conduct the linear regression analysis. The statistics software R is freely available to the public and may be downloaded from the web site of http://www.r-project.org/. However, the linear regression calculation needs not to be limited to the statistics software R. Software which have statistics functions, such as S-Plus®, JMP®, and Matlab®, can also be used. In one embodiment, any statistics software which is able to perform linear regression fitting can be used.

Step 308 is an optional step. In step 308, the coefficients A-F determined in step 307 are output.

Above step 301 may be conducted by combining the measures of replicate microarray experiments and then averaging the measures. For example, steps 301 average at least 3, at least 4, at least 10, or at least 20 differential gene expression profiles obtained from replicate microarray experiments measuring relative expression of respective transcripts by a cell containing the RNAi compound and expression of the transcripts by an analogous (preferably, same) cell not containing the RNAi compound. Experimental replicates help to reduce variance due to experimental noise. Experimental replicates may also be averaged before training the model on the averaged profile. Step 301 also may be repeated one or more times, each time using a different RNAi compound. The resulting set of coefficients is an universal set of coefficients which have improved prediction accuracy. A minimum of two RNAi compounds should be used for this optional step.

### Steps 309-310

Steps 309-310 are steps that can be performed alternatively or in addition to steps 307-308. In these steps, the coefficients of the linear regression model of Equation 2 are determined.

In step 309, the number of seed match types #pm, #m₁₋₇, #m₂₋₈, #m₂₋₇, #m₃₋₈, and #m₁₋₆, length(3′UTR), the number of A nucleotides and U nucleotides in the entire 3′UTR sequence, and the expression level of the transcript. When more than one additional predictor variable is included in Equation 2, G*X will be represented by G₁*X₁+G₂*X₂+G₃*X₃ . . . Gₙ*Xₙ, depending on the number of predictor variables. In one embodiment, four additional predictor variables G₁, G₂, G₃, and G₄ are included in Equation 2. The coefficients A-F, and G₁-G₄ in Equation 2 are derived by plotting a regression curve that has a least squares fit for the predictor variables.

Step 310 is an optional step. In step 310, the coefficients A-G determined in step 309 are output.

7.2 Methods for Determining the Seed-Sequence-Dependent Signature Size of an RNAi Compound

The invention provides methods for determining the seed-sequence-dependent signature size of an RNAi compound based on use of a linear model described above. In an embodiment according to the invention, a seed-sequence-dependent signature size of an RNAi compound is determined based on the probability scores of the RNAi compound modulating (or down-regulating) each gene in a set of genes of interest obtained as described in Section 6.1.2.1. The probability score represents the probability that the RNAi compound modulates (or, in a specific embodiment, down-regulates) the expression levels of each gene in a set of genes of interest. In one embodiment, the seed-sequence-dependent signature size is a count of a subset of genes in the set of genes of interest, which subset of genes all have probability scores that are above one threshold and/or below another threshold, depending on the form of the scores used.

In certain methods for selecting siRNAs for use in decreasing gene expression, a seed-sequence-dependent signature size of each siRNA is determined empirically based on measures of expression levels of a multiplicity of genes in a cell into which the siRNA has been introduced.

7.2.1 Methods for Determining the Seed-Sequence-Dependent Signature Size of an RNAi Compound Based on a Linear Regression Model

The probability score can be in the form of a log-odds, a p-value, or an expression ratio, which are described in 5.1.1. For example, if the score is in the form of a log-odds (log-odds), seed-sequence-dependent signature size can be the number of genes for which the log of probability is above a pre-selected threshold, comprising genes that are highly probable to be modulated. Alternatively, the seed-sequence-dependent signature size can be expressed as the standard deviation of the log-odds for the set of genes. If the score is in the form of a p-value, the seed-sequence-dependent signature size can be the number of genes that is below a pre-selected threshold, comprising genes that have low probability not to be modulated. If the score which is in the form of a measure of the relative expression of a transcript by a cell containing the RNAi compound and expression of the transcript by an analogous cell not containing the RNAi compound is a logarithm of the ratio of the expression by the cell containing the RNAi compound to the cell not containing the RNAi compound, the seed-sequence-dependent signature size can be the number of genes for which transcripts provide such a score that is above a first pre-selected threshold, e.g. 1.2, 1.5, or 2, comprising genes that are up-regulated, and below a second pre-selected threshold, e.g. 0.5, 0.67, or 0.83, comprising genes that are down-regulated. Other ways of determining seed-sequence-dependent signature size are described below. Therefore, the invention provides a method for determining the number of genes, or an indication of the number of genes, whose expression levels are predicted to be modulated by an RNAi compound, in a set of genes of interest.

If the RNAi compounds only with down-regulation effect are of interest, and the probability scores of the RNAi compounds are in the form of a measure of the relative expression of a transcript by a cell containing the RNAi compound and expression of the transcript by an analogous cell not containing the RNAi compound, the seed-sequence-dependent signature size can be calculated as the number of genes for which their transcripts provide a score that is below the above second pre-selected threshold.

It will be clear that where the measure of relative expression is a log ratio, it can be calculated in alternative ways by reversing the numerator and the denominator. For example, the measure can be the logarithm of the ratio of the expression of a transcript by a cell not containing the RNAi compound to expression of the transcript by an analogous cell containing the RNAi compound, or vice versa. Consequently, the seed-sequence-dependent signature size is determined using a reversed criteria for one type of ratio relative to another. For example, the seed-sequence-dependent signature size for the former type of log ratio (of expression by the cell not containing the RNAi compound to expression by the analogous cell containing the RNAi compound) is determined by counting the number of genes for which transcripts provide such a score that is above a pre-selected threshold, e.g. 1.2, 1.5, or 2, comprising genes that are down-regulated, and/or below another pre-selected threshold, e.g. 0.5, 0.67 or 0.83 comprising genes that are up-regulated.

Once the seed-sequence-dependent signature size for each siRNA in a set of siRNAs is determined, the specificity of the siRNAs can be evaluated based on their seed-sequence-dependent signature sizes. It will be clear that if a seed-sequence-dependent signature size is large, such as above a preselected threshold, a large set of genes are predicted to be modulated by the RNAi compound. This indicates that the RNAi compound has a low specificity in modulating a set of genes of interest. Likewise, if a predicted seed-sequence-dependent signature size is below a preselected threshold, it indicates that the RNAi compound has a high specificity in modulating a set of genes of interest. Preferably, in the case of an RNAi compound whose target silencing, but not seed-sequence-dependent silencing is desired, an RNAi compound is selected that will modulate at most 0, at most 5, at most 10, at most 20 or at most 50 genes having seed-sequence-dependent silencing effect through matching to the seed match sites at the 3′UTR region of those genes, predicted according to a linear model of the invention. Preferably, an RNAi compound is selected that modulates the expression levels of only genes functioning in the pathway of interest, or at most 5, at most 10, at most 20 or at most 50 additional genes. Although preselected thresholds can be used to evaluate the specificity of an siRNA in modulating a set of genes of interest, some of these thresholds are arbitrarily set and thus may not be the best parameters for selecting siRNAs with the lowest seed-sequence-dependent silencing effect. Thus, alternatively and preferably, the siRNAs are ranked according to their seed-sequence-dependent signature sizes, and a set of N siRNAs with the 1^{st} to N^{th} smallest seed-sequence-dependent signature sizes are selected, wherein N is the desired number of siRNAs to be selected, i.e., a positive integer. The desired number of N siRNAs may be determined for different target genes based on selection stringency in the number of genes having seed-sequence-dependent match.

When the RNAi compound is an siRNA, the seed-sequence-dependent seed-sequence-dependent signature size provides a method for evaluating the silencing specificity of the siRNA. For example, if an siRNA is predicted to have a large seed-sequence-dependent signature size, it shows that the siRNA has a strong seed-sequence-dependent silencing effect. In other words, the siRNA is predicted to target a large number of genes which are not the intended target. Therefore, seed-sequence-dependent signature size of an siRNA can be an useful parameter in measuring the seed-sequence-dependent silencing effect of the siRNA.

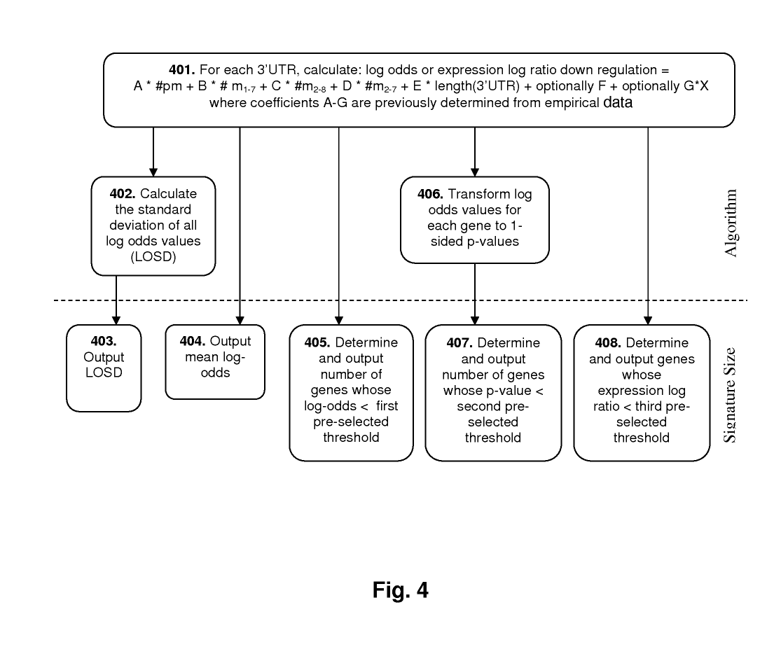

In one embodiment, the determination of the seed-sequence-dependent signature size of an siRNA is based on the linear regression model of Equation 1. In a preferred embodiment, the seed-sequence-dependent signature size of an siRNA is determined by following the steps in the flow chart of FIG. 4, described below. The steps in FIG. 4 are an exemplary detailed implementation of steps 209 and 210 in FIG. 2.

First, the log-odds or expression log ratio scores for the probabilities that an siRNA down-regulates each respective gene in a set of genes of interest are calculated, using the linear regression model of Equation 1 or Equation 2. The log-odds and expression log ratios can be calculated following steps 201-204 in FIG. 2, as described in Section 6.1.2.1. FIG. 4 starts from step 401 which is one embodiment of step 204 in FIG. 2.

Second, the seed-sequence-dependent signature size of the siRNA for the set of genes of interest is determined. In one embodiment, steps 402-408 are used, the details of which are described below.

There are various ways to identify the seed-sequence-dependent signature size of an siRNA, either using the log-odds and expression log ratio obtained above.

When the probability scores are in the form of log-odds, the seed-sequence-dependent signature size can be determined in one of several ways. In a preferred embodiment, as shown by step 402, the standard deviation of the log-odds for all the respective genes in the set of genes of interest is calculated. Standard deviation is a common measure of statistical dispersion, measuring how widely spread the values in a data set are. An equation that can be used to calculate standard deviation is:

$$SD ( x ) = \sqrt{\frac{1}{n} {\sum }_{i = 1}^{n} {( \overline{x} - {x}_{i} )}^{2}} \qquad ( Equation 7 )$$

In this context, xᵢ is the log-odds that gene i in the set of genes of interest is modulated. The set of gene is represented by {Xᵢ . . . X_{N}} where N is the number of genes in the set of genes of interest. x̅ is the mean of xᵢ's. The standard deviation of the log-odds for the set of genes of interest is calculated. Such standard deviation is represented as Logarithm of Odds Standard Deviation (LOSD). In a specific embodiment, any gene whose log-odds is outside of one LOSD of x̅ is considered to be a gene that is modulated by the siRNA, and thus is counted in determining seed-sequence-dependent signature size. In an alternative specific embodiment, the LOSD itself is used as the seed-sequence-dependent signature size, indicating the number of genes whose score predicts that it is modulated (or down-regulated) by the RNAi compound, with a LOSD above a preselected threshold indicating a large seed-sequence-dependent signature size. Likewise, a LOSD below a preselected threshold indicates a small seed-sequence-dependent signature size. Where the log-odds are for down-regulation, the LOSD is an indication of the number of genes predicted to be down-regulated by the siRNA. The LOSD is output in an optional step 403. In one embodiment, the 75 percentile of LOSD score is equal to 0.545, and any siRNAs with LOSD score above 0.545 is predicted to have a strong seed-sequence-dependent silencing effect. In such an embodiment, the 25 percentile of LOSD score is equal to 0.289, and any siRNAs with LOSD score below 0.289 is predicted to have a weak seed-sequence-dependent gene silencing effect. In another embodiment, the 90 percentile of LOSD score is equal to 0.680, and any siRNAs with LOSD score above 0.680 is predicted to have a strong seed-sequence-dependent silencing effect; and the 10 percentile of LOSD score is equal to 0.250, and any siRNAs with LOSD score below 0.250 is predicted to have a weak seed-sequence-dependent silencing effect. It should be noted that the thresholds selected for use can vary, depending, e.g., on time after siRNA introduction, method for measuring expression levels, etc. In an alternative embodiment, instead of using thresholds, the siRNAs with the 1^{st} to N^{th} smallest LOSD scores are selected, wherein N is the desired number of siRNAs to be selected, i.e., a positive integer.

In another embodiment, the absolute values of the log-odds for the respective genes are summed up and divided by the number of genes, to provide a mean log-odds. The mean log-odds score is another way that can be used to represent the seed-sequence-dependent signature size of the siRNA. A mean log-odds score above a preselected threshold indicates a large seed-sequence-dependent signature size. Likewise, a mean log-odds score below a preselected threshold indicates a small seed-sequence-dependent signature size. The mean log-odds score is calculated, and then is output in an optional step 404. In one embodiment, any siRNAs with a mean log-odds score above 75% of the mean log-odds score of all the siRNAs in the tested plurality are predicted to have a strong seed-sequence-dependent silencing effect; and any siRNAs with a mean log-odds score below 25% of the mean log-odds score of all the siRNAs in the tested plurality are predicted to have a weak seed-sequence-dependent silencing effect. In another embodiment, any siRNAs with a mean log-odds score above 90% of the mean log-odds score of all the siRNAs in the tested plurality are predicted to have a strong seed-sequence-dependent silencing effect; and any siRNAs with a mean log-odds score below 10% of the mean log-odds score of all the siRNAs considered in the tested plurality are predicted to have a weak seed-sequence-dependent silencing effect. In a preferred embodiment, siRNAs with the 1^{st} to N^{th} smallest mean log-odds scores are selected, wherein N is the desired number of siRNAs to be selected, i.e., a positive integer.

In yet another embodiment, the seed-sequence-dependent signature size of an siRNA is determined by using a preselected threshold of log-odds. Those genes whose log-odds are below the threshold are considered genes that are down-regulated by the siRNA. In specific embodiments, such a threshold can be −1.279, −1.996, or −2.299, depending on the stringency of the selection. The three log-odds thresholds of −1.279, −1.996, and −2.299 are converted from the p-values of 0.05, 0.01, and 0.005, using Equation 4 described above. The number of genes whose log-odds are above the threshold is considered the seed-sequence-dependent signature size of the RNAi compound; this number of genes is determined in step 405. Optionally, the identities of the genes whose log-odds are above the preselected threshold are output in step 405.

In a specific embodiment shown in step 406, in order to determine the p-value of each down-regulated gene, the log-odds that the null hypothesis that a transcript is not down-regulated is true are first transformed into p-values. The seed-sequence-dependent signature size can then be determined by selecting genes whose p-values are below a pre-selected threshold. In specific embodiments, such threshold can be 0.05, 0.01, or 0.005, depending on the desired confidence level of the selection. The number of genes whose p-values are below the threshold is counted to determine the seed-sequence-dependent signature size of the RNAi compound in step 407. Optionally, the selected genes are output in step 407. If the linear regression model in step 401 is trained on expression data of genes which are both up-regulated and down-regulated, the application of Equation 2 yields two-sided p-value. In such case, the two-sided p-value needs to be converted into a one-sided p-value in step 406 before it can be used to determine the seed-sequence-dependent signature size of the siRNA in step 407. The application of Equation 3 converts a two-sided p-value to a one-sided p-value.

When the probability score is in the form of an expression log ratio where the ratio is the expression of a transcript by a cell containing an RNAi compound to the expression of the transcript by an analogous cell not containing the RNAi compound, the seed-sequence-dependent signature size of the RNAi compound is the number of genes whose expression log ratio is below a preselected threshold. In other words, the genes that are under-expressed under the influence of the siRNA are counted to determine the seed-sequence-dependent signature size. The number of genes meeting the above expression log ratio selection threshold are determined in step 408. The selected genes are output in the same step 408. Preferably, expression is reduced at least 1.2-fold, at least 1.5-fold, or at least 2-fold.

7.2.2 Methods for Determining the Seed-Sequence-Dependent Signature Size of an RNAi Compound Empirically

In certain methods of the invention for selecting siRNA(s) for efficacy in their silencing effect, described below, as an alternative to determining the seed-sequence-dependent signature size of an RNAi compound using a linear regression model as described hereabove, the seed-sequence-dependent signature size of an RNAi compound is determined empirically. In one embodiment, a seed-sequence-dependent signature size of an RNAi compound is determined based on the p-value or LOSD of the measured expression levels of a multiplicity of genes. In a preferred embodiment, the seed-sequence-dependent signature size of an siRNA is determined by a method comprising the following steps:

First, cells are transfected with a candidate siRNA. The expression levels of a multiplicity of genes, preferably 40 or more, 400 or more, 4000 or more, or 40000 or more, are measured and compared to control cells that are not transfected with the candidate siRNA, or that are mock transfected or transfected with one or more control siRNAs. In a preferred embodiment, measurement errors are removed using the Rosetta Error Model as described in Section 6.1.3.

Second, the seed-sequence-dependent signature size of the candidate siRNA is determined by counting the number of genes with a significantly decreased level of expression of transcripts. In one embodiment, genes with a p-value for down-regulation of transcripts of below 0.05 are counted as down-regulated genes. In another embodiment, genes with a p-value below 0.01 are counted as down-regulated genes. The total number of down-regulated genes counted for the candidate siRNA is taken as the seed-sequence-dependent signature size of the siRNA.

In another embodiment, the seed-sequence-dependent signature size of the candidate siRNA is determined based on the LOSD of the siRNA. In this embodiment, the p-values for decreased expression levels of the multiplicity of genes in the assay are converted to log-odds values. The LOSD of these log-odds are then determined as described in Section 6.2.1. The LOSD is then taken as the seed-sequence-dependent signature size of the candidate siRNA.

It is clear that the seed-sequence-dependent signature sizes of a plurality of siRNAs can be determined by repeating the above procedure with different siRNAs.

7.3 Methods for Selecting from a Plurality of siRNAs One or More siRNAs for Silencing a Target Gene in an Organism

7.3.1 Methods for Selecting siRNAs Based on Silencing Specificity

The present invention provides several methods for selecting from a plurality of siRNAs one or more siRNAs with high silencing specificity relative to other siRNAs in the plurality with respect to a set of genes of interest.

In one embodiment, such selection is based on seed-sequence-dependent signature sizes of the siRNAs. As explained in Section 6.2, seed-sequence-dependent signature size provides a way to evaluate the silencing specificity of an siRNA with respect to a set of genes. The selection process can be extended by ranking siRNAs based on their seed-sequence-dependent signature sizes, from smallest to largest. siRNAs whose seed-sequence-dependent signature size ranks at the top of the list are considered having high silencing specificity against their gene targets. Therefore, in one embodiment, siRNAs with a seed-sequence-dependent signature size below a preselected threshold are selected as having high silencing specificity.

In another embodiment, selection of siRNAs with high silencing specificity against their gene targets is made based on the number of genes having seed-sequence-dependent match predicted for each siRNA. The selection process is described as follows. First, for each siRNA in a plurality of siRNAs, the score representing the probability that the siRNA down-regulates the expression level of each gene in a set genes of interest is determined according to the methods of the invention. The score can be in the form of a p-value, a log-odds, or an expression ratio, as described in Section 6.1.1. Next, the number of genes that is predicted to be modulated by the siRNA is determined based on a preselected threshold. For example, if the score indicating a probability of gene expression down-regulation is in the form of a p-value, a transcript is deemed to be modulated by the siRNA if a p-value is below a preselected threshold. If the score is in the form of a log-odds, a transcript is deemed to be modulated by the siRNA if the log-odds is below a preselected threshold. If the score is in the form of a expression ratio of the expression of a transcript by a cell containing an RNAi compound to the expression of the transcript by an analogous cell not containing the RNAi compound, a transcript is deemed to be down-regulated by the siRNA if the expression ratio is below a preselected threshold. The number of genes having seed-sequence-dependent match of an siRNA is determined by identifying from a set of genes of interest the number of genes predicted to be down-regulated by the siRNA, excluding the target gene of the siRNA. Once the number of genes having seed-sequence-dependent match for each siRNA in a plurality of siRNAs is determined, the plurality of siRNAs are ranked based on such number of genes. In the last step, one or more siRNAs is selected for which their number of genes having seed-sequence-dependent match is below a preselected threshold. Alternatively, in a preferred embodiment, the siRNAs with the 1^{st} to N^{th} smallest seed-sequence-dependent signature sizes are selected from the ranked list, wherein N is the desired number of siRNAs to be selected, i.e., a positive integer.

7.3.2 Methods for Selecting siRNAs Based on Silencing Specificity, Efficacy and/or Diversity

The present invention also provides methods for selecting from a plurality of siRNAs one or more siRNAs for silencing a target gene in an organism. Specifically, the invention provides methods for identifying one or more siRNAs which have the highest silencing efficacy, specificity and diversity against the target gene from among a plurality of candidate siRNAs. In the context of the present invention, silencing efficacy refers to as the power of an siRNA to silence the expression of a given transcript. Silencing specificity refers to the quality of an siRNA being specific for silencing the expression of the transcript of a target gene without asserting influence on the transcripts of genes having seed-sequence-dependent match. For example, an siRNA with few predicted genes having seed-sequence-dependent match is considered as having good silencing specificity. Silencing diversity is described as the variety between two candidate siRNAs in terms of sequence composition and the spacing between their target sites on the sequence of a target transcript, as described below.

7.3.2.1 A Method for Selecting siRNAs or shRNAs for Silencing a Target Gene in an Organism

The present invention provides methods for selecting from a plurality of siRNAs or shRNAs one or more siRNAs or shRNAs for silencing a target gene in an organism. The plurality of siRNAs have passenger strands that are or are not chemically modified to inhibit silencing activity mediated by the passenger strands.

In one embodiment, the silencing efficacy of each siRNA in the plurality of siRNAs is evaluated by use of PSSMs. The absolute value of the calculated PSSM score correlates with the silencing efficacy of the siRNA. In one embodiment, this step comprises calculating the PSSM score for each siRNA in a plurality of siRNAs. The plurality of siRNAs are then ranked based on their PSSM scores. One or more siRNAs with PSSM scores falling into a presented range are selected.

A PSSM is a sequence motif descriptor which captures the characteristics of a functional sequence motif. A general discussion of PSSM can be found in, e.g., “Biological Sequence Analysis” by R. Durbin, S. Eddy, A. Krogh, and G. Mitchison, Cambridge Univ. Press, 1998; and Henikoff et al., 1994, J. Mol. Biol. 243, 574-8. In the context of siRNA silencing, a PSSM is a sequence motif descriptor which records the different weights at different positions of a functional sequence motif and thus captures the characteristics of the sequence. The weights at different positions are derived empirically from those siRNAs that are known to target and silence genes with the functional sequence motif. The weight of bases A, T, G and C in different positions of the functional sequence motif are then collected to form a PSSM scoring matrix. The resulting scoring matrix is subsequently used to calculate the PSSM score of an siRNA candidate whose silencing effect on the target gene is unknown. A PSSM score which falls into a preselected cutoff range is considered a good candidate for silencing the target gene.

Methods of selecting siRNAs with high silencing efficacy using PSSM scores are disclosed in International Publication No. WO 2005/042708. As described in WO 2005/042708, a PSSM is used to describe the functional sequence motif in a transcript sequence. The functional sequence motif comprises at least a portion of a sequence in the transcript that is targeted by an siRNA and one or more sequences in one or both flanking regions. In a preferred embodiment, the functional sequence motif comprises 39 nucleotides which consist of a 19 nucleotide siRNA target sequence and a flanking sequence of 10 nucleotides at either end of the siRNA target sequence. A functional sequence motif is characterized using the frequency of each G, C, A, U (or T) observed at each position along the sequence motif. A frequency matrix of the above sequence motif is derived from a library of P number of siRNA target sequences that exhibit a desired level of susceptibility or resistance to siRNA silencing. The library of P siRNAs is an siRNA training set for which correlations between the PSSM and the observed efficacy of the siRNAs are known. The resulting PSSM scoring matrix is then used to calculate the PSSM scores of the test siRNAs. The PSSM scores represent the predicted efficacy of the test siRNAs. In a preferred embodiment, siRNAs with PSSM scores ranging from −200 to 0 are considered to have high silencing efficacy. In another embodiment, siRNAs with PSSM scores ranging from −300 to +200 are considered to have high silencing efficacy.

In an optional step, screening for siRNAs with high silencing specificity can include the steps of eliminating siRNAs with significant sequence homology to transcripts of non-target genes. In one embodiment, the candidate siRNAs are queried against a sequence database which is purported to obtain sequences of transcripts of the majority of the genes of the organism of interest but which excludes the target gene. Among transcripts of all the genes in the database, a maximal match to the full length nucleotide sequence of an siRNA is identified from a full set of matches between the siRNA sequence and each gene. The process is continued until the maximal match for each siRNA in the set of plurality of siRNAs is obtained. Those siRNA with maximal match scores above a preselected threshold are eliminated as being low in silencing specificity. In one embodiment, siRNAs with a maximal match of more than 90% identity with at least one transcript of a non-target gene are eliminated. The sequence alignment may be conducted using any of the commonly used sequence alignment algorithms, preferably using the default parameters. Such algorithms include but are not limited to BLAST, FASTA and VMATCH. In one embodiment, siRNAs with less than 17 out of 19 nucleotides BLAST match to a non-target gene are selected. In another embodiment, siRNAs with less than 18 out of 19 nucleotides FASTA match to a non-target gene are selected. In yet another embodiment, siRNAs with less than 18 out of 19 nucleotides VMATCH match to a non-target gene are selected.

In a specific embodiment, siRNAs with high silencing specificity are selected based on their seed-sequence-dependent signature sizes. In one embodiment, the seed-sequence-dependent signature size of each siRNA in a plurality of siRNAs is determined using a method of the invention described in Section 6.2.1. In an alternative embodiment, the seed-sequence-dependent signature size of each siRNA is determined empirically based on expression data as described in Section 6.2.2. The siRNAs are then ranked according to their seed-sequence-dependent signature sizes. In one embodiment, siRNAs with a seed-sequence-dependent signature size below a preselected threshold are selected as siRNAs having high silencing specificity. Alternatively, in a preferred embodiment, the siRNAs with the 1^{st} to N^{th} smallest seed-sequence-dependent signature sizes are selected from the ranked list, wherein N is the desired number of siRNAs to be selected, i.e., a positive integer.

In another specific embodiment, the silencing specificity of each siRNA in a plurality of siRNAs is evaluated based on the number of genes predicted to have seed-sequence-dependent match for each siRNA according to a method of the invention. The details of this method have been described hereinabove.

In a preferred embodiment, the siRNAs having the desired levels of efficacy and specificity for a transcript are further evaluated for sequence diversity. Preferably, the sequence diversity characteristics used are quantifiable. For example, sequence diversity can be based on one or more of the minimal spacing between two candidate siRNAs in the 3′UTR sequence of a transcript, the GC content and the location of G/C in the target site of the transcript, and the distance between the target site and the stop codon in the 3′UTR sequence of the transcript, as described below.

In the context of this application, the step of selection of siRNAs for diversity or variety is also referred to as a “de-overlapping” step. In a preferred embodiment, the de-overlapping step selects a subset of siRNAs from a set of candidate siRNAs such that the target sequences of the subset of siRNAs are located at a minimum distance away from each other in the 3′UTR sequence, and the absolute value of the PSSM score of each siRNA of this subset of siRNAs ranks lowest among the siRNAs whose target sites are at least 2 nucleotides away from each other in said transcript sequence. In one embodiment, the siRNAs are positioned at least 2 nucleotides apart. In another embodiment, the siRNAs are positioned at least 5 nucleotides apart.

In some embodiments, the GC content of the siRNA functional sequence motif in the transcript of a target gene also is calculated. In one embodiment, the siRNA functional sequence motif consists of a siRNA target sequence ranging from 15-30 nucleotides in length and a flanking sequence of 200 nucleotides at either end of the siRNA target sequence. In a preferred embodiment, the siRNA functional sequence motif consists of a 19 nucleotide siRNA target sequence and a flanking sequence of 200 nucleotides at either end of the siRNA target sequence. In another embodiment, the siRNA functional sequence motif consists of a 19 nucleotide siRNA target sequence and a flanking sequence of 100 nucleotides at either end of the siRNA target sequence. In another embodiment, the siRNA functional sequence motif consists of a 19 nucleotide siRNA target sequence and a flanking sequence of 10 nucleotides at either end of the siRNA target sequence. In another embodiment, the siRNA functional sequence motif consists of a 19 nucleotide siRNA target sequence and a flanking sequence of 2 nucleotides at either end of the siRNA target sequence. In another embodiment, the siRNA functional sequence motif consists of a 19 nucleotide siRNA target sequence and a flanking sequence of 1 nucleotide at either end of the siRNA target sequence. In another embodiment, the siRNA functional sequence motif consists of a 19 nucleotide siRNA target sequence and no flanking sequence.

In some embodiments, the candidate siRNAs are selected based on the GC content and GC position in the target site of the transcript and the distance between the target sequence of the siRNA (if any) in the 3′UTR sequence to the 5′ end of the 3′UTR sequence of the transcript.

Additional filer to select efficacious siRNAs can be employed. In one embodiment, siRNAs with limited GC content at positions 2-7 of the target sequence are selected. In a preferred embodiment, siRNAs with GC content at positions 2-7 of the target sequence of 0 to 40% are selected. In another embodiment, siRNAs with GC content at positions 2-7 of the target sequence of 0 to 60% are selected. In another embodiment, the GC content at position 1 is 100%, i.e., position 1 is either G or C. In another embodiment, the GC content at position 19 numbered from the 5′ end of the 3′UTR sequence of the transcript is 0%, i.e., position 19 is neither G or C. In other words, only siRNAs with A or T at position 19 are selected. In another embodiment, the G/C content at positions 18 and 19 is 0 to 50%, i.e., 1 or no GC at positions 18 and 19.

Additional quality control filters can also be employed. In another embodiment, the distance between the target sequence of the siRNA in the 3′UTR sequence to the 5′ end of the 3′UTR sequence of the transcript is at most 100, 300 or 500 nucleotides. In some embodiments, siRNAs can be selected based on one or more or all or any combination of the above selection criteria.

Optionally, siRNAs can be further selected based on one or more or all or any combination of the following additional criteria.

In one embodiment, siRNAs targeting sequences not common to all documented splice forms of transcripts of the target gene are eliminated.

In another embodiment, siRNAs that have target sequences overlapping with simple or interspersed repeats in the transcript of the target gene are eliminated. “Simple repeats” refer to tandem repeats of short (e.g., 1-5 bases, more typically 1-3 bases) sequences. “Interspersed repeats” refer to longer repeats (e.g., between 20 to 90,000 bases, more typically about 1,000 bases). Interspersed repeats are found in all eukaryotic genomes. These sequences may propagate themselves by RNA mediated transposition. Both simple repeats and interspersed repeats can be readily identified and scored by someone skilled in the art. In one embodiment, one can use the program RepeatMasker (Available Web Site: http://ftp.genome.washington.edu/cgi-bin/RepeatMasker) to compare a siRNA target sequence to simple repeats and/or interspersed repeats in a database of such sequences. Because such simple repeats and interspersed repeats are generally specific to the species of organism from which the siRNA target sequence is derived, preferably the database is a database of simple repeats and/or interspersed repeats for an appropriate species or class of organism, (e.g., for human, mouse, rhesus monkey, to name a few). Typically, one makes such comparison using a “scoring matrix”, with either customized, or default parameters, and siRNAs with target sequences that are identified as “hits” in the database are eliminated.

In another embodiment, siRNAs with a target sequence overlapping with regions in the transcript which are masked by the DUST software program for low complexity are eliminated. DUST is a public-accessible software program which detects regions in a sequence that have low sequence complexity, and masks these regions from further sequence analysis. DUST computes scores for substrings based on how often different three-letter sequences occur in the substring. More occurrences of a three-letter sequences lead to a higher score that indicates lower complexity. Substrings with low complexity are masked from being analyzed by database searching applications. A general discussion of DUST can be found in, e.g., ftp://ftp.ncbi.nlm.nih.gov/pub/agarwala/windowmasker/windowmasker_suppl.pdf.

In still another embodiment, siRNAs targeting sequences positioned at least 75 bases downstream of the translation start codon of the transcript of the target gene are selected.

In still another embodiment, the siRNAs which have binding site(s) in the 5′UTR sequence of the transcript of the target gene are eliminated.

In still another embodiment, siRNAs targeting a sequence containing 4 consecutive guanosine, cytosine, adenine or uracil residues are eliminated.

In still another embodiment, siRNAs targeting a sequence containing recognition sites for one or more given restriction endonucleases, e.g., Xhol or EcoRI restriction endonucleases, are eliminated. This embodiment may be used to select siRNAs sequences for construction of the shRNA vectors.

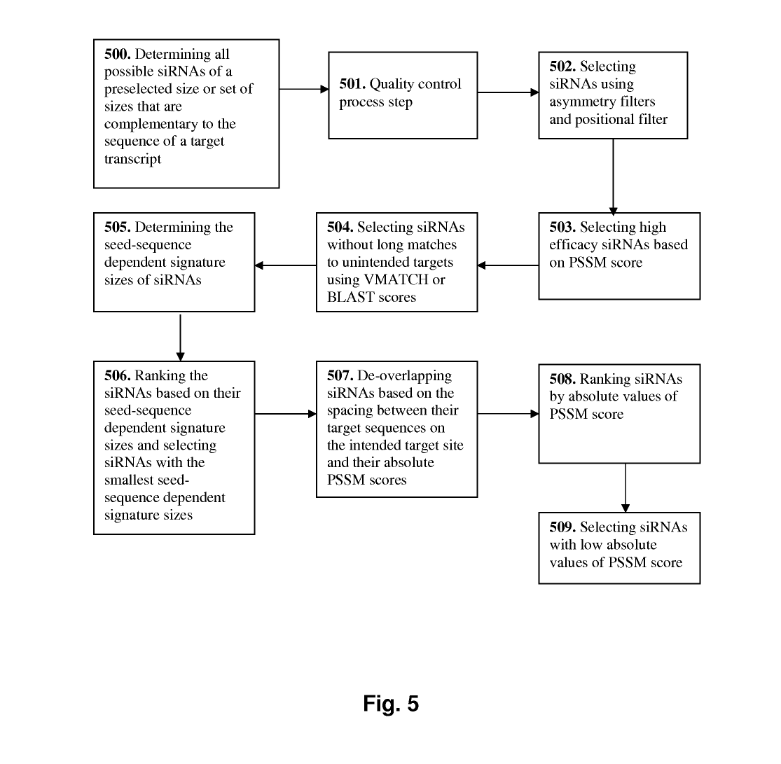

A flow chart of an exemplary embodiment of a method used to select siRNAs is shown in FIG. 5. It will be clear that any one or more of the selected steps, except steps 505 and 506, may optionally be omitted.

In step 500, all possible siRNAs of a preselected size or sizes (in specific embodiments, all of 21 nucleotide strand length; or all of 19, 20, or 21 nucleotide strand length) that are complementary (via complete sequence complementary of entire strand, not including any 3′ overhangs) to the sequence of a target transcript are determined. Preferably, the siRNAs are all of the same length, and are tiled across a sequence complementary to the complete transcript (except for the poly A tail). In one embodiment, this is done by selecting an siRNA whose sequence is complementary to a 19-nucleotide sequence on the target transcript, starting at the 5′ end of the transcript, and moving to the 3′ end of the transcript one nucleotide at a time, until the selected siRNAs tile over the entire length of the transcript.

In step 501, a quality control process step is performed in order to remove junk sequences, i.e., siRNAs with sequences that are clearly not suited for gene silencing. The candidate siRNAs are evaluated against the following filters: (A) removing siRNAs with a target sequence not common to all documented splice forms of transcripts of the target gene; (B) removing siRNAs with a target sequence overlapping with simple or interspersed repeat elements in the transcript; (C) removing siRNAs with target sequence overlapping with regions in the transcript which are masked by the DUST software program for low complexity; (D) removing siRNAs with a target sequence positioned within 75 nucleotides downstream of the translation start codon of the transcript; (E) removing siRNAs with one or more binding sites in the 5′UTR of the transcript; (F) removing siRNAs with a target sequence containing 4 or more consecutive guanosine, cytosine, adenine or uracil residues; (G) removing siRNAs with a target sequence containing one or more recognition sites for restriction endonucleases; (H) removing siRNAs with all nucleotides 1-8 of seed sequence perfectly matched with any known miRNAs in said organism (preferably by comparing to one of the publicly available databases of miRNA sequences); and (I) removing siRNAs with a target sequence which overlaps with any known SNPs in said organism (preferably by comparing to one of the publicly available databases of SNP sequences).

In step 502, the candidate siRNAs selected by step 501 are further evaluated using the one or more or all of the following criteria (referred to herein as “asymmetry filters”): (1) selecting one or more siRNAs which have either a guanine or cytosine residue at nucleotide 1 at the 5′ end of the siRNAs from the candidate siRNAs, or such that the selected siRNAs have one or no guanine or cytosine residues at positions 18 and 19 of said selected siRNA; (2) selecting one or more siRNAs from the candidate siRNAs such that, 0-40% of nucleotides 2-7, numbered from a 5′ end of the selected siRNA are either guanine or cytosine. In another embodiment, selecting siRNAs with G/C content in the range of 0-60% of nucleotides 2-7; and (3) selecting one or more siRNAs from the candidate siRNAs such that the target site of the selected siRNAs in the 3′UTR sequence of the transcript is at most 100 nucleotides, at least most nucleotides, or at most 500 nucleotides away from the 5′ end of the 3′UTR sequence of the gene transcript. At least 250 candidate siRNAs preferably are selected using the above asymmetry filters.

A positional filter is also employed, in which siRNAs with a target site in the coding region of the transcript are preferentially selected, but if insufficient candidate siRNAs have target sites in the coding region, 3′UTR siRNAs may also be selected in a limited manner. In one embodiment, an siRNA is selected if: there is a G or C at the first position of 5′ end of the siRNA, the G/C content at positions 2-7 of the 5′ end of the siRNA is 0-40%, there is no G or C at position 19 at the 3′ end of the siRNA, and the target site of the siRNA is at most 100 bases away from the 5′ end of the 3′UTR sequence of the transcript of the target gene. In another embodiment, an siRNA is selected if: there is a G or C at the first position of 5′ end of the siRNA, the G/C content at positions 2-7 of the 5′ end of the siRNA is 0-40%, there is no G or C at position 19 at the 3′ end of the siRNA, and the target site of the siRNA is at most 300 bases away from the 5′ end of the 3′UTR sequence of the transcript of the target gene. In another embodiment, an siRNA is selected if: there is a G or C at the first position of 5′ end of the siRNA, the G/C content at positions 2-7 of the 5′ end of the siRNA is 0-40%, there is no G or C at position 19 at the 3′ end of the siRNA, and the target site of the siRNA is at most 500 bases away from the 5′ end of the 3′UTR sequence of the transcript of the target gene. In another embodiment, an siRNA is selected if: there is a G or C at the first position of 5′ end of the siRNA, the G/C content at positions 2-7 of the 5′ end of the siRNA is 0-60%, there is no G or C at position 19 at the 3′ end of the siRNA, and the target site of the siRNA is at most 500 bases away from the 5′ end of the 3′UTR sequence of the transcript of the target gene. In another embodiment, an siRNA is selected if: there is a G or C at the first position of 5′ end of the siRNA, the G/C content at positions 2-7 of the 5′ end of the siRNA is 0-40%, and there is no G or C at position 19 at the 3′ end of the siRNA. In another embodiment, an siRNA is selected if: there is a G or C at the first position of 5′ end of the siRNA, the G/C content at positions 2-7 of the 5′ end of the siRNA is 0-60%, and there is no G or C at position 19 at the 3′ end of the siRNA. In another embodiment, an siRNA is selected if: there is a G or C at the first position of 5′ end of the siRNA, the G/C content at positions 2-7 of the 5′ end of the siRNA is 0-40%, and there is one or no G or C at positions 18 and 19 at the 3′ end of the siRNA. In another embodiment, an siRNA is selected if: there is a G or C at the first position of 5′ end of the siRNA, the G/C content at positions 2-7 of the 5′ end of the siRNA is 0-60%, and there is one or no G or C at positions 18 and 19 at the 3′ end of the siRNA. In another embodiment, an siRNA is selected if: there is a G or C at the first position of 5′ end of the siRNA, and there is no G or C at position 19 at the 3′ end of the siRNA. In another embodiment, an siRNA is selected if there is no G or C at position 19 at the 3′ end of the siRNA.

In step 503, the candidate siRNAs selected by step 502 are evaluated for silencing efficacy using PSSM scores. In one embodiment, the evaluation comprises calculating a PSSM score for each siRNA. The siRNA is selected if the score is between an upper threshold and a lower threshold. In one embodiment, the lower threshold is −300, and the higher threshold is +200. siRNAs with PSSM scores falling into the above range are selected as having high silencing efficacy. In another embodiment, a stricter range of between −200 and 0 is used. In a preferred embodiment of step 503, a minimum of 160 candidate siRNAs are selected to be used in a next selection step, even if the number of siRNAs of PSSM score between −200 and 0 is fewer than 160. If fewer than 160 siRNAs have PSSM scores between 0 and −200, the thresholds are extended to between −300 and +200. If fewer than 160 siRNAs are between these thresholds, all available sequences are selected and the algorithm proceeds with less than 160 candidate sequences.

In step 504, the candidate siRNAs selected by step 503 are further filtered by removing siRNAs with high sequence homology VMATCH, BLAST, or FASTA matches. The target sequence of each candidate siRNA is queried against a sequence database which is purported to obtain sequences of transcripts of the majority of the genes of the organism but which excludes the target gene. Such majority of the genes of the organism include all or almost all of the genes which are known to exist in the organism and whose transcript sequences are available in the database. When BLAST is used, those siRNAs with returned BLAST search results of 17 or more matching bases are removed. In one embodiment, the gene database used is TIGR Gene Indices database (TGI, http://compbio.dfci.harvard.edu/tgi/) from which the target gene has been removed. In one embodiment, the BLAST search is a collapsed BLAST search, meaning that transcripts are flagged according to the gene to which they belong, and matches to other transcripts of the gene are ignored. When FASTA is used, those siRNAs with returned FASTA search results of 18 or more matching bases are removed. In a preferred embodiment, the computer software program VMATCH is used to detect high homology matches, and those siRNAs with returned VMATCH search results of 18 or more matching bases are removed. It will be clear that the sequence alignment may be conducted using any of the commonly used sequence alignment algorithms.

In step 505, the seed-sequence-dependent silencing activity of each candidate siRNA selected by step 504 is evaluated according to the linear model of the invention to obtain a score indicating the probability that the siRNA modulates the expression levels of the transcripts of the set of genes of interest. The seed-sequence-dependent signature size of each candidate siRNA is then determined based on a method of the invention described in Section 6.2.1. Alternatively, the seed-sequence-dependent signature size of each candidate siRNA is determined empirically based on expression data as described in Section 6.2.2.

In step 506, siRNAs with the lowest seed-sequence-dependent silencing activities are selected. In one embodiment, the candidate siRNAs in step 505 are first ranked according to their seed-sequence-dependent signature sizes. Then, the siRNAs with the 1^{st} to N^{th} smallest seed-sequence-dependent signature sizes are selected from the ranked list, wherein N is the desired number of siRNAs to be selected, i.e., a positive integer. In a preferred embodiment, N is 10 and thus the siRNAs with the 1^{st} to 10^{th} smallest seed-sequence-dependent signature sizes are selected. In a different embodiment, the candidate siRNAs in step 505 are not necessarily ranked. Instead, the siRNAs whose seed-sequence-dependent signature sizes are below a preselected threshold are selected.

In step 507, the candidate siRNAs selected by step 506 are filtered for better diversity using a de-overlapping step. Briefly, siRNAs are first ranked according to some parameters thought to distinguish better from poorer performers and then selected for spacing between siRNAs according to some other parameter. In a preferred embodiment, a better performer refers to an siRNA with a low absolute value of PSSM score, while a poorer performer refers to an siRNA with a high absolute value of PSSM score. The siRNA with the lowest absolute value of PSSM score within a set of siRNAs is considered to be the best siRNA. The siRNA with the lowest absolute PSSM score is designated as selected in this step. Next, the siRNA with the next-lowest absolute PSSM score and with at least the minimum required spacing from the target site of the first selected siRNA, is selected from the list of siRNAs. siRNAs with a lower absolute PSSM score but not meeting the minimum spacing requirement are not selected. In one embodiment, the above minimum spacing is 2 nucleotides. In another embodiment, the minimum spacing is 5 nucleotides. In the end, a subset of siRNAs is selected such that the siRNAs in the subset are located at a minimum distance away from each other in the CDS sequence, and the absolute value of the PSSM score of each siRNA of this set of siRNAs ranks lowest among the siRNAs that are within the minimum spacing on the transcript. In one embodiment, at least 140 siRNAs candidates are selected in this process step. In another embodiment, if insufficient number of siRNAs are selected in a first pass of de-overlapping, the spacing requirement can be relaxed until the desired number, or the set of all remaining available siRNAs, is selected. In another embodiment, if insufficient number of siRNAs are selected in a first pass of de-overlapping, siRNAs in the 3′UTR can be chosen until the desired number, or the set of all remaining available siRNAs, is selected.

In step 508, the selected siRNAs are ranked by the absolute values of their PSSM scores, from the lowest to the highest.

In step 509, one or more siRNAs are selected. In a preferred embodiment, the first 3 siRNAs on the top of this ranked siRNA list are selected. The number of siRNAs can be adjusted based on the number of siRNAs desired to be selected.

7.3.2.2 A Method for Selecting One or More siRNAs for Silencing a Target Gene in an Organism

The present invention provides methods for selecting from a plurality of siRNAs one or more siRNAs for silencing a target gene in an organism. In a preferred embodiment, the plurality of siRNAs have a passenger strand that is chemically modified to inhibit silencing activity mediated by the passenger strand.

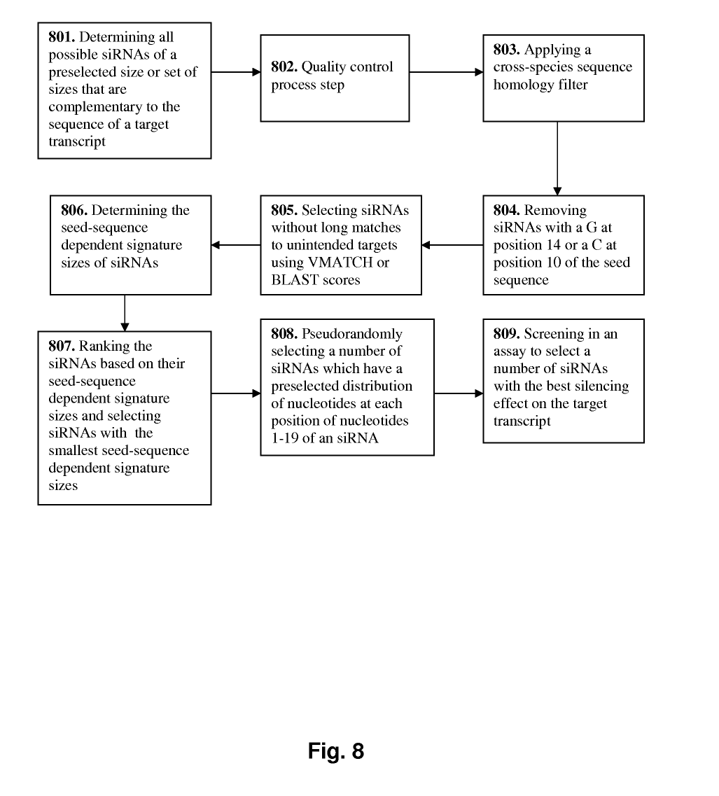

A flow chart of an exemplary embodiment of a method used to select siRNAs is shown in FIG. 8. It will be clear that any one or more of the selected steps, except steps 806 and 807, may optionally be omitted. Steps 802, 803, 804, and 805 can be performed in any order. In a specific embodiment, step 808 or 809, or both steps 808 and 809, are omitted.

In step 801, all possible siRNAs of a preselected size or sizes (in specific embodiments, all of 21 nucleotide strand length; or all of 19, 20, or 21 nucleotide strand length) that are complementary (via complete sequence complementary of entire strand, not including any 3′ overhangs) to the sequence of a target transcript are determined. Preferably, the siRNAs are all of the same length, and are tiled across a sequence complementary to the complete transcript (except for the poly-A tail). In one embodiment, this is done by selecting an siRNA whose sequence is complementary to a 19-nucleotide sequence on the target transcript, starting at the 5′ end of the transcript, and moving to the 3′ end of the transcript one nucleotide at a time, until the selected siRNAs tile over the entire length of the transcript.

In step 802, a quality control step is performed in order to remove siRNA with sequences that are not suitable for gene silencing or that interfere with other mechanisms of gene transcription regulation. The candidate siRNAs are evaluated against filters by performing one or more, preferably all, of the following steps, in any order: (i) removing siRNAs with a target sequence containing 4 or more consecutive guanosine, cytosine, adenine or uracil residues; (ii) removing siRNAs with one or more binding sites in the 5′UTR region of the transcript; (iii) removing siRNAs with a target sequence that starts more than 500 nucleotides 3′ of the 5′ end of the 3′UTR sequence of the transcript; (iv) removing siRNAs with a target sequence not common to all documented splice forms of transcripts of the target gene; (v) removing siRNAs with a target sequence overlapping with simple or interspersed repeat elements in the transcript; (vi) removing siRNAs with a target sequence overlapping with regions in the transcript which are masked by the DUST software program for their low sequence complexity, or which have significant matches to a database of known cloning vector sequences; (vi) removing siRNAs that have all nucleotides 1-8 of their seed sequence perfectly matched with any known miRNAs in the same organism (preferably by comparing to one of the publicly available databases of miRNA sequences); and (vii) removing siRNAs with a target sequence which overlaps with any known SNPs in the same organism (preferably by comparing to one of the publicly available databases of SNP sequences).

It will be clear that where siRNAs with silencing effects across a number of species are desired, the above steps (iv)-(vii) will be performed against the transcripts, miRNAs, and SNPS, as the case may be, of all the species of interest.

In step 803, which is optional, the candidate siRNAs selected by step 802 are further evaluated using a cross-species sequence homology filter. In one embodiment, where siRNAs with gene silencing effect across a number of species is desired, those siRNAs with target sequences which do not have sufficient homology/similarity across transcripts from the species of interest are eliminated. In a preferred embodiment, the species of interest are human, rhesus monkey, mouse, rat, dog, rabbit, and hamster. In another embodiment, the species of interest are human and mouse. In another embodiment, where siRNAs with gene silencing effect against one species, but not one or more other species, is desired, those siRNAs with a target sequence that have cross-species sequence homologies to transcripts of the other species are eliminated. In a preferred embodiment, the cross-species sequence homology search is performed using VMATCH with default parameters.

In step 804, which is optional, the candidate siRNAs selected by step 803 are evaluated for silencing efficacy using a base composition filter selecting against bases at positions known to reduce on-target silencing efficacy. In one embodiment, the evaluating comprises removing siRNAs which have a nucleotide G at position 14 of the seed sequence or a nucleotide C at position 10 of the seed sequence of the siRNA.

In step 805, which is optional, siRNAs with a sequence alignment score above a preselected threshold are removed. The sequence alignment may be conducted using any of the commonly used sequence alignment algorithms, preferably using the default parameters. Programs that can be used include but are not limited to BLAST, FASTA and VMATCH. In one embodiment, siRNAs with a less than 17 out of 19 nucleotide BLAST match to a non-target gene are selected. In another embodiment, siRNAs with a less than 18 out of 19 nucleotide FASTA match to a non-target gene are selected. In yet another embodiment, siRNAs with less than 18 out of 19 nucleotides VMATCH match to a non-target gene are selected.

In step 806, the seed-sequence-dependent gene silencing activity of each candidate siRNA selected by step 805 is evaluated according to a linear model of the invention to obtain a score indicating the probability that the siRNA modulates the expression levels of the transcripts of the set of genes of interest. The seed-sequence-dependent signature size of each candidate siRNA is then determined based on a method of the invention described in Section 6.2.1. Alternatively, the seed-sequence-dependent signature size of each candidate siRNA is determined empirically based on expression data as described in Section 6.2.2.

In step 807, siRNAs with the lowest seed-sequence-dependent gene silencing activity are selected. In one embodiment, the candidate siRNAs in step 805 are first ranked according to their seed-sequence-dependent signature sizes. Then, the siRNAs with the 1^{st} to N^{th} smallest seed-sequence-dependent signature sizes are selected from the ranked list, wherein N is the desired number of siRNAs to be selected, i.e., a positive integer. In a preferred embodiment, N is 100 and thus the siRNAs with the 1^{st} to 100^{th} smallest seed-sequence-dependent signature sizes are selected. In alternative embodiment, after or instead of ranking, the candidate siRNAs selected by step 805 are filtered by selecting one or more siRNAs whose seed-sequence-dependent signature sizes are below a preselected threshold.

In one embodiment, the method terminates at step 807. In another embodiment where the method does not terminate at step 807, a sufficient number of siRNAs is selected to facilitate subsequent processing steps.

One or both of two additional optional steps, 807a and 807b, may be conducted after step 807, and before optional steps 808 and/or 809, as follows:

Step 807a. This step is done to help ensure diversity of GC content in the selected siRNAs. Percentage GC content is determined for each of the siRNAs selected in step 807. A number of bins, with a predetermined range of GC content, are then used. In a specific embodiment, 20 bins are set up, with 0, 1, 2, 3, 4, 5, 6, 7, 8, 9, 10, 11, 12, 13, 14, 15, 16, 17, 18 or 19 G+C. Each siRNA is placed within one of the above bins of GC content, starting from the one with the smallest seed-sequence-dependent signature size. When the number of siRNAs in a particular bin has reached a preselected threshold, the next siRNA that would have been placed in the bin is discarded. In one embodiment, a maximum of 10 siRNAs are placed in each bin.

Step 807b. This step is done to ensure diversity of siRNAs over the length of a transcript of the target gene. In one embodiment, the entire length of the target transcript is equally divided in to a number of sections. Each siRNA is placed within one of the sections, starting from the one with the smallest seed-sequence-dependent signature size. When the number of siRNAs in a particular section has reached a preselected threshold, the next siRNA that would have been place in the section is discarded. In one embodiment, a maximum of 5 siRNAs are placed in each section.

In a preferred embodiment, the number of selected siRNAs is the number of siRNAs useful to conduct the pseudorandom selection in step 808. In a preferred embodiment, 100 siRNAs are selected and used to conduct the pseudorandom selection step. If a set of 100 siRNAs is not sufficient to give the preselected distribution of bases in the pseudorandom selection step, the number of siRNA selected in step 808 can be increased. If necessary, this process may be repeated until a sufficient number of siRNAs is selected in step 807 in order to satisfy the pseudorandom selection in step 808.

In step 808, out of the siRNAs selected in step 807, 807a, or 807b, Y number of siRNAs are selected using an algorithm to give a preselected distribution of nucleotides at each position of the entire length of an siRNA, wherein Y is a positive integer. In a preferred embodiment, the number Y ranges between 42-84. It is the purpose of the algorithm used in this pseudorandom step to obtain a population of siRNAs that have a preselected distribution of nucleotides at each position. In a preferred embodiment, such a distribution of nucleotides is an equal (25%) or near equal (25±2%) distribution of nucleotides A, U, G, and C at each position (e.g., of nucleotides 1-19) of an siRNA. In another specific embodiment, the population of siRNAs is selected so as to achieve a distribution of nucleotides that is an equal or near equal distribution of GC content at each position (e.g., of nucleotides 1-19) of an siRNA. The steps for conducting the pseudorandom selection process are as follows: first, form four bins, representing the four possible nucleotides, A, C, G or U, at position 1 of an siRNA, and repeat this process for all 19 positions so that there are 4×19 bins; next, choose one siRNA at random, and put the identity of the nucleotides of its target sequence into the appropriate bins which respectively correspond to each position of the siRNA sequence; next, consider each of the remaining siRNA, and compare how well the identity of the nucleotides of its target sequence will contribute to achieving the desired distribution of nucleotides at each position. Choose the sequence that best contributes to achieving the desired distribution of nucleotides. The above steps are conducted iteratively until the desired number of siRNAs have been obtained in the chosen set. At each iteration, the algorithm tests each possible sequence (from those that have not been yet chosen) by temporarily adding it to the chosen set, and then summing the Kullback Liebler (KL) divergence between the chosen set and the desired distribution at each position. The sequence that minimizes the KL divergence is chosen.

In optional step 809, the siRNAs selected by step 808 are then screened in a gene expression profiling assay to identify a number of siRNAs with the best silencing activity against the target gene. Preferably this is conducted by transfecting each siRNA into a cell and measuring gene expression levels. In a preferred embodiment, 4-12 siRNAs are selected in this step.

7.4 Methods for Using Biomarkers for Monitoring the Off-Target Activity of a Particular siRNA

The present invention provides methods for selecting biomarkers for monitoring the seed-sequence-dependent gene silencing activity of a particular siRNA.

As used herein, an “Seed-sequence-dependent Biomarker” refers to a gene that is not the intended target of an siRNA but that is down-regulated by the siRNA based on seed-sequence-dependent match. In a preferred embodiment, Seed-sequence-dependent Biomarkers selected are the genes that are down-regulated the most by the siRNA in a particular experiment and have seed-sequence-dependent match to the siRNA. Seed-sequence-dependent Biomarkers can be used to monitor the seed-sequence-dependent gene silencing activity of a particular siRNA. As described hereinabove, seed-sequence-dependent gene silencing activity can pose a significant obstacle for use of siRNA as a specific gene expression regulator. Adverse seed-sequence-dependent gene silencing activity due to cross-reactivity among unintended gene targets often is desired to be suppressed. Seed-sequence-dependent gene silencing activity from the passenger strand, the guide strand, or both strands can be monitored by the methods of this invention. It has been observed by the inventors that an siRNA with its passenger strand chemically modified increases the on-target and seed-sequence-dependent silencing of the guide strand. Thus, in a specific embodiment, the present invention provides methods for monitoring the reduction, or lack thereof, of the seed-sequence-dependent gene silencing activity of a particular siRNA after its passenger strand is chemically modified.

In one embodiment, the selection of Seed-sequence-dependent Biomarkers(s) is based on the predicted probabilities that an RNAi compound modulates the expression levels of each gene in a set of genes of interest, determined as described above. As explained in Section 6.1.2, the predicted probabilities provide a way to evaluate the silencing efficacy of an siRNA with respect to a plurality of genes having seed-sequence-dependent match. Thus, one can rank genes that are not intended targets of the siRNA, from the most probable of being down-regulated to the least probable of being down-regulated (or vice versa) by a particular strand of the siRNA. Genes having transcript that rank with the 1^{st} to N^{th} highest probabilities of down-regulation (N being the desired number of Seed-sequence-dependent Biomarkers) are considered as having high seed-sequence-dependent silencing efficiency, and thus to be effective Seed-sequence-dependent Biomarkers for the siRNA. In one embodiment, 2-12 genes per seed sequence are selected as Seed-sequence-dependent Biomarkers. In a preferred embodiment, transcripts are ranked by probability of being down-regulated by the particular strand of the siRNA and also filtered by observed regulation by the siRNA in an expression profiling experiment. This method results in selection of validated biomarkers specific for the particular siRNA strand. This method can then be applied to the other strand of the siRNA to obtain distinct biomarkers for each strand.

The selected Seed-sequence-dependent Biomarkers can then be used for monitoring the seed-sequence-dependent gene silencing activity of an siRNA, for example one whose guide or passenger strand is chemically modified (for example, by 2′-O-methylation). In one embodiment, the expression levels of the Seed-sequence-dependent Biomarkers by a cell containing an siRNA and the expression levels of the Seed-sequence-dependent Biomarkers by a cell not containing the siRNA are measured, for example, using TacMan qPCR, and compared to each other. The degree of reduction in the expression levels of the biomarkers measures the effectiveness of controlling seed-sequence-dependent gene silencing activity by the guide or passenger strand chemical modification.

7.5 Methods for Applying Seed-Sequence-Dependent Match to Identify Genes Involved with a Pathway/Phenotype of Interest

The present invention provides methods for applying seed-sequence-dependent match to interpret the results of siRNA screens. Traditional siRNA screens detect transcripts that are involved in a pathway of interest by silencing transcripts and looking for the correlation between targeting of a transcript with changes of phenotype. It is assumed that if the siRNA has an effect on a phenotype, it is because the gene that is the intended target of the siRNA is involved in the pathway that affects the phenotype. Instead of identifying genes targeted by an siRNA in siRNA screens to identify a gene involved in a pathway or phenotype of interest, the present invention provides methods for analyzing siRNA screens to identify gene(s) involved in a pathway or phenotype of interest using genes having seed-sequence-dependent match and are predicted to be down-regulated by the methods described hereinabove.

In one embodiment, a score indicating whether an siRNA down-regulates a transcript is calculated for the transcript of each gene in a set of genes of interest which have seed-sequence-dependent match to the siRNA. Preferably such set of genes are a transcriptome, i.e., all the gene transcripts that are actively expressed in an organism or a population of cells, excluding the target gene. The score is calculated using a linear model as described in Section 6.1.2 of this application. The above calculations are performed for each siRNA in a plurality of different siRNAs. Preferably, the probability of down-regulation is determined for each of the siRNAs being screened, for each transcript in the set. In one embodiment, a transcript is considered to be down-regulated if its mlr<0 or its p-value<0.01. Next, the effect of each siRNA of the above set of siRNAs upon a phenotype of interest is determined, if such data is not already available. Such effect can be determined, for example, by introducing the siRNA into a cell quantifying any change in the phenotype of interest. Next, the effects of the siRNAs upon the phenotype of interest are compared with the predicted down-regulation of the siRNAs of the transcripts of said set of genes. Transcripts are identified that exhibit a statistically significant correlation between down-regulation of the transcript across the siRNAs and the modulation of the phenotype across the siRNAs. The genes encoding these transcripts are considered as affecting the phenotype of interest.

7.6 Implementation Systems and Methods

The analytical methods of the present invention are preferably implemented using a suitably programmed computer system, such as the computer system described in this section, according to the following programs and methods. Such a computer system can also preferably store and manipulate measured signals obtained in various experiments that can be used by a computer system implemented with the analytical methods of this invention. Accordingly, such computer systems are also considered part of the present invention. Preferably, each step of the method of the invention is computer-implemented. Preferably, the score representing the degree of likelihood that an RNAi compound modulates the expression level of a gene of interest, or the seed-sequence-dependent signature size (optionally accompanied by a listing of the genes predicted to be modulated, or down-regulated), or the identity(ies) or sequence(s) of a selected one or more siRNAs, determined by a method of the invention, is output, e.g., to a user, a user interface device, a computer readable storage medium, or a local or remote computer system, or is displayed.

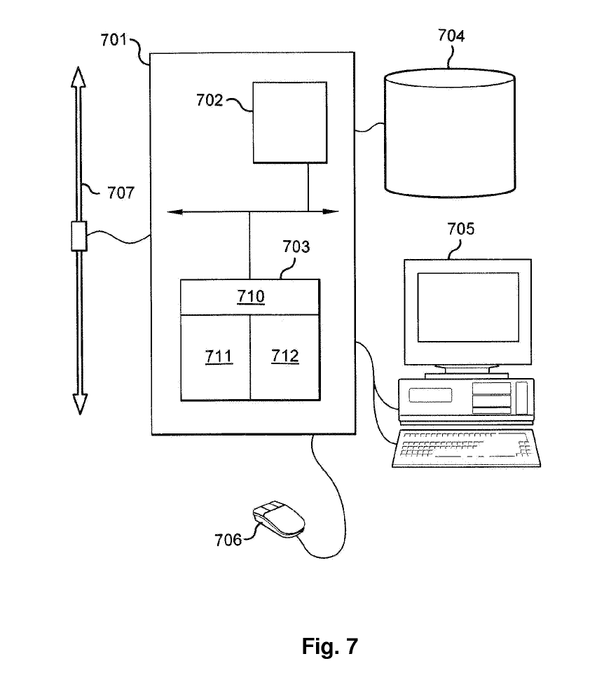

An exemplary computer system suitable for implementing the analytic methods of this invention is illustrated in FIG. 7. Computer system 701 is illustrated here as comprising internal components and as being linked to external components. The internal components of this computer system include one or more processor elements 702 interconnected with a main memory 703. For example, computer system 701 can be an Intel Pentium IV®-based processor of 2 GHZ or greater clock rate and with 256 MB or more main memory. In a preferred embodiment, computer system 701 is a cluster of a plurality of computers comprising a head “node” and eight sibling “nodes” with each node having a central processing unit (“CPU”). In addition, the cluster also comprises at least 128 MB of random access memory (“RAM”) on the head node and at least 256 MB of RAM on each of the eight sibling nodes. Therefore, the computer systems of the present invention are not limited to those consisting of a single memory unit or a single processor unit.

The external components can include a mass storage 704. This mass storage can be one or more hard disks that are typically packaged together with the processor and memory.

Such hard disks are typically of 10 GB or greater storage capacity and more preferably have at least 40 GB of storage capacity. For example, in a preferred embodiment, described above, wherein a computer system of the invention comprises several nodes, each node can have its own hard drive. The head node preferably has a hard drive with at least 10 GB of storage capacity whereas each sibling node preferably has a hard drive with at least 40 GB of storage capacity. A computer system of the invention can further comprise other mass storage units including, for example, one or more floppy drives, one more CD-ROM drives, one or more DVD drives, one or more Flash drives, or one or more DAT drives.

Other external components typically include a user interface device 705, which is most typically a monitor and a keyboard together with a graphical input device 706 such as a “mouse.” The computer system is also typically linked to a network link 707 which can be, e.g., part of a local area network (“LAN”) to other, local computer systems and/or part of a wide area network (“WAN”), such as the Internet, that is connected to other, remote computer systems. For example, in the preferred embodiment, discussed above, wherein the computer system comprises a plurality of nodes, each node is preferably connected to a network, preferably an NFS network, so that the nodes of the computer system communicate with each other and, optionally, with other computer systems by means of the network and can thereby share data and processing tasks with one another.

Loaded into memory during operation of such a computer system are several software components that are also shown schematically in FIG. 7. The software components comprise both software components that are standard in the art and components that are special to the present invention. These software components are typically stored on mass storage such as the hard drive 704, but can be stored on other computer readable media as well including, for example, one or more floppy disks, one or more CD-ROMs, one or more DVDs, one or more Flash memories, or one or more DATs. Software component 710 represents an operating system which is responsible for managing the computer system and its network interconnections.

The operating system can be, for example, of the Microsoft Windows family such as Windows 95, Window 98, Windows NT, Windows 2000 or Windows XP. Alternatively, the operating software can be a Macintosh operating system, a UNIX operating system or a LINUX operating system. Software component 711 comprises common languages and functions that are preferably present in the system to assist programs implementing methods specific to the present invention. Languages that can be used to program the analytic methods of the invention include, for example, PERL, C and C++, FORTRAN, HTML, JAVA, and any of the UNIX or LINUX shell command languages such as C shell script language. The methods of the invention can also be programmed or modeled in mathematical software packages that allow symbolic entry of equations and high-level specification of processing, including specific algorithms to be used, thereby freeing a user of the need to procedurally program individual equations and algorithms. Such packages include, e.g., R from R-Project (http://www.r-project.org/), Matlab® from Mathworks (Natick, Mass.), Mathematica® from Wolfram Research (Champaign, Ill.) or S-Plus® from MathSoft (Seattle, Wash.).

Software component 712 comprises any analytic methods of the present invention described supra, preferably programmed in a procedural language or symbolic package. For example, software component 712 preferably includes programs that cause the processor to implement steps of accepting a plurality of measured signals and storing the measured signals in the memory. For example, the computer system can accept measured signals that are manually entered by a user (e.g., by means of the user interface). More preferably, however, the programs cause the computer system to retrieve measured signals from a database. Such a database can be stored on a mass storage (e.g., a hard drive) or other computer readable medium and loaded into the memory of the computer, or the compendium can be accessed by the computer system by means of the network 707.

In addition to the exemplary program structures and computer systems described herein, other, alternative program structures and computer systems will be readily apparent to the skilled artisan. Such alternative systems, which do not depart from the above described computer system and programs structures either in spirit or in scope, are therefore intended to be comprehended within the accompanying claims.

### 8. EXAMPLES

The following examples are presented by way of illustration of the present invention and are not intended to limit the present invention in any way.

### Example 1

### miRNA Target Regulation and siRNA Off-Target Regulation are Linearly Related to the Number of Seed Match Types and the Length of 3′UTR Sequence of the Transcript of a Gene

RNAi compounds introduced into human cells have been observed to regulate a plurality of mRNAs through short stretches of complementarity. To identify the factors that can be used to predict miRNA targeting and siRNA seed-sequence-dependent gene silencing activities, the full and partial matches of the seed sequence of a miRNA to the 3′UTR sequence of mRNA, the length of the 3′UTR sequence, and their effects on gene expression regulation were examined.

1. miRNA Expression Profiling

The differential gene expression profiles of the miRNA family of miR-16 were obtained by use of miR-16 and HCT116 Dicer cells.

miRNAs.

miR-16 and miR-106b were used for differential gene expression profiling. miR-16 down-regulation triggers accumulation of cells in G₀/G₁ phase of cell cycle. The sequences of miR-16 and miR-106b are as follows:

| | | |
|---|---|---|
| miR-16 | Seed | (SEQ ID NO: 14) |

| hsa-miR-16 | UAGCAGCACGUAAAUAUUGGCG |
|---|---|
| miR-106b | |
| (SEQ ID NO: 15) | |
| miR-106b | UAAAGUGCUGACAGUGCAGAU |

Transfection with miRNA.

HCT116 Dicer cells were plated 24 h prior to transfection. HCT 116 Dicer cells were transfected in 6-well plates using Lipofectamine 2000 (Invitrogen, Carlsbad, Calif.). Duplexes were used at final concentrations of 100 nM.

Microarray Analysis.

HCT116 Dicer cells were transfected in 6-well plates, and RNA was isolated 6 to 24 h following transfection. Microarray analysis was performed as described previously (Jackson et al., 2003, Nat. Biotechnol. 21, 635-637). Genes identified by expression arrays were validated using quantitative reverse transcription PCR (qRT-PCR).

2. miRNA Seed Matches Types and the Length of 3′UTR Sequence

Three types of miRNA seed match types were defined. The match types were distinguished by the minimum length of contiguous matching between the transcript and the seed region of the siRNA. An 8mer match corresponded to the pm match described in section 5.1.1. A 7mer match comprised at least 7 of 8 contiguous matches anywhere in the seed region. A 6mer match comprises at least 6 of 8 contiguous matches anywhere in the seed region. The 3′UTR sequences of all genes in a genome of interest were downloaded from the University of California Santa Cruz's genome center website (http://genome.ucsc.edu/). The numbers of 6-mer, 7-mer and 8-mer seed matches per transcript were determined. 8-mer matches were matches of pm seed match type. 7-mer matches included matches of both m₁₋₇ and m₂₋₈ seed match types and 8-mer matches. 6-mer matches included matches of m₁₋₆, m₃₋₈, or m₂₋₇ seed match types, 7-mer matches, and 8-mer matches. The length of the 3′UTR sequence for each transcript was also counted.

### 3. Results

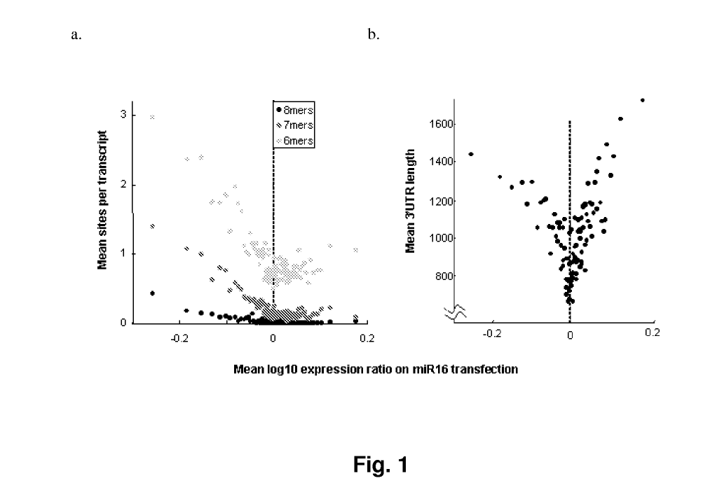

The numbers of 6-mer, 7-mer and 8-mer seed matches for each gene transcript were plotted against the corresponding mean log₁₀ gene expression ratio of that gene transcript. The length of the 3′UTR sequence of each gene transcript was also plotted against the corresponding mean log₁₀ gene expression ratio of that gene transcript. For these plots, a set of 8000 well-expressed transcripts with defined 3′UTR sequences were selected. The transcripts were binned into 100 bins by mean log 10 expression ratio, as follows: the transcripts were ranked by mean log 10 expression ratio, the first 80 transcripts by rank were placed in the first bin, the next 80 transcripts by rank were placed in the next bin, etc. For each bin, the mean mlr ratio, mean seed match count and mean 3′UTR length were calculated. The results are shown in FIGS. 1a and 1b.

All of the above-identified full and partial seed matches were discovered to have a strong influence on gene expression level (see FIG. 1a). It was observed that the relationship between expression ratio and seed match count was linear, with a different slope and a different baseline for 6-mer, 7-mer and 8-mer seed matches (see FIG. 1a). Seed matches were seen to have a weaker influence on gene up-regulation compared to down-regulation (FIG. 1a, positive vs. negative expression ratio).

Moreover, it was observed in another study (data not shown) that the different seed match types had different frequencies of occurrences and potencies of modulations. The 8mer (pm) matches have the longest complementarity to the 3′UTR sequence of a gene transcript and were observed to be a potent predictor of down-regulation. However, the frequency of 8mer matches in the 3′UTR sequence of a gene transcript was often lower than the frequency of the 7mers and the 6mer. The 7mer match of m₂₋₈ was less potent than the 8mer but its frequency of occurrence was about 4 times higher than the 8mer matches. Combining frequency of occurrence and potency of modulation, the 7mer match of m₂₋₈ was observed to be a stronger contributor to the prediction of down-regulation than 8mers. The 6mer match of m₂₋₇ occurred even more frequently than the 7mer matches, but its overall influence was not as strong as the 7mer m₂₋₈ matches. It was also observed that not every 6mer seed match had a strong influence on gene expression level. The 6mer seed match types other than m₂₋₇ were found to have a weaker impact on gene expression level.

A strong correlation was observed also between 3′UTR length and transcript regulation (see FIG. 1b). 3′UTR length was seen to exert a strong influence on transcript regulation. When the tested transcripts had long 3′UTR length and a high number of seed match types, the transcripts tended to be down-regulated. When the tested transcripts had long 3′UTR length but a low number of seed match types, the transcripts tended to be up-regulated. Thus, 3′UTR length is another strong predictor of RNAi regulation of transcript expression.

It was also observed that the correlation between 3′UTR length and down-regulation was subsumed into seed match counts. In other words, if there was a high density of seed match types to the 3′UTR sequence of the transcripts, transcripts with long 3′UTR length tended to be down-regulated. But if there was a low density of seed match types to the 3′UTR sequence of the transcripts, transcripts with long 3′UTR length tended to be up-regulated.

It was concluded that the number of 6-mer (m₂₋₇), 7-mer (m₁₋₇ and m₂₋₈) and 8-mer (pm) seed match types and length of the 3′UTR sequence are important factors in modulation of transcripts expression by RNAi compounds, and the relationship between these factors and the expression level of the transcripts is linear.

The above observations were incorporated into a linear regression model of Equation 1 described in detail in Section 6.1.1. The linear regression model of Equation 1 was used to determine a degree of likelihood that an RNAi compound modulates a transcript for each gene in a set of genes of interest, as well as to determine the seed-sequence-dependent signature size of the RNAi compound. The linear regression model of Equation 1 and its application for calculating the seed-sequence-dependent signature sizes of one or more RNAi compounds were implemented in computer software coded in Perl. The source code is shown in Example 4.

The following features were found to have modest influences on the expression level of transcripts but not as strong an influence as the features described above in this example. For example, #m₃₋₈, #m₁₋₆, and the number of A/U nucleotides in the entire 3′UTR sequence, all defined in Section 6.1.1, were included in the linear regression model of Equation 2 and were found to contribute to the prediction power of the Equation.

The expression level of the transcript was found to be a strong predictor of regulation but was omitted from the general model, as including expression level results in a tissue-specific and not a general model.

It was also discovered that the inclusion of a phylogenetic conservation score of the seed match site only improved the prediction of transcript regulation by miRNA marginally, and did not improve the prediction of transcript regulation by siRNA.

Other features used by some existing prediction methods were found to have no predictive value in the present linear regression model. For example, the distance from a seed match site to the beginning or to the end of the 3′UTR sequence did not affect the modulation by the RNAi compound of gene expression. The use of this prior art feature may constitute a confused misunderstanding of the role of 3′UTR length in targeting. In addition, it was discovered that the portion of the RNAi sequence that is not part of the seed sequence of nucleotides 1-8, i.e., from nucleotide 9 and up, had little value in predicting modulation of transcript expression by RNAi compounds. The matches of all other non-seed sequence regions of the RNAi compound to the 3′UTR sequence exhibited no impact on gene expression.

### Example 2

### Determination of Coefficients of the Linear Model

The coefficients of the current linear model were derived by performing linear regression on a plurality of differential gene expression profiles.

A set of 27 differential gene expression profiles were employed to derive the above coefficients. In a microarray experiment, 27 siRNAs with different sequences were transfected into HTC116 Dicer cells. The mRNAs of the transfected cells were collected and the expression level (transcript abundance) of each gene in a set of genes of interest was measured using Agilent human 25K microarrays. The sequences of the 27 siRNAs are listed below:

| siRNA | Active Strand | Target Strand Sequence | SEQ ID NO |
|---|---|---|---|
| 6344-HEC | Guide | CGTCTAGAGTCGTTGAGAA | (SEQ ID NO: 16) |
| 6345-HEC | Guide | GGGTTTGGAGGATACTTTA | (SEQ ID NO: 17) |
| 6346-HEC | Guide | GGCTTCCTTACAAGGAGAT | (SEQ ID NO: 18) |
| 6326-ERBB3 | Guide | GGACCGAGATGCTGAGATA | (SEQ ID NO: 19) |
| 6327-ERBB3 | Guide | CGGCGATGCTGAGAACCAA | (SEQ ID NO: 20) |
| 1291-ERBB3 | Guide | GAGGATGTCAACGGTTATG | (SEQ ID NO: 21) |
| 1292-ERBB3 | Guide | CAAAGTCTTGGCCAGAATC | (SEQ ID NO: 22) |
| 6338-PIK3CB | Guide | GTGACAACATCATGGTCAA | (SEQ ID NO: 23) |
| 6339-PIK3CB | Guide | GCCTTTGTGGCTGGTATAC | (SEQ ID NO: 24) |
| 6340-PIK3CB | Guide | CTCCTAATATGAATCCTAT | (SEQ ID NO: 25) |
| 6347-STK6 | Guide | CGGGTCTTGTGTCCTTCAA | (SEQ ID NO: 26) |
| 6348-STK6 | Guide | GCACCACTTGGAACAGTTT | (SEQ ID NO: 27) |
| 6349-STK6 | Guide | GAACTTACTTCTTGGATCA | (SEQ ID NO: 28) |
| 339-STK6 | Guide | GCACAAAAGCTTGTCTCCA | (SEQ ID NO: 29) |
| 6341-VHL | Guide | CACACGATGGGCTTCTGGT | (SEQ ID NO: 30) |
| 446-VHL | Guide | GGCATTGGCATCTGCTTTT | (SEQ ID NO: 31) |
| 467-VHL | Guide | GTGAATGAGACACTCCAGT | (SEQ ID NO: 32) |
| 6350-SOS1 | Guide | CTGTGCAACTGCGAGTATT | (SEQ ID NO: 33) |
| 6351-SOS1 | Guide | CCCTTTGTCTCCAATTCAA | (SEQ ID NO: 34) |
| 6352-SOS1 | Guide | CTGCCTAGTGCTGATGTTT | (SEQ ID NO: 35) |
| 1112-HEC | Passenger | CAGAAGTTGTGGAATGAGG | (SEQ ID NO: 36) |
| 312-PIK3CB | Passenger | AAGTTCATGTCAGGGCTGG | (SEQ ID NO: 37) |
| 313-PIK3CB | Passenger | CAAAGATGCCCTTCTGAAC | (SEQ ID NO: 38) |
| 314-PIK3CB | Passenger | AATGCGCAAATTCAGCGAG | (SEQ ID NO: 39) |
| 341-STK6 | Passenger | ACAGTCTTAGGAATCGTGC | (SEQ ID NO: 40) |
| 6342-VHL | Passenger | TTATTTGTGCCATCTCTCA | (SEQ ID NO: 41) |
| 1582-SOS1 | Passenger | ATTGACCACCAGGTTTCTG | (SEQ ID NO: 42) |

The differential gene expression profiles of the above 27 siRNAs, in the form of microarray experiment data, were imported into the Rosetta Resolver® Gene Expression Data Management and Analysis System. Measurement error removal was performed by Rosetta Resolver® using the Rosetta Error Model as described in Section 6.1.3. The Rosetta Error Model reduced the number of false positives at the low signal intensity end. The cleaned differential gene expression profiles, as supplied by Rosetta Resolver®, are in the form of expression log ratios and p-values. The p-value of a gene expression profile is the probability that the null hypothesis that the given gene is not differentially expressed is true. These p-values were subsequently transformed into log-odds values using Equation 6.

Among all the genes of the Agilent human 44K microarray, the 8000 most well expressed transcripts were selected (as measured by array signal intensity). The differential expression profiles of the above 8000 most well expressed genes with available 3′UTR sequences (no transcripts without known 3′UTR sequence were used) were downloaded from Rosetta Resolver® to Matlab®, which is a numerical computing software. The data were then reformatted and exported to individual files in tab-delimited format and imported into the R Statistics Environment. R Statistics Environment is a free software environment for statistical computing and graphics. R was used to perform linear regression on the data of this example. The linear regression model took the above differential gene expression profile data as the response variable, and the sequence feature data described below as predictor variables.

The sequence feature data of #pm, #m₁₋₇, #m₂₋₈, #m₂₋₇, and length(3′UTR) for each of the 27 siRNAs were determined. First, the 3′UTR sequences of all genes in a genome of interest were downloaded from the University of California Santa Cruz's genome center database (http://genome.ucsc.edu/). Second, a library of the 3′UTR sequences of the above 8000 most well expressed genes was constructed in a FASTA format file. Third, for each 3′UTR sequence of the above 8000 genes, the numbers of seed match types #pm, #m₁₋₇, #m₂₋₈, #m₂₋₇, and length(3′UTR) were determined for a given siRNA, using a subroutine written in PERL shown in Example 4. Fourth, repeat the above third step for each siRNA of the 27 siRNAs respectively. The results were output to 27 files in tab-delimited format.

The above feature data files were imported in the R Statistics Environment and merged with the log-odds values for each siRNA/transcript pair. The result was a single table of response variable (log-odds) and predictor variables (#pm, #m₁₋₇, #m₂₋₈, #m₂₋₇, and length(3′UTR)). Linear regression was then performed using the R Statistics Environment, which generated a least squares fit of the data to Equation 1. The corresponding coefficients estimated were A=−1.671, B=−1.292, C=−0.5471, D=−0.3876, E=0.0001551, and F=0.002255.

### Example 3

### Comparison of Prediction Powers of the Current Linear Regression Model Over Prior Art Models

1. Improvement of Prediction Powers of the Current Linear Regression Model Over Prior Art Models which Use a Weighted FASTA Alignment Count Score

The accuracy rate of prediction of siRNA's seed-sequence-dependent gene silencing effect was compared between a linear regression model of the invention and a prior art model that uses a weighted FASTA alignment score. A weighted FASTA alignment score is determined from an algorithm described in other siRNA design applications, which uses a weight matrix to calculate a score for each transcript/siRNA pair from a FASTA alignment of the transcript with the siRNA sequence. The linear regression model does not use a weighted FASTA alignment score. The linear regression model was found to show significant improvement over the prior art model in terms of true positive rate vs. false positive rate.

A linear regression model of the present invention was first trained on experimental data to derive the coefficients of Equation 1. The resulting Equation 1 was then used to predict the genes having seed-sequence-dependent silencing for a set of test siRNAs. The seed-sequence-dependent silencing effect for the genes of the same set of siRNAs, using the algorithm of a weighted FASTA alignment score, were also predicted. The pairs of prediction results were then compared for their accuracy.

The linear regression model was trained on a set of 8 siRNAs. In order to avoid training bias, these 8 siRNAs were selected to have one dominant active strand but were not otherwise rationally designed. The sequences of the 8 siRNAs are listed below.

| siRNA | Active Strand | Target Strand Sequence | SEQ ID NO |
|---|---|---|---|
| IGF1R-AJ39 | Guide | GGATATTGGGCTTTACAAC | (SEQ ID NO: 43) |
| IGF1R-AJ41 | Passenger | AATGCTGACCTCTGTTACC | (SEQ ID NO: 44) |
| IGF1R-AJ43 | Passenger | CTTGCTGCTGTTCCGAGTG | (SEQ ID NO: 45) |
| IGF1R-AJ45 | Guide | GGCCTCGAGAGCCTCGGAG | (SEQ ID NO: 46) |
| IGF1R-AJ37 | Passenger | CTACGCCCTGGTCATCTTC | (SEQ ID NO: 47) |
| IGF1R-45/46 | Guide | GATGATTCAGATGGCCGGA | (SEQ ID NO: 48) |
| IGF1R-47/48 | Passenger | CTTGCAGCAACTGTGGGAC | (SEQ ID NO: 49) |
| IGF1R-AJ42 | Passenger | CATTACCGAGTACTTGCTG | (SEQ ID NO: 50) |

The coefficients of the linear regression model were determined using the same procedure described in Example 2 above. First, the differential gene expression profile data of the 8 siRNAs were obtained from microarray experiments. Second, the features in Equation 1, #pm, #m₁₋₇, #m₂₋₈, #m₂₋₇, and length(3′UTR), were determined. Third, linear regression was performed on the feature data and gene expression data of these 8 siRNAs, which generated the least squares fit and corresponding estimates of coefficients: A=−0.5071381, B=−0.2410966, C=−0.6754640, D=−0.2825670, E=0.00006691, and F=0.0059628.

The linear regression model derived above was used to predict the seed-sequence-dependent silencing effect of a testing set of 27 siRNAs. Like the training set of siRNAs, this test set of 27 siRNAs was selected to have one dominant active strand. It comprised both rationally designed and randomly selected siRNAs. The siRNAs were profiled on a distinct platform from the training set to avoid platform bias. The test set of the 27 siRNAs is listed in the table in Example 2. The prediction was performed following the same steps described in FIG. 2 and Section 6.1.2.2. First, a set of 4000 transcripts with sufficiently detectable expression levels on both the platform on which the 8 training siRNAs were profiled and on the platform on which the 27 test siRNAs were profiled was selected as the transcripts of the set of genes of interest. Sufficiently detectable expression level meant that the signal intensity of the fluorescent emission of a labeled transcript was detectable after correction for background noise. The 3′UTR sequences of human genes were downloaded from the University of California Santa Cruz's genome center website (http://genome.ucsc.edu/). The 3′UTR sequences of the above 4000 selected transcripts were then retrieved using a Perl software program. Next, the features in Equation 1, i.e., #pm, #m₁₋₇, #m₂₋₈, #m₂₋₇, and length of the 3′UTR sequence, were determined using the procedures described in Section 6.1.2.2. Lastly, the p-values and the mlr of the selected transcripts were calculated using Equation 1.

In order to verify the accuracy of the prediction result, the genes that were down-regulated by these 27 siRNAs were also determined via microarray experiments. The 27 siRNAs were each transfected into HTC116 Dicer cells. Differential gene expression profiles of the transcripts of the 4000 genes for each of the siRNA were then obtained. Off-target genes were then identified by screening for those gene transcripts which had been significantly down-regulated, excluding the target gene. Specifically, gene transcripts with mlr ratios<0 and p-values of regulation<0.01 are considered as total positives of down-regulated gene transcripts.

The genes predicted for having seed-sequence-dependent silencing effect by the current linear model and the down-regulated genes identified by the microarray experiment were then compared. A set of true positives and false positives from the prediction were determined. Briefly, the 4000 genes were sorted by the predicted mlr ratio. Going down the sorted predicted mlr ratios one score at a time, if the mlr ratio and the p-value determined from the microarray experiment indicated that this transcript was a true positive, one count was added to the true-positive bin. Otherwise, one count was added to the false positive bin. The percentage of true positives over total positives was compared to the percentage of false positives over total positives for each position in the sorted list. This prediction result was then compared with the prediction result obtained by using the algorithm of weighted FASTA alignment score, which is described below.

A prior art model, that uses a weighted FASTA alignment count score, was used to predict the genes having seed-sequence-dependent silencing effect from the same 4000 gene transcripts. The weighted FASTA alignment score is disclosed in International Application No. WO 2005/042708 by Jackson et al., published on Dec. 5, 2005. As described in WO 2005/042708, genes with seed sequence matches to a given siRNA can be identified by using FASTA alignment and position match score. First, a set of transcript sequences from a given set genes of interest were aligned with the siRNA. Pair-wise alignment method FASTA was used for identifying such set of potential seed sequence matches. Second, a position match position-specific score matrix (pmPSSM) was used to calculate position match scores for each of these alignments. A pmPSSM is a functional sequence motif descriptor which captures the frequency of matches and mismatches at each position in an siRNA (see WO 2005/042708). The pmPSSM was obtained empirically and was then used as a lookup table in order to calculate the position match scores for above mentioned alignments. Any gene with a score above a give threshold was predicted to be a gene with seed sequence match.

Weighted FASTA alignment scores were used to sort the 4000 genes described above. Going down the sorted list of weighted FASTA alignment scores, true positives and false positives were determined by the microarray experiment described above. A second set of true positive ratios and false positive ratios in the weighted FASTA alignment score model thus was obtained.

The results from the above two different prediction methods were plotted on a Receiver Operation Characteristics (ROC) plot. ROC curves allow comparison between sensitivities (the total detection rate) and specificities (one minus the false positive rate) from different analysis methods. In an ROC plot, the y-axis indicates the total positive rate, estimated as the proportion of true positives detected as a fraction of total data points. The x-axis indicates the false positive rate, estimated as the proportion of false positives detected as a fraction of total data points. One data point in the ROC curve of the given analysis method is defined by these two rates, and the whole ROC curve is constructed by varying the detection threshold. An analysis method has higher statistical power if its ROC curve is closer to the upper-left corner. A higher ROC curve gives higher sensitivity for a given false positive rate, or lower false positive rate for a given sensitivity. If the differential expression calls are made based on 50-50 chance, its ROC curve is the diagonal line.

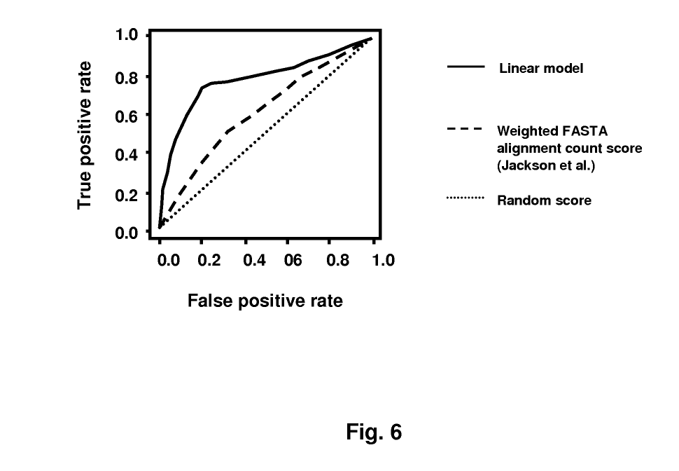

The results from the above two different prediction models were plotted in FIG. 6. The area under the curve for the linear regression model is significantly greater than that for the weighted FASTA alignment count score model. This indicates that the prediction of the linear regression model is far more accurate than that of the prior art model.

### 2. Improvement of Prediction Powers of the Current Linear Regression Model Over Target Prediction Models TargetScan 4 and Pictar

TargetScan and Pictar are prediction algorithms for miRNA targets that assign a binary designation to each mRNA/miRNA pairing (the mRNA is predicted to be a target of the miRNA or it is not). In the context of predicting miRNA “targets”, the definition of a target may be the subject of some debate. If we define an miRNA target as an mRNA that is down-regulated by the miRNA and has an effect on a phenotype of the cell, then the problem might appropriately be deemed a classification problem (either the down-regulation of the mRNA has a “purpose” in the cell or it does not). In contrast, the linear model of the present invention treats the prediction problem as continuous, modeling how much an mRNA will be down-regulated (or modulated) by a given miRNA or siRNA without regard to whether that down-regulation will result in any phenotypic effect. A binary prediction can assist biologists in determining the “function” of an miRNA, but it falls short of describing completely the effect of an miRNA on the transcriptome. Thus, a linear model of the present invention shows superior prediction of silencing efficacy over existing binary classifiers such as TargetScan 4 and Pictar.

The linear regression model of Equation 1 was cross-trained and tested on two miRNAs: miR-16 and miR-106b. Equation 1 was first trained on miR-16 to determine its coefficients A-F. The resulting Equation 1, integrated with the coefficients A-F derived from the training data, was then tested by predicting gene modulations of miR-106b. Similarly, Equation 1 was cross-trained on miR-106b, and the resulting Equation 1 was tested by predicting gene modulations of miR-16. Sequences of miR-16 and miR106b are shown in Example 1. It can be noted that the two miRNAs have distinct seed sequences, belonging to distinct miRNA families.

The miR-16 miRNA was used to train the linear models of Equation 1. Using the same procedures as in part 1 of Example 3, the feature data of #pm, #m₁₋₇, #m₂₋₈, #m₂₋₇, and length of the 3′UTR sequence, and the gene expression data derived from microarray experiment, were determined. Linear regression was then performed to predict mlr, which generated the least squares fit and corresponding estimates of coefficients: A=−0.06968, B=−0.03196, C=−0.03953, D=−0.01204, E=0.00001487, and F=−0.002902.

The above model was then used to predict gene transcripts that are modulated by the miR-106b miRNA, following the same procedure as in part 1 of Example 3. The predicted results were then compared with true positives, i.e., gene transcripts identified as being modulated based on experimental data from microarray. As shown in Table I, 19.3% of the gene expression variance caused by miR-106b was observed to be correctly predicted by the linear model.

TABLE I
The improvement of prediction powers of a linear
regression model of the present invention over
two existing models, TargetScan and PicTar

| | miR-16 | miR-106b |
|---|---|---|
| Model | % Variance Explained | % Variance Explained |
| Linear | 16.1%, cross-trained | 19.3%, cross-trained |
| TargetScan 4 | 6.5% | 14.1% |
| PicTar | 5.4% | 14.0% |

Similarly, the miR-106b miRNA was used to cross-train the linear models of Equation 1, the result of which was subsequently used to predict gene transcripts modulated by the miR-16 miRNA. Table I shows that 16.1% of the gene expression variance caused by miR-16 was observed to be correctly predicted by the linear model.

The accuracy rates of the prior art prediction programs of TargetScan and PicTar were also determined. Gene transcripts which were predicted by TargetScan and PicTar to be target gene transcripts of miR-16 and miR-106b were collected from published results. The predicted target gene transcripts were used as a predictor of observed MLR in the microarray experiment. As demonstrated in Table I, the results showed that the TargetScan 4 classification explains only 6.5% of the variance for miR-16 and 14.1% for miR-106b. PicTar did not show any superiority, with 5.4% variance explained for miR-16 and 14.0% for miR-106b.

In comparison, the linear model showed a more than 2-fold improvement on miR-16 variance explained and smaller but significant improvement on miR-106b variance explained over the two existing methods.

### Example 4

### Computer Source Code for Implementing an Application of the Linear Regression Model

This example shows a computer source code for implementing an application of the linear regression model of the present invention.

#!/usr/bin/perl -w
#----------------------------------------------------------------------

| | |
|---|---|
| # | COPYRIGHT NOTICE |

#----------------------------------------------------------------------

| | |
|---|---|
| # | Copyright (c) 2007 Merck and Co., Inc. |
| # | All Rights Reserved. Reproduction, adaptation, or |
| # | translation without prior written permission of |

| | |
|---|---|
| # | Merck and Co., Inc. is prohibited. |

#----------------------------------------------------------------------
package SOffTarget;
###########################################################

| | |
|---|---|
| # Score module for oligo design | # |

| | |
|---|---|
| # Calculates predicted off target effect of an oligo | # |

```
###########################################################
# implements:
#
# new( ) - Takes fasta file of 3′UTRs as its sole argument
# fastafile - path to the fasta file containing 3′UTR sequences
use ScoreModule;
use strict;
use vars qw(@ISA);
@ISA = qw(ScoreModule);
sub new {
  print STDERR “Constructor called for SOffTarget\n”;
  my($pkg) = shift;
  my($oligoDesigner) = shift;
  my(%args) = @_;
  my($self,
```

```
  $fastafile,
  $nameRef,
  $seqRef
  );
```

$self = $pkg−>SUPER::new($pkg);

| | |
|---|---|
| $self−>{VERSION} | = |

$self−>parseversion(‘$Id: SOffTarget.pm,v 1.0 2007/11/01 16:44:43

buehlere Exp $ ’);
$fastafile = $args{‘fastafile’} || die “Fasta file not provided as
argument for off target module”;

($nameRef, $seqRef) = ReadFasta($fastafile);
$self−>{SEQS} = $seqRef;

```
  $self−>{OLIGODESIGNER} = $oligoDesigner;
  return bless($self, $pkg);
}
# Calculates the off-target score (standard deviation of predicted log odds)
# for a group of oligos
sub calculaten {
  my($self) = shift;
  my(@oligos) = @_;
  my($score,
    $oligo,
    $sequence,
    );
  # predict off-target seed-sequence-dependent signature size for each
oligo
  foreach $oligo (@oligos) {
```

$sequence = $oligo−>{SEQUENCE};
$score = CalculateLOSD($self, $sequence);
print STDERR “LOSD of $score assigned to $sequence\n”;

```
  $oligo−>addscore(“OFFTARGET”,$score,$self);
  $oligo−>{OFFTARGET} = $score;
  }
}
# calculate the LOSD (standard deviation of predicted log odds) for a
single oligo
sub CalculateLOSD {
```

my($self) = shift;
my $oligoSeq = shift;
# model parameters, these parameters come from training
# on the 6x6 set
my $pmParameter = −1.671;
my $m1Parameter = −1.292;
my $m8Parameter = −0.5471;
my $m18Parameter = −0.3876;
my $lengthParameter = 0.0001551;
my $intercept = 0.002255;
# regular expressions for four kind of matches to the
# seed region, including perfect match (pm), m1 (base 1 mismatch)
# m8 (base 8 mismatch) and m18 (mismatch at both base 1 and 8)
my $pmG = substr $oligoSeq, −8;
my $m1G = MakeMismatch($pmG, 7);
my $m8G = MakeMismatch($pmG, 0);
my $m18G = MakeMismatch($pmG, 0, 7);
# calculate predicted log odds for each transcript
my $seqsRef = $self−>{SEQS};

```
  my ($seq, $plo, $pmGCount, $m1GCount, $m8GCount, $m18GCount,
  $length);
```

my @plos = ( );
foreach $seq (@$seqsRef) {

$pmGCount = CountREMatches($seq, $pmG);
$m1GCount = CountREMatches($seq, $m1G);
$m8GCount = CountREMatches($seq, $m8G);
$m18GCount = CountREMatches($seq, $m18G);
$length = length $seq;
$plo = ($pmGCount * $pmParameter)

+ ($m1GCount * $m1Parameter)
+ ($m8GCount * $m8Parameter)
+ ($m18GCount * $m18Parameter)
+ ($length * $lengthParameter)
+ $intercept;

push @plos, $plo;

}
# return the standard deviation of the predicted log odds
return StandardDeviation(@plos);

}
# make a regular expression for mismatches at given positions in the seed
# no need to do this for a fixed model, so could be factored out
# but probably not the rate limiting step anyway
sub MakeMismatch {

my $string = shift;
my @stringList = split //, $string;
while (@_) {

my $position = shift;
$stringList[$position] = “[\hat{ }“ . $stringList[$position] . ”N]”;

}
$string = join ‘’, @stringList;
# print STDOUT “$string\n”;
return $string;

}
# count the number of matches to a regular expression
sub CountREMatches {

my $seq = shift;
my $re = shift;
my $matchNum = 0;
while ($seq =~ /($re)/gi) {

$matchNum++;

}
return $matchNum;

}
# calculate the standard deviation of a list of numbers
sub StandardDeviation {

my @values = @_;
my ($value, $sum, $avg, $sd);
$sum = 0;
foreach $value (@values) {$sum += $value;}
$avg = $sum / scalar @values;
$sum = 0;
foreach $value (@values) {$sum += (($avg − $value) ** 2);}
return (($sum / scalar @values) ** .5);

}
# read a fasta file, returning references to two lists, one of header lines
# and the other of sequences
sub ReadFasta {

my $fastaFile = shift;

open FASTA, $fastaFile or die “Couldn't open $fastaFile for input!\n”;

my @nameList = ( );
my $seq = “”;
my @seqList = ( );
my $firstSeq = 1;
while(<FASTA>) {

chomp;
if (/\hat{ }>(.+)/) {

push @nameList, $1;
if (! $firstSeq) {
push @seqList, $seq;
}
$seq = “”;
$firstSeq = 0;

}
else {

$seq .= $_;

}

}
push @seqList, $seq;
# return the list of names and list of sequences
return (\@nameList, \@seqList);

}

### 9. REFERENCES CITED

All references cited are incorporated herein by reference in their entireties and for all purposes to the same extent as if each individual publication or patent or patent application was specifically and individually indicated to be incorporated by reference in its entirety for all purposes.

Many modifications and variations of the present invention can be made without departing from its spirit and scope, as will be apparent to those skilled in the art. The specific embodiments described herein are offered by way of example only, and the invention is to be limited only by the terms of the appended claims along with the full scope of equivalents to which such claims are entitled.

1-114. (canceled)

115. A method of selecting one or more siRNAs from among a plurality of siRNAs based on silencing specificity, comprising:
(a) determining the seed-sequence-dependent signature of each siRNA in said plurality of siRNAs by a method comprising:
(i) calculating, on a suitably programmed computer, a score representing a probability that said siRNA modulates a transcript of a gene in a set of genes of interest according to a linear model of:
Score=A*#pm+B*#m₁₋₇+C*#m₂₋₈+D*#m₂₋₇+E*length(3′UTR)+optionally F+optionally G*X
wherein
said #pm is the number of pm seed match types between a 3′UTR sequence of said transcript and a seed sequence, or a variant thereof, of said siRNA;
said seed sequence consists of the first 8 nucleotides, numbered 1-8, respectively, at a 5′ end of said siRNA;
said #m₁₋₇ is the number of m₁₋₇ seed match types between said 3′UTR sequence and said seed sequence or said variant thereof;
said #m₂₋₈ is the number of m₂₋₈ seed match types between said 3′UTR sequence and said seed sequence or said variant thereof;
said #m₂₋₇ is the number of m₂₋₇ seed match types between said 3′UTR sequence and said seed sequence or said variant thereof; and
said length(3′UTR) is the length in number of nucleotides of said 3′UTR sequence; wherein said variant is said seed sequence except that a nucleotide U replaces the nucleotide at position 1 of said seed sequence;
wherein
said pm seed match type=perfect match of all nucleotides 1-8 in said seed sequence or said variant thereof;
said m₁₋₇ seed match type=perfect match of nucleotides 1-7 and mismatch of nucleotide 8 in said seed sequence or said variant thereof;
said m₂₋₈ seed match type=perfect match of nucleotides 2-8 and mismatch of nucleotide 1 in said seed sequence or said variant thereof; and
said m₂₋₇ seed match type=perfect match of nucleotides 2-7 and mismatches of nucleotides 1 and 8 in said seed sequence or said variant thereof;
wherein a perfect match means a complementary nucleotide is present, and a mismatch means absence of a complementary nucleotide; wherein coefficients A, B, C, D, E, F and G are constants; and wherein X is the value of one or more additional features characterizing the influence of said siRNA on said gene; and
(ii) repeating step (i) for each gene in said set of genes, thereby determining a set of scores indicating the probability that said siRNA modulates said respective transcript; and
(iii) calculating, on a suitably programmed computer, the seed-sequence-dependent signature size of said siRNA, wherein said seed-sequence-dependent signature size is, or an indication of, the number of genes that have a transcript which said score predicts is modulated by said siRNA;
(b) ranking, on a suitably programmed computer, said siRNAs by seed-sequence-dependent signature sizes; and
(c) selecting one or more siRNAs whose seed-sequence-dependent signature size is below a preselected threshold, or selecting N siRNAs with the 1^{st} to N^{th} smallest seed-sequence-dependent signature size, wherein N is a positive integer.

116. The method of claim 115, wherein said score of part (a) is selected from the group consisting of: (i) a log-odds that the null hypothesis that said transcript is not modulated or is not down-regulated by said siRNA is true, (ii) a p-value that is the probability that the null hypothesis that said transcript is not modulated or is not down-regulated by said siRNA is true, and (iii) a measure of the relative expression of said transcript by a cell containing said siRNA and expression of said transcript by an analogous cell not containing said siRNA; and
wherein said seed-sequence-dependent signature size is calculated as follows:
(1) when said score is said log-odds, calculating said seed-sequence-dependent signature size comprises: (A) calculating the standard deviation of said set of scores, or (B) calculating the mean of the absolute values of said set of scores, or (C) counting the number of log-odds in said set of scores that have a value below a first preselected threshold; and
(2) when said score is said p-value, calculating said seed-sequence-dependent signature size comprises counting the number of p-values in said set of scores that have a value below a second preselected threshold; and
(3) when said score is said measure, calculating said seed-sequence-dependent signature size comprises counting the number of measures in said set of scores that have a value above a third preselected threshold and/or below a fourth preselected threshold.

117. The method of claim 116 wherein said score is the log-odds of the null hypothesis that said transcript is not down-regulated by said siRNA is true.

118. The method of claim 116, wherein said score is said measure, wherein said measure is the relative expression of said transcript by a cell not containing said siRNA and expression of said transcript by an analogous cell containing said siRNA, and said seed-sequence-dependent signature size is the number of measures in said set of scores that have a value above a fifth preselected threshold and/or below a sixth preselected threshold.

119. The method of claim 118, wherein said measure of the relative expression is the mean log ratio, wherein said mean log ratio is a mean of the log ratios of signal intensities from a pair of microarray experiments where fluorescent dye labeling of nucleic acids contacted with a microarray is reversed in one microarray experiment relative to the other.

120. The method of claim 115, wherein said seed-sequence-dependent signature size is a standard deviation of log-odds, wherein said step (c) comprises selecting one or more siRNAs whose seed-sequence-dependent signature size is below a preselected threshold, and wherein said preselected threshold is 0.250, or 0.289.

121. The method of claim 115, wherein the seed-sequence-dependent signature size is a mean of the absolute value of log-odds, wherein said step (c) comprises selecting one or more siRNAs whose seed-sequence-dependent signature size is below a preselected threshold, and wherein said preselected threshold is 10^{th}, or 25^{th} percentile of all siRNAs.

122. The method of claim 115, wherein the seed-sequence-dependent signature size is expression log₂ ratio, wherein step (c) comprises selecting one or more siRNAs whose seed-sequence-dependent signature size is below a preselected threshold, and wherein said preselected threshold is 1.2 fold, 1.5 fold, or 2 fold reduction of expression level.


SEQUENCE LISTING (50 sequences)

SEQ ID NO: 1 - RNA, 8 nt, Artificial Sequence
  Synthetic
augccgaa

SEQ ID NO: 2 - RNA, 8 nt, Artificial Sequence
  Synthetic
uucggcau

SEQ ID NO: 3 - RNA, 8 nt, Artificial Sequence
  Synthetic
uucggcac

SEQ ID NO: 4 - RNA, 8 nt, Artificial Sequence
  Synthetic
uucggcag

SEQ ID NO: 5 - RNA, 8 nt, Artificial Sequence
  Synthetic
uucggcaa

SEQ ID NO: 6 - DNA, 8 bp, Artificial Sequence
  Synthetic
uucggcan

SEQ ID NO: 7 - RNA, 8 nt, Artificial Sequence
  Synthetic
nucggcau

SEQ ID NO: 8 - RNA, 8 nt, Artificial Sequence
  Synthetic
nucggcan

SEQ ID NO: 9 - RNA, 8 nt, Artificial Sequence
  Synthetic
uugccgaa

SEQ ID NO: 10 - RNA, 8 nt, Artificial Sequence
  Synthetic
uucggcaa

SEQ ID NO: 11 - RNA, 8 nt, Artificial Sequence
  Synthetic
uucggcan

SEQ ID NO: 12 - RNA, 8 nt, Artificial Sequence
  Synthetic
nucggcaa

SEQ ID NO: 13 - RNA, 8 nt, Artificial Sequence
  Synthetic
nucggcan

SEQ ID NO: 14 - RNA, 22 nt, Artificial Sequence
  Synthetic
uagcagcacguaaauauuggcg

SEQ ID NO: 15 - RNA, 21 nt, Artificial Sequence
  Synthetic
uaaagugcugacagugcagau

SEQ ID NO: 16 - DNA, 19 bp, Artificial Sequence
  Synthetic
cgtctagagtcgttgagaa

SEQ ID NO: 17 - DNA, 19 bp, Artificial Sequence
  Synthetic
gggtttggaggatacttta

SEQ ID NO: 18 - DNA, 19 bp, Artificial Sequence
  Synthetic
ggcttccttacaaggagat

SEQ ID NO: 19 - DNA, 19 bp, Artificial Sequence
  Synthetic
ggaccgagatgctgagata

SEQ ID NO: 20 - DNA, 19 bp, Artificial Sequence
  Synthetic
cggcgatgctgagaaccaa

SEQ ID NO: 21 - DNA, 19 bp, Artificial Sequence
  Synthetic
gaggatgtcaacggttatg

SEQ ID NO: 22 - DNA, 19 bp, Artificial Sequence
  Synthetic
caaagtcttggccagaatc

SEQ ID NO: 23 - DNA, 19 bp, Artificial Sequence
  Synthetic
gtgacaacatcatggtcaa

SEQ ID NO: 24 - DNA, 19 bp, Artificial Sequence
  Synthetic
gcctttgtggctggtatac

SEQ ID NO: 25 - DNA, 19 bp, Artificial Sequence
  Synthetic
ctcctaatatgaatcctat

SEQ ID NO: 26 - DNA, 19 bp, Artificial Sequence
  Synthetic
cgggtcttgtgtccttcaa

SEQ ID NO: 27 - DNA, 19 bp, Artificial Sequence
  Synthetic
gcaccacttggaacagttt

SEQ ID NO: 28 - DNA, 19 bp, Artificial Sequence
  Synthetic
gaacttacttcttggatca

SEQ ID NO: 29 - DNA, 19 bp, Artificial Sequence
  Synthetic
gcacaaaagcttgtctcca

SEQ ID NO: 30 - DNA, 19 bp, Artificial Sequence
  Synthetic
cacacgatgggcttctggt

SEQ ID NO: 31 - DNA, 19 bp, Artificial Sequence
  Synthetic
ggcattggcatctgctttt

SEQ ID NO: 32 - DNA, 19 bp, Artificial Sequence
  Synthetic
gtgaatgagacactccagt

SEQ ID NO: 33 - DNA, 19 bp, Artificial Sequence
  Synthetic
ctgtgcaactgcgagtatt

SEQ ID NO: 34 - DNA, 19 bp, Artificial Sequence
  Synthetic
ccctttgtctccaattcaa

SEQ ID NO: 35 - DNA, 19 bp, Artificial Sequence
  Synthetic
ctgcctagtgctgatgttt

SEQ ID NO: 36 - DNA, 19 bp, Artificial Sequence
  Synthetic
cagaagttgtggaatgagg

SEQ ID NO: 37 - DNA, 19 bp, Artificial Sequence
  Synthetic
aagttcatgtcagggctgg

SEQ ID NO: 38 - DNA, 19 bp, Artificial Sequence
  Synthetic
caaagatgcccttctgaac

SEQ ID NO: 39 - DNA, 19 bp, Artificial Sequence
  Synthetic
aatgcgcaaattcagcgag

SEQ ID NO: 40 - DNA, 19 bp, Artificial Sequence
  Synthetic
acagtcttaggaatcgtgc

SEQ ID NO: 41 - DNA, 19 bp, Artificial Sequence
  Synthetic
ttatttgtgccatctctca

SEQ ID NO: 42 - DNA, 19 bp, Artificial Sequence
  Synthetic
attgaccaccaggtttctg

SEQ ID NO: 43 - DNA, 19 bp, Artificial Sequence
  Synthetic
ggatattgggctttacaac

SEQ ID NO: 44 - DNA, 19 bp, Artificial Sequence
  Synthetic
aatgctgacctctgttacc

SEQ ID NO: 45 - DNA, 19 bp, Artificial Sequence
  Synthetic
cttgctgctgttccgagtg

SEQ ID NO: 46 - DNA, 19 bp, Artificial Sequence
  Synthetic
ggcctcgagagcctcggag

SEQ ID NO: 47 - DNA, 19 bp, Artificial Sequence
  Synthetic
ctacgccctggtcatcttc

SEQ ID NO: 48 - DNA, 19 bp, Artificial Sequence
  Synthetic
gatgattcagatggccgga

SEQ ID NO: 49 - DNA, 19 bp, Artificial Sequence
  Synthetic
cttgcagcaactgtgggac

SEQ ID NO: 50 - DNA, 19 bp, Artificial Sequence
  Synthetic
cattaccgagtacttgctg